(19) United States
(12) Patent Application Publication
(10) Pub. No.: US 2025/0325039 A1
(43) Pub. Date: Oct. 23, 2025

(54) AEROSOL GENERATING SYSTEM, OPERATING METHOD THEREOF, AND AEROSOL GENERATING ARTICLE THEREFOR

(71) Applicant: KT&G CORPORATION, Daejeon (KR)

(72) Inventors: Sang Cheol PARK, Suwon-si (KR); Jin Chul JUNG, Daejeon (KR); Won Kyeong LEE, Guri-si (KR); Sung Wook YOON, Suwon-si (KR)

(73) Assignee: KT&G CORPORATION, Daejeon (KR)

(21) Appl. No.: 19/175,514

(22) Filed: Apr. 10, 2025

(30) Foreign Application Priority Data
Apr. 22, 2024 (KR) 10-2024-0053665

(51) Int. Cl. A24F 40/51; A24D 1/02; A24D 1/20; A24D 3/17; A24F 40/20; A24F 40/57

(52) U.S. Cl. CPC A24F 40/51; A24D 1/025; A24D 1/20; A24F 40/20; A24F 40/57; A24D 3/17

(57) ABSTRACT

An aerosol generating system includes a cigarette including an identification portion that emits light of a second wavelength when excited by light of a first wavelength, wherein the second wavelength is different from the first wavelength, a main body including a cavity into which the cigarette is inserted, an optical sensor package near the cavity and configured to detect the identification portion, and a controller configured to identify whether the cigarette is counterfeit and a type of the cigarette based on a sensing value detected by the optical sensor package. The optical sensor package includes a package substrate, an emission portion on the package substrate and emitting light of the first wavelength, a semiconductor chip on the package substrate, and a light-receiving portion on at least one of the semiconductor chip and the package substrate, which is on the opposite side of the emission portion with respect to the semiconductor chip, and configured to receive light of the second wavelength.

### CROSS-REFERENCE TO RELATED APPLICATION

This application is based on and claims priority under 35 U.S.C. § 119 to Korean Patent Application No. 10-2024-0053665, filed on Apr. 22, 2024, in the Korean Intellectual Property Office, the disclosure of which is incorporated by reference herein in its entirety.

### BACKGROUND

### 1. Field

The disclosure relates to an aerosol generating system capable of determining information about an aerosol generating article based on a sensing value sensed from an emission material included in the aerosol generating article, an operating method of the aerosol generating system, and an aerosol generating article included in the aerosol generating system.

### 2. Description of the Related Art

Recently, the demand for alternative methods to overcome the shortcomings of general cigarettes has increased. For example, there is an increasing demand for a system for generating aerosols by heating a cigarette or an aerosol generating material by using an aerosol generating device, rather than by burning cigarettes.

Recently, the types of sensors included in aerosol generating devices have been diversifying to detect the insertion/removal of cigarettes, cigarette types, counterfeiting of cigarettes, and the like. In particular, as the types of cigarettes increase and counterfeit cigarettes are distributed in the market, there is a growing need for aerosol generating devices capable of distinguishing genuine products from counterfeits.

However, an aerosol generating device may undergo degradation in sensing values of sensors due to various reasons or there may be limitations in the sensor performance because of a heater for heating a cigarette. For example, if an aerosol generating device automatically checks whether a cigarette is counterfeit for user's convenience and stops the operation of the heater when it is determined that the cigarette is counterfeit, low sensor accuracy may lead to malfunctions, which may rather negatively impact the user's experience.

In addition, with the recent acceleration of personalization trends, customized cigarettes are manufactured in various forms to meet the preferences of users. As such, small-scale production of various types of cigarettes, as opposed to mass production of a few types of cigarettes, may limit the identification of cigarette types using limited identification means.

In addition, because aerosol generating devices are compact electronic products, the space for mounting electronic components is limited, which may inevitably cause power consumption issues due to limited battery capacity.

### SUMMARY

Provided is an aerosol generating device with improved sensor sensitivity.

In addition, provided is an aerosol generating device capable of distinguishing various types of cigarettes by using limited identification means.

Moreover, provided is an aerosol generating device capable of effectively utilizing limited mounting space and reducing power consumption.

The technical problems of the present disclosure are not limited to the aforementioned description, and other technical problems may be clearly understood by one of ordinary skill in the art from the present specification and the attached drawings.

Additional aspects will be set forth in part in the description which follows and, in part, will be apparent from the description, or may be learned by practice of the presented embodiments of the disclosure.

According to an embodiment of the disclosure, an aerosol generating system includes a cigarette including an identification portion that emits light of a second wavelength when excited by light of a first wavelength, wherein the second wavelength is different from the first wavelength, a main body including a cavity into which the cigarette is inserted, an optical sensor package arranged near the cavity and configured to detect the identification portion, and a controller configured to identify whether the cigarette is counterfeit and a type of the cigarette based on a sensing value detected by the optical sensor package, wherein the optical sensor package includes a package substrate, an emission portion arranged on the package substrate and emitting light of the first wavelength, a semiconductor chip arranged on the package substrate, and a light-receiving portion arranged on at least one of the semiconductor chip and the package substrate, which is located on the opposite side of the emission portion with respect to the semiconductor chip, and configured to receive light of the second wavelength.

The semiconductor chip may include a signal processor that is electrically connected to the light-receiving portion, and the signal processor may include an analog-to-digital converter configured to convert an analog signal, which is the sensing value, into a digital signal.

The controller may be further configured to determine whether the cigarette is counterfeit and a type of the cigarette, based on the digital signal generated by the signal processor.

A height from an upper surface of the package substrate to an upper surface of the semiconductor chip may be greater than a height from the upper surface of the package substrate to an upper surface of the emission portion.

The emission portion may include at least one of an infrared light-emitting diode and an ultraviolet light-emitting diode, and the light-receiving portion may include at least one of an RGB photodiode and an infrared photodiode.

The identification portion may include at least one of a lanthanide material and a taggant material.

The optical sensor package may further include a partition arranged on the package substrate located between the emission portion and the semiconductor chip.

The partition may include a black epoxy mold compound, and a molding member may include a clear molding compound.

The optical sensor package may further include the molding member arranged on an upper surface of an exposed portion of the package substrate, the emission portion, the light-receiving portion, and the semiconductor chip.

The aerosol generating system may further include a partition arranged on the package substrate and including a first partition portion and a second partition portion, wherein the first partition is arranged between the emission portion and the semiconductor chip, and the second partition portion is arranged along the periphery of the package substrate.

The molding member may comprise a first molding portion arranged on an upper surface of an exposed portion of the package substrate and a second molding portion arranged on an upper surface of another exposed portion of the package substrate, the light-receiving portion, and the semiconductor chip.

An inner side surface of the partition that contacts the first molding portion may have an inclined surface that forms an obtuse angle with the upper surface of the package substrate.

A reflective material may be placed on the inclined surface.

The partition may include a black epoxy mold compound, and the molding member may include a clear molding compound.

The cigarette may include an aerosol generating rod and a filter rod, and the identification portion may be formed in a region extending in a direction towards the filter rod from a boundary between the aerosol generating rod and the filter rod, the identification portion having a band shape surrounding an outer circumferential surface of the cigarette.

According to an embodiment of the disclosure, an aerosol generating system includes a cigarette including an identification portion that emits light of a second wavelength when excited by light of a first wavelength, wherein the second wavelength is different from the first wavelength, a main body including a cavity into which the cigarette is inserted, a sensor unit arranged near the cavity and configured to detect the identification portion, and a controller configured to identify whether the cigarette is counterfeit and a type of the cigarette, based on a sensing value detected by the sensor unit, wherein the identification portion includes a plurality of regions containing identification materials with different concentrations.

The cigarette may include a tobacco rod and a filter rod, and the identification portion may be formed in a region extending in a direction towards the filter rod from a boundary between the tobacco rod and the filter rod.

The identification portion may include a first region, a second region, and a third region each having a band shape surrounding an outer circumferential surface of the cigarette, wherein the first region, the second region, and the third region may be arranged adjacent to each other in sequence in the direction towards the filter rod from the boundary.

The sensor unit may be positioned to correspond to the third region and configured to detect the first region, the second region, and the third region in a stated order while the cigarette is inserted into the cavity.

Concentrations of the identification materials respectively included in the first region, the second region, and the third region may be different.

The aerosol generating system may further include a memory storing different concentration intensity change patterns for each type of cigarette, wherein the controller may be further configured to compare a sensing value change pattern of each of the first region, the second region, and the third region with the concentration intensity change pattern stored in advance in the memory to determine the type of the cigarette inserted into the cavity, the sensing value change pattern being detected by the sensor unit.

The aerosol generating system may further include a heater configured to heat the cigarette inserted into the cavity, wherein the controller may be further configured to control power supply to the heater based on a temperature profile corresponding to the determined type of the cigarette.

The identification portion may include a first region to a fifth region each having a band shape surrounding an outer circumferential surface of the cigarette, and the first region to the fifth region may be arranged adjacent to each other in sequence in the direction towards the filter rod from the boundary.

The sensor unit may be positioned to correspond to the fifth region and further configured to detect the first region to the fifth region in sequence while the cigarette is inserted into the cavity.

Concentrations of identification materials respectively in the first region to the fifth region may differ, and each of the concentrations may be any one of a first concentration between a first threshold value and a second threshold value and a second concentration between a third threshold value and a fourth threshold value.

The controller may be further configured to map the first concentration to ‘0’ and the second concentration to ‘1’ to convert an array of sensing values of the first region to the fifth region into binary code.

The aerosol generating system may further include a memory storing identification codes that vary according to types of cigarette.

The controller may be further configured to compare the binary code derived from the sensing values of the first region to the fifth region with the identification codes stored in advance in the memory to determine the type of the cigarette inserted into the cavity, the sensing values being detected by the sensor unit.

The aerosol generating system may further include a heater configured to heat the cigarette inserted into the cavity, wherein the controller may be further configured to control power supply to the heater based on a temperature profile corresponding to the determined type of the cigarette.

The sensor unit may include an optical sensor package including a package substrate, an emission portion arranged on the package substrate and emitting light of the first wavelength, a light-receiving portion arranged on the package substrate and configured to receive light of the second wavelength, and a molding member arranged on an upper surface of an exposed portion of the package substrate, the emission portion, and the light-receiving portion.

The emission portion may include an ultraviolet light-emitting diode, and the light-receiving portion may include at least one of an RGB photodiode and an infrared photodiode.

The identification material may include at least one of a lanthanide material and a taggant material.

### BRIEF DESCRIPTION OF THE DRAWINGS

The above and other aspects, features, and advantages of certain embodiments of the disclosure will be more apparent from the following description taken in conjunction with the accompanying drawings, in which:

FIGS. 1 to 3 illustrate examples of an aerosol generating article;

FIGS. 4A to 4D are side cross-sectional views of an aerosol generating article to explain examples of an arrangement location/method of an identification material;

FIG. 5 is a perspective view of an aerosol generating article for explaining an arrangement location of an identification material;

FIGS. 6A and 6B illustrate a tobacco rod, a filter rod, and a wrapper separated from an aerosol generating article;

FIG. 7 is a schematic side view of an aerosol generating system according to an embodiment;

FIG. 8 is a schematic side view of an aerosol generating system using a heating method different from that of the aerosol generating system of FIG. 7;

FIG. 9 is a flowchart of a process of an aerosol generating system for determining information about an aerosol generating article and controlling power supply to a heater, according to an embodiment;

FIG. 10A is an example of a graph showing a wavelength emitted from a first identification material as a wavelength in a first wavelength range is irradiated;

FIG. 10B is an example of a graph showing a wavelength emitted from a second identification material as a wavelength in a second wavelength range is irradiated;

FIG. 11A is an example of a graph showing a wavelength emitted from a third identification material as a wavelength in a first wavelength range is irradiated;

FIG. 11B is an example of a graph showing a wavelength emitted from the third identification material as a wavelength in a first wavelength range is irradiated;

FIG. 12 is a flowchart of another example in which an aerosol generating system according to an embodiment determines information of an aerosol generating article;

FIG. 13 illustrates a cigarette including an identification portion, according to an embodiment;

FIGS. 14A and 14B illustrate a sensor unit for identifying a type of a cigarette of FIG. 13;

FIGS. 15A to 15D are graphs showing sensing values for respective regions of an identification portion;

FIG. 16 illustrates a cigarette including an identification portion, according to an embodiment;

FIGS. 17A and 17B illustrate a sensor unit for identifying a type of a cigarette of FIG. 16;

FIG. 18 illustrates a cigarette including an identification portion, according to an embodiment;

FIGS. 19A and 19B illustrate a sensor unit for identifying a type of a cigarette of FIG. 18;

FIG. 20 illustrates a cigarette including an identification portion, according to an embodiment;

FIGS. 21A and 21B illustrate a sensor unit for identifying a type of a cigarette of FIG. 20;

FIG. 22 illustrates a cigarette including an identification portion, according to an embodiment;

FIGS. 23A and 23B illustrate a sensor unit for identifying a type of a cigarette of FIG. 22;

FIG. 24A illustrates an aerosol generating system according to an embodiment;

FIG. 24B is a plan view of an optical sensor package according to an embodiment;

FIG. 24C is a cross-sectional view of the optical sensor package, taken along a line I-I′ of FIG. 24B;

FIG. 24D illustrates a sensing operation of the optical sensor package, according to an embodiment;

FIG. 25A is a plan view of an optical sensor package according to an embodiment;

FIG. 25B is a cross-sectional view of the optical sensor package, taken along a line II-II′ of FIG. 25A;

FIG. 26A is a plan view of an optical sensor package according to an embodiment;

FIG. 26B is a cross-sectional view of the optical sensor package, taken along a line III-III′ of FIG. 26A;

FIG. 27A is a plan view of an optical sensor package according to an embodiment;

FIG. 27B is a cross-sectional view of the optical sensor package, taken along a line IV-IV′ of FIG. 27A;

FIG. 28A is a plan view of an optical sensor package according to an embodiment;

FIG. 28B is a cross-sectional view of the optical sensor package, taken along a line V-V′ of FIG. 28A;

FIG. 29A is a plan view of an optical sensor package according to an embodiment;

FIG. 29B is a cross-sectional view of the optical sensor package, taken along a line VI-VI′ of FIG. 29A;

FIG. 30A is a plan view of an optical sensor package according to an embodiment;

FIG. 30B is a cross-sectional view of the optical sensor package, taken along a line VII-VII′ of FIG. 30A;

FIG. 31A is a plan view of an optical sensor package according to an embodiment;

FIG. 31B is a cross-sectional view of the optical sensor package, taken along a line VIII-VIII′ of FIG. 31A;

FIG. 32A is a plan view of an optical sensor package according to an embodiment;

FIG. 32B is a cross-sectional view of the optical sensor package, taken along a line VIIII-VIIII′ of FIG. 32A;

FIG. 33A is a plan view of an optical sensor package that includes a temperature sensor unit, according to an embodiment;

FIG. 33B is a cross-sectional view of the optical sensor package, taken along a line X-X′ of FIG. 33A;

FIG. 34 is a flowchart for explaining an emission amount adjustment method of an aerosol generating system, according to an embodiment;

FIG. 35A is a plan view of an optical sensor package that includes an emission portion emitting visible light, according to an embodiment;

FIG. 35B is a cross-sectional view of the optical sensor package, taken along a line XI-XI′ of FIG. 35A;

FIG. 36 is a flowchart for explaining a power consumption reduction operation of an aerosol generating system, according to an embodiment; and

FIG. 37 is a block diagram of an aerosol generating device according to another embodiment.

### DETAILED DESCRIPTION

Regarding the terms in the various embodiments, the general terms which are currently and widely used are selected in consideration of functions of structural elements in the various embodiments of the present disclosure. However, meanings of the terms can be changed according to intention, a judicial precedence, the appearance of a new technology, and the like. In addition, in certain cases, terms which can be arbitrarily selected by the applicant in particular cases. In such a case, the meaning of the terms will be described in detail at the corresponding portion in the description of the present disclosure. Therefore, the terms used in the various embodiments of the present disclosure should be defined based on the meanings of the terms and the descriptions provided herein.

In addition, unless explicitly described to the contrary, the word “comprise” and variations such as “comprises” or “comprising” will be understood to imply the inclusion of stated elements but not the exclusion of any other elements. In addition, the terms “-er”, “-or”, and “module” described in the specification mean units for processing at least one function and operation and can be implemented by hardware components or software components and combinations thereof.

Hereinafter, the present disclosure will now be described more fully with reference to the accompanying drawings, in which exemplary embodiments of the present disclosure are shown such that one of ordinary skill in the art may easily work the present disclosure. The disclosure may, however, be embodied in many different forms and should not be construed as being limited to the embodiments set forth herein.

Hereinafter, embodiments of the present disclosure will be described in detail with reference to the drawings.

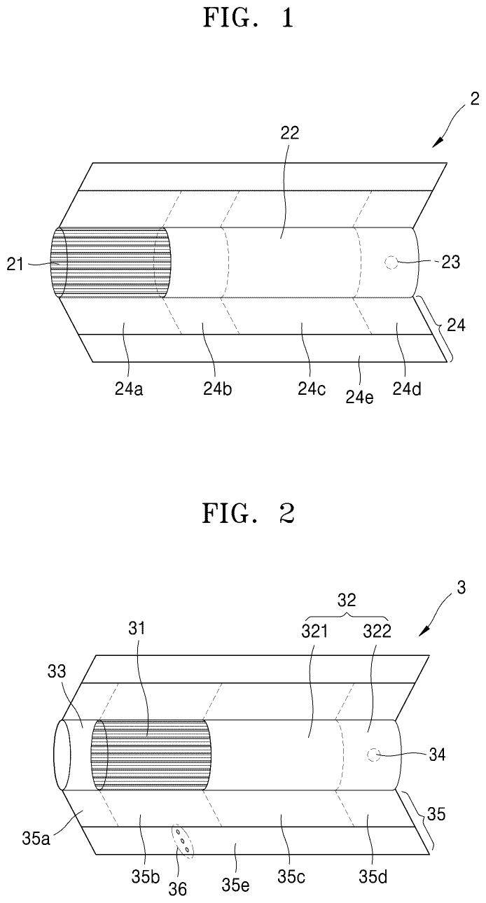

Hereinafter, examples of an aerosol generating article are described with reference to FIGS. 1 to 3.

FIGS. 1 to 3 illustrate examples of the aerosol generating article.

FIG. 1 illustrates that the filter rod 22 includes a single segment, but is limited thereto. In other words, the filter rod 22 may include a plurality of segments. For example, the filter rod 22 may include a first segment configured to cool an aerosol and a second segment configured to filter a certain component included in the aerosol. Also, as necessary, the filter rod 22 may further include at least one segment configured to perform other functions.

The aerosol generating article 2 may be packaged by at least one wrapper 24. The wrapper 24 may have at least one hole through which external air may be introduced or internal air may be discharged. For example, the aerosol generating article 2 may be packaged by one wrapper 24. As another example, the aerosol generating article 2 may be doubly packaged by two or more wrappers 24. For example, the tobacco rod 21 may be packaged by a first wrapper 241, and the filter rod 22 may be packaged by wrappers 24b, 24c, 24d. Also, the entire aerosol generating article 2 may be re-packaged by another single wrapper 24e. When the filter rod 22 includes a plurality of segments, each segment may be packaged by wrappers 24b, 24c, 24d.

The tobacco rod 21 may include an aerosol generating material. For example, the aerosol generating material may include at least one of glycerin, propylene glycol, ethylene glycol, dipropylene glycol, diethylene glycol, triethylene glycol, tetraethylene glycol, and oleyl alcohol, but it is not limited thereto. Also, the tobacco rod 21 may include other additives, such as flavors, a wetting agent, and/or organic acid. Also, the tobacco rod 21 may include a flavored liquid, such as menthol or a moisturizer, which is injected to the tobacco rod 21.

The tobacco rod 21 may be manufactured in various forms. For example, the tobacco rod 21 may be formed as a sheet or a strand. Also, the tobacco rod 21 may be formed as a pipe tobacco, which is formed of tiny bits cut from a tobacco sheet. Also, the tobacco rod 21 may be surrounded by a heat conductive material. For example, the heat conductive material may be, but is not limited to, a metal foil such as aluminum foil. For example, the heat conductive material surrounding the tobacco rod 21 may uniformly distribute heat transmitted to the tobacco rod 21, and thus, the heat conductivity applied to the tobacco rod may be increased and taste of the tobacco may be improved. Also, the heat conductive material surrounding the tobacco rod 21 may function as a susceptor heated by the induction heater. Here, although not illustrated in the drawings, the tobacco rod 21 may further include an additional susceptor, in addition to the heat conductive material surrounding the tobacco rod 21.

The filter rod 22 may include a cellulose acetate filter. Shapes of the filter rod 22 are not limited. For example, the filter rod 22 may include a cylinder-type rod or a tube-type rod having a hollow inside. Also, the filter rod 22 may include a recess-type rod. When the filter rod 22 includes a plurality of segments, at least one of the plurality of segments may have a different shape.

The filter rod 22 may be formed to generate flavors. For example, a flavoring liquid may be injected onto the filter rod 22, or an additional fiber coated with a flavoring liquid may be inserted into the filter rod 22.

Also, the filter rod 22 may include at least one capsule 23. Here, the capsule 23 may generate a flavor or an aerosol. For example, the capsule 23 may have a configuration in which a liquid containing a flavoring material is wrapped with a film. For example, the capsule 23 may have a spherical or cylindrical shape, but is not limited thereto.

When the filter rod 22 includes a segment configured to cool the aerosol, the cooling segment may include a polymer material or a biodegradable polymer material. For example, the cooling segment may include pure polylactic acid alone, but the material for forming the cooling segment is not limited thereto. In some embodiments, the cooling segment may include a cellulose acetate filter having a plurality of holes. However, the cooling segment is not limited to the above-described example and is not limited as long as the cooling segment cools the aerosol.

Referring to FIG. 2, the aerosol generating article 3 may further include a front-end plug 33. The front-end plug 33 may be located on one side of the tobacco rod 31 which is opposite to the filter rod 32. The front-end plug 33 may prevent the tobacco rod 31 from being detached outwards and prevent the liquefied aerosol from flowing from the tobacco rod 31 into the aerosol generating device, during smoking.

The filter rod 32 may include a first segment 321 and a second segment 322. Here, the first segment 321 may correspond to the first segment of the filter rod 22 of FIG. 1, and the second segment 322 may correspond to the third segment of the filter rod 22 of FIG. 1.

A diameter and a total length of the aerosol generating article 3 may correspond to a diameter and a total length of the aerosol generating article 2 of FIG. 1. For example, the length of The front-end plug 33 is about 7 mm, the length of the tobacco rod 31 is about 15 mm, the length of the first segment 321 is about 12 mm, and the length of the second segment 322 is about 14 mm, but it is not limited thereto.

The aerosol generating article 3 may be packaged using at least one wrapper 35. The wrapper 35 may have at least one hole through which external air may be introduced or internal air may be discharged. For example, the front end plug 33 may be packaged by a first wrapper 35a, the tobacco rod 31 may be packaged by a second wrapper 35b, the first segment 321 may be packaged by a third wrapper 35c, and the second segment 322 may be packaged by a fourth wrapper 35d.

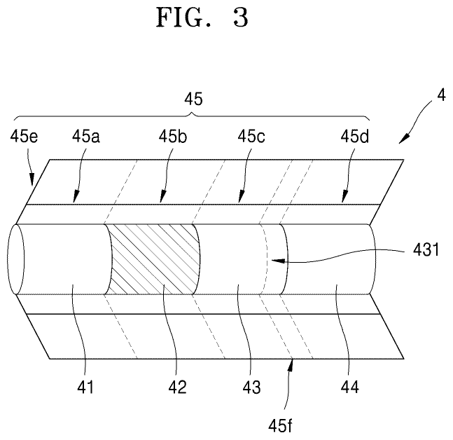

Further, the entire aerosol generating article 3 may be repackaged by a fifth wrapper 35e. In addition, at least one perforation 36 may be formed in the fifth wrapper 35e. For example, the perforation 36 may be formed in a region surrounding the tobacco rod 31, but is not limited thereto. The perforation 36 may serve to transfer heat generated by the heater 130 illustrated in FIGS. 2 and 3 to the inside of the tobacco rod 31.

In addition, at least one capsule 34 may be included in the second segment 322. Here, the capsule 34 may generate a flavor or an aerosol. For example, the capsule 34 may have a configuration in which a liquid containing a flavoring material is wrapped with a film. For example, the capsule 34 may have a spherical or cylindrical shape, but is not limited thereto.

FIG. 3 illustrates an example of an aerosol generating article.

Referring to FIG. 3, an aerosol generating article 4 may include a first aerosol generating rod 41, a second aerosol generating rod 42, a cooling rod 43, and a filter rod 44. Also, the aerosol generating article 4 may be packaged by at least one wrapper 45.

The first aerosol generating rod 41, the second aerosol generating rod 42, the cooling rod 43, and the filter rod 44 may be aligned sequentially along the lengthwise direction of the aerosol generating article 4. The lengthwise direction of the aerosol generating article 4 may be a direction in which the length of the aerosol generating article 4 extends. For example, the lengthwise direction of the aerosol generating article 4 may be a direction from the first aerosol generating rod 41 to the filter rod 44.

Aerosols generated from the first aerosol generating rod 41 and the second aerosol generating rod 42 may sequentially pass through the first aerosol generating rod 41, the second aerosol generating rod 42, the cooling rod 43, and the filter rod 44 and form an air current; thus, a smoker may inhale the aerosols through the filter rod 44.

The first aerosol generating rod 41 may be heated, thus generating an aerosol. The first aerosol generating rod 41 may include an aerosol generating material. In addition, the first aerosol generating rod 41 may contain other additives, such as a wetting agent and/or organic acid, and include a flavoring liquid, such as menthol. For example, the aerosol generating material may include at least one of glycerin, propylene glycol, ethylene glycol, dipropylene glycol, diethylene glycol, triethylene glycol, tetraethylene glycol, and oleyl alcohol.

The first aerosol generating rod 41 may include an aerosol generating substrate impregnated with the aerosol generating material. The aerosol generating substrate may include a crimped sheet, and the aerosol generating material may be included in the first aerosol generating rod 41 while impregnated in the crimped sheet. Also, while absorbed into the crimped sheet, other additives, such as flavors, a wetting agent, and/or organic acid, and a flavoring liquid may be included in the first aerosol generating rod 41.

The aerosol generating substrate may be arranged inside the first aerosol generating rod 41 while rolled. The rolled aerosol generating substrate may be rolled around the axis extending along the lengthwise direction of the aerosol generating article 4, but one or more embodiments are not limited thereto.

The crimped sheet may be a sheet including a polymer material. For example, the polymer material may include at least one of paper, cellulose acetate, lyocell, and polylactic acid. For example, the crimped sheet may be a paper sheet that, even when heated at a high temperature, does not produce a heat-induced odor.

The first aerosol generating rod 41 may extend from the end portion of the aerosol generating article 4 to the point from about 7 mm to about 20 mm, and the second aerosol generating article 42 may extend from the end point of the first aerosol generating rod 41 to the point from about 7 mm to about 20 mm. However, one or more embodiments are not limited to the numerical ranges stated above, and the extension length of each of the first aerosol generating rod 41 and the second aerosol generating rod 42 may be appropriately adjusted within the range that may be easily modified by one of ordinary skill in the art.

The second aerosol generating rod 42 may be heated, thus generating an aerosol containing nicotine. For example, the second aerosol generating rod 42 may include a tobacco material. The tobacco material may be in the form of tobacco strands, tobacco particles, tobacco sheets, tobacco beads, tobacco granules, tobacco powder, or tobacco extract, but the form of the tobacco material is not limited thereto.

For example, the second aerosol generating rod 42 may include a plurality of tobacco strands, and the plurality of tobacco strands may include sheet tobacco bits. The sheet tobacco bits may be manufactured by finely cutting a tobacco sheet. The sheet tobacco bits may be manufactured according to the following processes. A slurry in which an aerosol generating material (e.g., glycerin, propylene glycol, etc.), a flavoring liquid, a binder (e.g., guar gum, xanthan gum, carboxymethylcellulose, etc.), water, and the like are mixed is made by grinding tobacco ingredients. Natural pulp or cellulose may be added to the slurry, and one or more binders are mixed and used. After the slurry is cast to form a sheet and then dried, a tobacco sheet may be manufactured. The manufactured tobacco sheet may be cut or finely chopped to produce sheet tobacco bits. The tobacco ingredients may be tobacco leaves, tobacco stems, and/or tobacco powder generated during the tobacco processing. Also, other additives, such as wood cellulose fibers, may be contained in the tobacco sheet.

In addition, the second aerosol generating rod 42 may include tobacco bits that are produced by mixing and processing various types of tobacco leaves and then cutting the tobacco leaves. Moreover, a mixture of sheet tobacco bits and tobacco bits may be included in the second aerosol generating rod 42.

Another example, the second aerosol generating rod 42 may include a plurality of tobacco granules. The tobacco granules may be particles with a diameter ranging from about 100 μm to about 2000 μm. The tobacco granules may be manufactured by extruding a mixture of ground tobacco leaves, a pH adjuster, and a solvent.

The tobacco granules may be arranged between filter materials. The filter material may include, for example, a fiber bundle in which cellulose acetate fiber strands are aggregated. The tobacco granules may be uniformly distributed between cellulose fibers. As another example, the filter material may include a crimped paper sheet. The crimped paper sheet may be arranged inside the second aerosol generating rod 42 while rolled. The crimped paper sheet may be rolled with respect to the axis extending along the lengthwise direction of the aerosol generating article 4. The tobacco granules may be distributed and arranged within the rolled paper sheet.

In addition, the second aerosol generating rod 42 may include an aerosol generating substrate impregnated with a liquid aerosol generating composition. The aerosol generating substrate may include a crimped sheet, and the liquid aerosol generating composition may be included in the second aerosol generating rod 42 while impregnated in the crimped sheet. The description of the aerosol generating substrate included in the first aerosol generating rod 41 may be identically applied to the aerosol generating substrate included in the second aerosol generating rod 42.

The liquid aerosol generating composition may include nicotine. Nicotine may include freebase nicotine and nicotine salts. Freebase nicotine may refer to neutral nicotine to which protons are not added. For example, when a strong base such as ammonia is added to nicotine salt carrying a positive charge, the strong base may be converted into a positive ion, and the nicotine salt may become freebase nicotine in a neutral state.

In addition, the liquid aerosol generating composition may include an aerosol generating material. The description regarding the aerosol generating substrate included in the first aerosol generating rod 41 may be identically applied to the aerosol generating material.

The liquid aerosol generating composition may be impregnated in an amount of about 0.05 g to about 1.0 g per 1 g of the aerosol generating substrate. For example, the liquid aerosol generating composition may be impregnated in an amount of about 0.1 g to about 0.8 g per 1 g of the aerosol generating substrate.

The cooling rod 43 may cool the aerosol generated from the first aerosol generating rod 41 and the second aerosol generating rod 42. The cooling rod 43 may be formed of a biodegradable polymer material and have a cooling function. For example, the cooling rod 43 may be formed of polylactic acid (PLA) fibers, but one or more embodiments are not limited thereto.

Alternatively, the cooling rod 43 may include a cellulose acetate filter. However, the cooling rod 43 is not limited thereto, and any material having an aerosol cooling function may be used. For example, the cooling rod 43 may be a tube filter including a hollow or a paper tube formed of paper.

At least one hole 431 may be formed in an outer surface of the cooling rod 43. At least one hole 431 may be formed along a circumferential direction of the cooling rod 43 and form at least one column. At least one hole 431 may allow external air to be introduced into the cooling rod 43. The external air introduced into the cooling rod 43 may be mixed with a high-temperature aerosol generated in the first aerosol generating rod 41 and the second aerosol generating rod 42 and thus cool the aerosol.

The filter rod 44 may filter some components included in the aerosol passing through the filter rod 44. The filter rod 44 may include a filter material. For example, the filter rod 44 may include a cellulose acetate filter. The filter rod 44 may be manufactured by adding a plasticizer (e.g., triacetin) to cellulose acetate tow.

Shapes of the filter rod 44 are not limited. For example, the filter rod 44 may include a cylinder-type rod or a tube-type rod having a hollow inside. Alternatively, the filter rod 44 may be a recess-type rod including a hollow with an open end portion. When the filter rod 44 includes a plurality of segments, at least one of the plurality of segments may have a different shape.

The filter rod 44 may be formed to generate flavors. For example, the filter rod 44 may include a flavoring liquid, and an additional fiber including the flavoring liquid may be inserted into the filter rod 44.

Also, the filter rod 44 may include at least one capsule. Here, the capsule may generate a flavor or an aerosol. For example, the capsule may have a configuration in which a liquid containing a flavoring material is wrapped with a film. For example, the capsule may have a spherical or cylindrical shape, but is not limited thereto.

The aerosol generating article 4 may include a wrapper 45 surrounding at least a portion of the first aerosol generating rod 41 to the filter rod 44. In addition, the aerosol generating article 4 may include a wrapper 45 that entirely surrounds the first aerosol generating rod 41 to the filter rod 44. The wrapper 45 may be located on the outermost portion of the aerosol generating article 4, and the wrapper 45 may be a single wrapper or a combination of wrappers.

The aerosol generating article 4 may be doubly packaged via at least two wrappers. For example, the first aerosol generating rod 41 may be packaged via a first wrapper 45a, the second aerosol generating rod 42 may be packaged via a second wrapper 45b, the cooling rod 43 may be packaged via a third wrapper 45c, and the filter rod 44 may be packaged via a fourth wrapper 45d. Further, the entire aerosol generating article 4 may be repackaged via a fifth wrapper 45e.

The first wrapper 45a may surround the first aerosol generating rod 41, and the second wrapper 45b may surround the second aerosol generating rod 42. The first wrapper 45a and the second wrapper 45b may be a combination of paper and metal foil, such as aluminum foil. For example, the first wrapper 45a and the second wrapper 45b may each be a laminated sheet in which paper and metal foil are stacked. The first wrapper 45a and the second wrapper 45b may each be a laminated sheet in which paper is placed on a surface of metal foil or a laminated sheet in which paper is placed on both surfaces of metal foil.

The paper of the first wrapper 45a may include an oil-resistant material. For example, the paper of the first wrapper 45a may include polyvinyl alcohol (PVOH) or silicon. The surface of the paper of the first wrapper 45a may be coated with PVOH or silicon.

The third wrapper 45c may surround the cooling rod 43. The third wrapper 45c may include wrapping paper. The wrapping paper of the third wrapper 45c may be porous wrapping paper or non-porous wrapping paper. At least one perforation 45f may be formed in the third wrapper 45c. For example, the third wrapper 45c may be configured to package the cooling rod 43 including at least one hole 431, and at least one perforation 45f in the third wrapper 45c may be formed at a position corresponding to the at least one hole 431 formed in the cooling rod 43.

The fourth wrapper 45d may surround the filter rod 44. The fourth wrapper 45d may include hard wrapping paper having greater thickness and basis weight compared to general wrapping paper. For example, the thickness of the hard wrapping paper may be in a range from about 70 μm to about 150 μm, and the basis weight thereof may be in a range from about 50 g/m² to about 100 g/m². In addition, the hard wrapping paper may include an oil-resistant material. For example, the hard wrapping paper may include a surface treatment performed using the oil-resistant material, such as PVOH or silicon.

The fifth wrapper 45e may collectively surround the first aerosol generating rod 41 packaged via the first wrapper 45a, the second aerosol generating rod 42 packaged via the second wrapper 45b, the cooling rod 43 packaged via the third wrapper 45c, and the filter rod 44 packaged via the fourth wrapper 45d. The fifth wrapper 45e may prevent the exterior of the aerosol generating article 4 from being contaminated by the aerosol generated in the aerosol generating article 4. By a user's puff, liquid substances may be generated in the aerosol generating article 4. For example, as the aerosol generated in the aerosol generating article 4 is cooled by external air, liquid substances (e.g., moisture, etc.) may be generated. As the fifth wrapper 45e packages the outer surface of the aerosol generating article 4, the generated liquid substances may be prevented from leaking out of the aerosol generating article 4.

One or more embodiments of the disclosure relate to an aerosol generating device and an aerosol generating article that may distinguish different types of aerosol generating articles and identify an aerosol generating article suitable for use with the aerosol generating device and an aerosol generating article that is unsuitable for use with the aerosol generating device.

To this end, the aerosol generating article according to an embodiment may include an identification material. The identification material may be arranged on a component of the aerosol generating article. For example, the identification material may be arranged on a wrapper, a filter rod, a tobacco rod, a front-end plug, and/or an aerosol generating rod. One or more embodiments below are described based on an example in which the identification material is arranged on the wrapper, but as described above, the components on which the identification material may be arranged may vary.

The identification material may have physical, chemical, or optical properties. The identification material may be a material that changes the properties of the wavelength of transmitted light and then emits the light. Specifically, the identification material may be excited as light in a specific wavelength range is absorbed. In the present specification, ‘excitation of a material’ may indicate that the material state changes from a ground state to an excited state. Then, while the state of the identification material transitions from the excited state to the ground state, the light in a specific wavelength range may be emitted from the identification material. For example, the identification material may be a material included in the lanthanide series and may include a material containing at least one element with an atomic number from 57 to 71.

In an embodiment, the identification material may include a taggant. The taggant may include a spectrometric signature that is identifiable when light is absorbed and/or emitted. The taggant may absorb light in a specific wavelength range when light is emitted from an emission portion of the aerosol generating device. The taggant may be excited by absorbing light and emit at least one wavelength of light transitioning from the wavelength of the excited light. In this case, the light emitted from the taggant may be in the form of photoluminescence and may be phosphorescence or fluorescence.

The light in a specific wavelength range that is emitted from the taggant may be received by a light-receiving portion of the aerosol generating device. Based on the wavelength of the light received by the light-receiving portion, the aerosol generating device may identify the type of aerosol generating article.

The wavelength in a specific range that is emitted from the taggant may be determined based on the amount, concentration, type, and/or composition ratio of the taggant material.

The taggant may include an organic material. In an embodiment, the taggant may include one or more organic materials selected from the group consisting of quinazolinone-based compounds, thiophene-based compounds, sulfobenzoic acid-based compounds, and naphthyridine-based compounds.

The quinazolinone-based compounds may include quinazolinone derivatives or salts thereof. For example, the quinazolinone-based compounds may include 4(3H)-quinazolinone,6-chloro-2-(5-chloro-2-hydroxyphenyl), 4(3H)-quinazolinone,6-chloro-2-(4-chloro-2-hydroxyphenyl), 4(3H)-quinazolinone,7-chloro-2-(5-chloro-2-hydroxyphenyl); and 2-(5-chloro-2-hydroxy-phenyl)-3H-quinazolin-4-on.

The thiophene-based compounds may include thiophene derivatives or salts thereof. For example, the thiophene-based compounds may include 2,5-bis(5-tert-butyl-2-benzoxazolyl)thiophene.

The sulfobenzoic acid-based compounds may include sulfobenzoic acid derivatives or salts thereof. For example, the sulfobenzoic acid-based compounds may include benzoic acid, 2-[(2-hydroxy-5-sulfobenzoyl)amino]-,monosodium salt.

The naphthyridine-based compounds may include naphthyridine derivatives or salts thereof. For example, the naphthyridine-based compounds may include a 1,8-naphthyridine derivative and a 1,5-naphthyridine derivative.

In addition, the taggant may include an inorganic material. In one embodiment, the taggant may include one or more inorganic materials selected from the group consisting of rare earth elements, actinide metal oxide, and ceramic. For example, the rare earth element may include one or more lanthanide series selected from the group consisting of lanthanum, cerium, praseodymium, neodymium, promethium, samarium, europium, gadolinium, terbium, dysprosium, holmium, erbium, thulium, ytterbium, and lutetium.

In addition, the taggant may include a combination of an organic material and an inorganic material. In an embodiment, the taggant may include a material in which an organic material and an inorganic material are covalently, coordinately, or ionically bonded. For example, the taggant may be a material in which a lanthanide inorganic material is coordinately bonded to an organic material. For example, the taggant may include europium, tris[7-chloro-1-cyclopropyl-6-fluoro-1,4-dihydro-4-(oxo-kappaO)-1,8-naphthyridine.

The difference between the maximum absorption wavelength (Absₘₐₓ) of the light irradiated onto the identification material and a dominant wavelength (DWL) of emitted light may be at least about 20% with respect to the Absₘₐₓ. When the difference between the Absₘₐₓ and the DWL of the identification material falls within the above-described numerical range, the identification material may exhibit significant identification accuracy. When the difference between the Absₘₐₓ and the DWL of the identification material is less than about 20%, light reflected from components other than the identification material may act as noise, leading to a decrease in identification accuracy. For example, the difference between the Absₘₐₓ and the DWL of the light irradiated onto the identification material may be in a range of about 25% to about 70% with respect to the Absₘₐₓ. Additionally, the difference between the Absₘₐₓ and the DWL of the light irradiated onto the identification material may be in a range of about 30% to about 65% with respect to the Absₘₐₓ.

### Experimental Example: Experiment on Light Emission of Identification Material Containing Taggant

After light is irradiated onto the identification material including the taggant, the wavelength of emitted light was identified. The irradiated light has a wavelength of about 365 nm, and the DWL of the emitted light was measured. The results are recorded in Table 1 below.

As in Table 1, Embodiment 1 is a quinazolinone-based compound, 4(3H)-quinazolinone,6-chloro-2-(5-chloro-2-hydroxyphenyl); Embodiment 2 is a quinazolinone-based compound, 2-(5-chloro-2-hydroxy-phenyl)-3H-quinazolin-4-on; Embodiment 3 is a thiophene-based compound, 2,5-bis(5-tert-butyl-2-benzoxazolyl)thiophene and a sulfobenzoic acid-based compound that is benzoic acid, 2-[(2-hydroxy-5-sulfobenzoyl)amino]-, a mixture of monosodium salt (85-90:10-15 weight ratio); and Embodiment 4 is europium, tris[7-chloro-1-cyclopropyl-6-fluoro-1,4-dihydro-4-(oxo-kappaO)-1,8-naphthyridine.

TABLE 1

| | Maximum | | |
|---|---|---|---|
| | Absorption | | Dominant |
| | Wavelength | | Wavelength |
| Classification | (nm, Absₘₐₓ) | CIE color coordinates | (nm, DWL) |
| Embodiment 1 | 396 | X = 0.4300 ± 0.05y = | 546.4 ± 5 |
| | | 0.5347 ± 0.05 | |
| | | (Yellow) | |
| Embodiment 2 | 382 | X = 0.3232 ± 0.05Y = | 518.8 ± 5 |
| | | 0.5943 ± 0.05 | |
| | | (Green) | |
| Embodiment 3 | 364 | X = 0.1590 ± 0.05Y = | 471.3 ± 5 |
| | | 0.1825 ± 0.05 | |
| | | (Blue) | |
| Embodiment 4 | 382 | X = 0.6633 ± 0.02Y = | 622 ± 5 |
| | | 0.3155 ± 0.02 | |
| | | (Red) | |

As shown in Table 1, it was found in Embodiment 1 to Embodiment 4 that light is absorbed and excited, and light at a wavelength that is different from that of the absorbed light is emitted. In addition, it was identified in Embodiment 1 to Embodiment 4 that the difference between the Absₘₐₓ of the irradiated light and the DWL of the emitted light is at least about 20% with respect to the Absₘₐₓ, (Embodiment 1: about 38%, Embodiment 2: about 36%, Embodiment 3: about 29%, and Embodiment 4: about 63%).

The taggant may be added to a paper slurry or paste before a component (e.g., a wrapper) of an aerosol generating article is dried, or the taggant may be painted or sprayed onto the component. The taggant may be included in the component of the aerosol generating article in nanogram units.

In an embodiment, the aerosol generating article may include a taggant in an amount that is equal to or greater than a preset first content. Accordingly, the aerosol generating article may include a sufficient amount of taggant to emit light in a specific wavelength range. For example, when the taggant is sprayed onto the surface, the sprayed solution may contain the taggant at a concentration ranging from about 1 ppm to about 1000 ppm. As another example, the taggant may be applied to the wrapper at a concentration of about 6 mg/mm² or higher.

In an embodiment, an identification material solution may be spread onto the surface of the component of the aerosol generating article. Here, the identification material solution may refer to a liquid composition including the identification material. For example, the identification material solution may be used to coat the surface of the wrapper of the aerosol generating article. As another example, the identification material solution may be printed on the surface of the wrapper of the aerosol generating article.

For example, the identification material solution may be produced according to a manufacturing method that includes preparing an identification material, producing a primary solution by mixing the identification material with an overprint (OP) varnish, and manufacturing an identification material solution by mixing the primary solution with a diluent. The manufactured identification material may be applied to the component of the aerosol generating article.

The preparing of the identification material may be a process of preprocessing the identification material to have a shape or physical property suitable for application to the components of the aerosol generating article. For example, the identification material included in the identification material solution may be a plurality of particles with a diameter ranging from about 0.1 μm to about 10 μm. The identification material may be milled to have the diameter in the aforementioned range. When the identification material has the diameter in the aforementioned range, the identification material may be uniformly distributed and arranged on the surface of the aerosol generating article to which the identification material solution is applied, and thus, the printability may be improved. When the identification material has a diameter of less than about 0.1 μm, it may be difficult to detect the light emitted from the identification material. When the identification material has a diameter of greater than about 10 μm, the uniform distribution of the identification material may be difficult, and the printability may degrade. The identification material may have the diameter in a range, for example, from about 0.5 μm to about 5 μm or from about 0.7 μm to about 3 μm.

The identification material solution may include an OP varnish. In the present specification, the OP varnish may refer to a liquid coating that is solidified through curing. For example, the OP varnish may include one or more materials selected from the group consisting of nitrocellulose, polyamide, propyl acetate, isopropyl alcohol, ethyl acetate, and 1,2-cyclohexane dicarboxylic acid diisononyl ester (DINCH).

The identification material solution may include a diluent. The diluent may be a diluent used for gravure printing or offset printing, which is well known in the field. For example, the diluent may include one or more materials selected from the group consisting of water, an alcohol having 1 to 4 carbon atoms, vegetable oil, a fatty amine, propyl acetate, isopropyl alcohol, and ethyl acetate. The vegetable oil may include one or more oils selected from the group consisting of flaxseed oil, soybean oil, castor oil, corn oil, tung oil, otticita oil, and coconut oil. The fatty amine may be one or more components selected from the group consisting of oleyl amine, stearyl amine, and oleyl diamine.

For example, the identification material solution may include about 0.01 wt % to about 20 wt % of the identification material, about 10 wt % to about 40 wt % of the OP varnish, and about 50 wt % to about 85 wt % of the diluent, but one or more embodiments are not limited thereto. The identification material solution may include about 0.05 wt % to about 10 wt % of the identification material, about 15 wt % to about 30 wt % of the OP varnish, and about 60 wt % to about 80 wt % of the diluent.

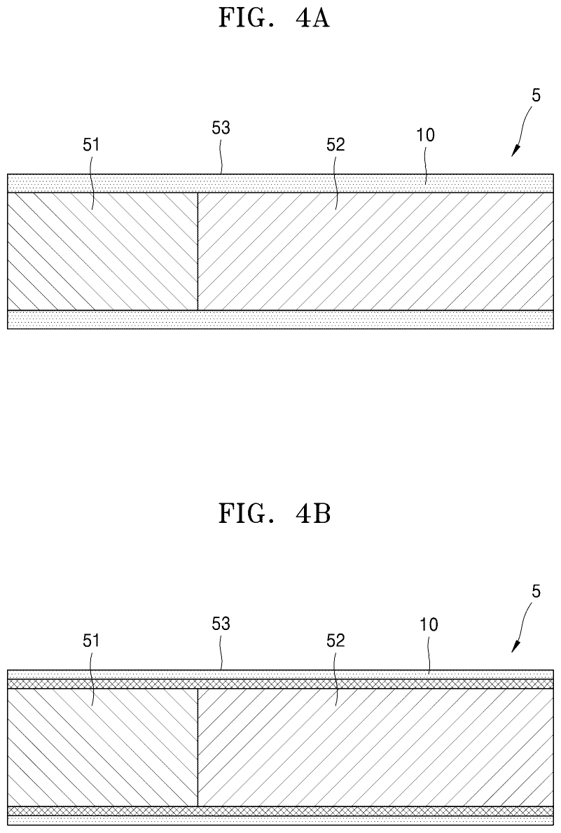

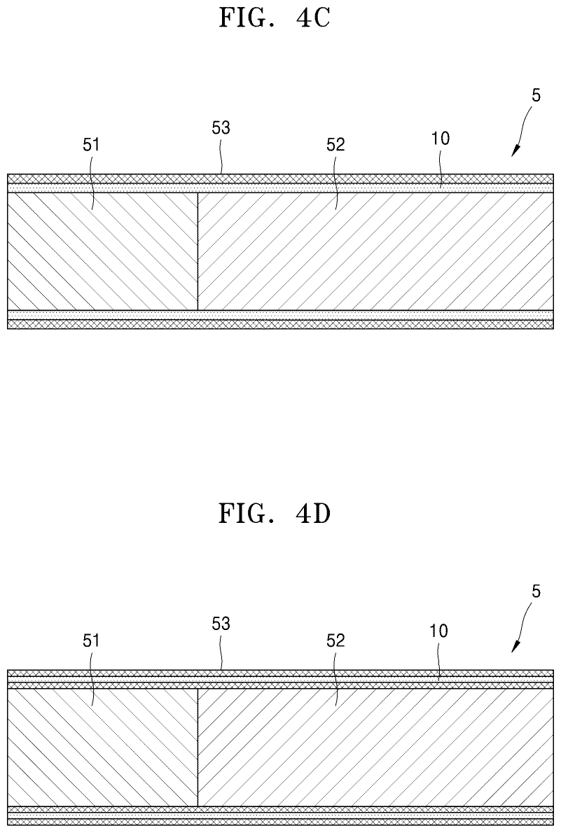

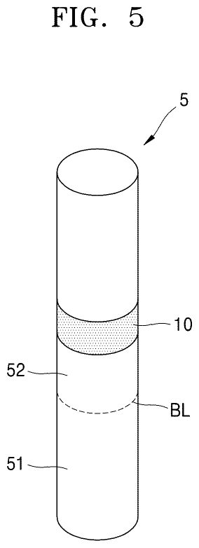

Hereinafter, with reference to FIGS. 4A to 5D, various embodiments regarding the arrangement location/method of the identification material are examined in sequence.

FIGS. 4A to 4D are side cross-sectional views of an aerosol generating article for explaining examples of an arrangement location/method of an identification material.

Referring to FIGS. 4A to 4D, a cigarette 5 may include an identification material 10, a tobacco rod 51, a filter rod 52, and a wrapper 53. At least one of the components of the cigarette 5 shown in FIGS. 4A to 4D is the same as or similar to at least one of the components of the components of the aerosol generating article described above, and thus, detailed descriptions thereof are omitted. In addition, it is obvious that some components and configurations may be replaced, added, or omitted within a range that one of ordinary skill in the art may easily understand by referring to the drawings and descriptions below.

Referring to FIG. 4A, the identification material 10 may be uniformly arranged on the entire wrapper 53 along the lengthwise direction of the wrapper 53. Accordingly, because a sensor module of the aerosol generating device may sense the entire region of the wrapper 53 on which the identification material 10 is arranged, the degree of freedom in the arrangement of the sensor module may increase. As a result, the ease of the manufacturing process of the aerosol generating device may be improved.

In addition, because the identification material 10 is exposed to the outer surface of the wrapper 53, the sensor module of the aerosol generating device may easily detect the identification material 10. In other words, the sensitivity of the sensor module may be improved.

The identification material 10 shown in FIG. 4A may be uniformly arranged on the entire region of the wrapper 53 in a manner that the identification material 10 is added to a paper slurry or paste during the manufacturing process of the wrapper 53.

Referring to FIG. 4B, the identification material 10 may be arranged on the outer circumferential surface of the wrapper 53 along the lengthwise direction of the wrapper 53. Accordingly, the sensor module of the aerosol generating device may sense the entire region of the wrapper 53 along the lengthwise direction of the wrapper 53 on which the identification material 10 is arranged, and thus, the degree of freedom in the arrangement of the sensor module may be improved.

Additionally, because the identification material 10 is exposed to the outer surface of the wrapper 53, the sensor module of the aerosol generating device may easily detect the identification material 10. In other words, the sensitivity of the sensor module may be improved.

Moreover, based on the improved sensitivity, the amount of the identification material 10 used may be reduced compared to the embodiment shown in FIG. 4A.

The identification material 10 shown in FIG. 4B may be arranged along the lengthwise direction of the wrapper 53 in a manner that the identification material 10 is sprayed onto the surface of the wrapper 53.

Referring to FIG. 4C, the identification material 10 may be arranged on the inner surface of the wrapper 53 along the lengthwise direction of the wrapper 53. Accordingly, the identification material 10 may not be separated from the wrapper 53 without a separate adhesive. Therefore, the accuracy of identifying the identification material 10 by the aerosol generating device may be improved, and the process of attaching the identification material 10 to the wrapper 53 may be omitted from the manufacturing process of the cigarette 5.

The identification material 10 of FIG. 4C may be arranged on the inner surface of the wrapper 53 in a manner that the identification material 10 is sprayed onto the inner surface of the wrapper 53. In this case, the thickness of the wrapper 53 may be set in an appropriate range to allow the sensor module of the aerosol generating device to identify the identification material 10 arranged on the inner surface of the wrapper 53. For example, the thickness of the wrapper 53 may be in a range from about 10 μm to about 200 μm.

Referring to FIG. 4D, two wrappers 53 may overlap and surround the cigarette 5. The identification material 10 may be arranged between two overlapping wrappers 53 along the lengthwise direction of the wrapper 53. Accordingly, the identification material 10 may not be separated from the wrapper 53 without a separate adhesive. Therefore, the accuracy of identifying the identification material 10 by the aerosol generating device may be improved, and the process of attaching the identification material 10 to the wrapper 53 may be omitted from the manufacturing process of the cigarette 5.

In addition, compared to the embodiment shown in FIG. 4C, the identification material 10 is arranged close to the outer circumferential surface of the wrapper 53, and thus, the sensor module of the aerosol generating device may easily detect the identification material 10. That is, the sensitivity of the sensor module may be improved compared to the embodiment shown in FIG. 4C.

FIG. 5 is a perspective view of an aerosol generating article for explaining an arrangement location of an identification material.

Because the cigarette 5 shown in FIG. 5 may be at least any one of the aerosol generating articles described above, repeated descriptions are omitted below.

Also, at least one configuration or feature stated in the above-described embodiments may be combined with the cigarette 5, unless technically clearly impossible. For example, the embodiment shown in FIG. 5 is described based on the identification material 10 being arranged on the outer surface of the wrapper, but one or more embodiments are not limited thereto. The identification material 10 shown in FIG. 5 may be arranged on the inner surface of the wrapper.

Referring to FIG. 5, the identification material 10 may be arranged in a band pattern along the circumferential direction of the cigarette 5, but may be arranged only on a portion of the cigarette 5 along the lengthwise direction of the cigarette 5. In this case, because the sensor module of the aerosol generating device is arranged at a specific position along the circumferential direction of the cigarette 5 to detect the identification material 10, the degree of freedom in the arrangement of the sensor module may increase.

In addition, compared to the embodiment in which the identification material 10 is arranged on the entire region of the wrapper along the lengthwise direction of the wrapper, the amount of the identification material 10 used may be reduced.

For example, the region where the identification material 10 is arranged may extend about 1 mm to about 10 mm along the lengthwise direction of the cigarette 5. For example, the region where the identification material 10 is arranged may extend about 2 mm to about 7 mm along the lengthwise direction of the cigarette 5.

In addition, the cigarette 5 may include the tobacco rod 51 and the filter rod 52 which are sequentially arranged along the lengthwise direction of the cigarette 5, and the identification material 10 may be arranged in a region extending towards the filter rod 52 from the boundary BL between the tobacco rod 51 and the filter rod 52.

The length from the lower portion of the region where the identification material 10 is arranged to the boundary BL between the tobacco rod 51 and the filter rod 52 may be about 0 mm to about 5 mm. Thus, in the above range, the heat applied to the cigarette 5 may be prevented from being delivered to the identification material 10. For example, the length from the lower portion of the region where the identification material 10 is arranged to the boundary BL between the tobacco rod 51 and the filter rod 52 may be about 1 mm to about 3 mm.

Hereinafter, in the embodiment in which the identification material is arranged on the outer surface of the wrapper, a separation preventing portion that prevents the separation of the identification material from the wrapper is described with reference to the attached drawing.

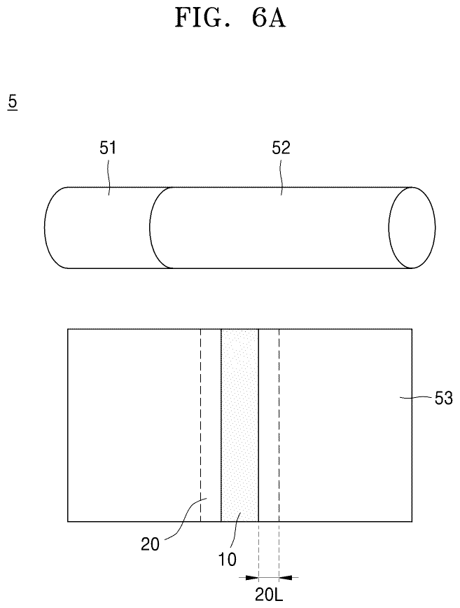

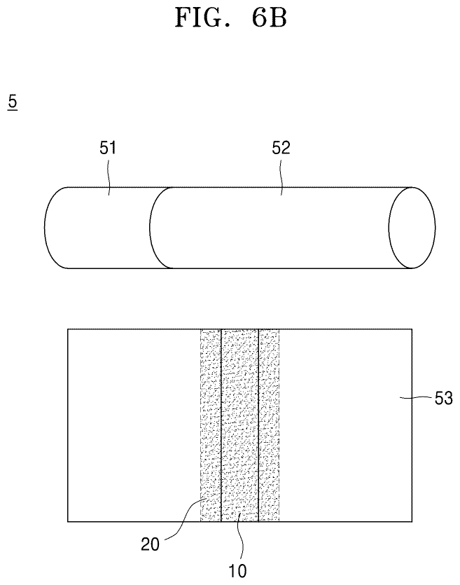

FIGS. 6A and 6B illustrate a tobacco rod, a filter rod, and a wrapper separated from an aerosol generating article.

Referring to FIGS. 6A and 6B, the cigarette 5 may include the identification material 10, a separation preventing portion 20, the tobacco rod 51, the filter rod 52, and the wrapper 53. At least one of the components of the cigarette 5 shown in FIGS. 6A and 6B is the same as or similar to at least one of the components of the components of the aerosol generating article described above, and thus, repeated descriptions thereof are omitted. In addition, it is obvious that some components and configurations may be replaced, added, or omitted within a range that one of ordinary skill in the art may easily understand by referring to the drawings and descriptions below.

The separation preventing portion 20 may prevent the identification material 10 from being separated from the wrapper 53. The separation preventing portion 20 may be arranged on the wrapper 53 to cover the region where the identification material 10 is arranged. Although covering the region where the identification material 10 is arranged, the separation preventing portion 20 may be transparent not to block the light irradiated onto the identification material 10.

As shown in FIG. 6B, the separation preventing portion 20 may be discolored at the temperature at which the tobacco rod 51 is heated. For example, the separation preventing portion 20 may include a thermo-chromic material that remains transparent before heated, but is discolored after exposed to heat. Because the separation preventing portion 20 is arranged to cover the identification material 10, the identification material 10 may be covered when the separation preventing portion 20 is discolored. Accordingly, the user may easily check with the naked eye whether the cigarette 5 has been used. For example, when the separation preventing portion 20 is heated to a temperature ranging from about 200° C. to about 400° C., the separation preventing portion 20 may be discolored from transparent to opaque brown.

The temperature at which the separation preventing portion 20 is discolored may be higher than an activation temperature of the identification material 10. In the present specification, the activation temperature of the identification material 10 may be the threshold temperature at which the identification material 10 emits light at a wavelength that is different from that of the irradiated light. When the temperature at which the separation preventing portion 20 is discolored is equal to or lower than the activation temperature of the identification material 10, the separation preventing portion 20 is discolored before the identification material 10 emits light, and the light irradiated onto the identification material 10 may be blocked; thus, the sensor module may fail to detect the identification material 10. According to an embodiment, because the temperature at which the separation preventing portion 20 is discolored is higher than the activation temperature of the identification material 10, the integrity of the process of identifying the identification material 10 by the sensor module may be ensured.

In an embodiment, the area of the separation preventing portion 20 may be greater than the area of the region where the identification material 10 is arranged, and the separation preventing portion 20 may be arranged to prevent the external exposure of the region where the identification material 10 is arranged. For example, the end portion of the separation preventing portion 20 may be spaced from the end portion of the identification material 10 by a preset distance 20L. The preset distance 20L may be about 1 mm to about 10 mm.

When the preset distance 20L is less than about 1 mm, the likelihood of the identification material 10 being separated from the wrapper 53 may increase. In addition, when the preset distance 20L is greater than about 10 mm, the area of the separation preventing portion 20 becomes excessively great, which may result in unintended heating.

In an embodiment, the separation preventing portion 20 may include an adhesive material. The separation preventing portion 20 may include the same material as the OP varnish in the identification material solution. For example, the separation preventing portion 20 may include one or more materials selected from the group consisting of nitrocellulose, polyamide, propyl acetate, isopropyl alcohol, ethyl acetate, and DINCH.

Hereinafter, the aerosol generating device using the aerosol generating article mentioned above is described with reference to the attached drawings.

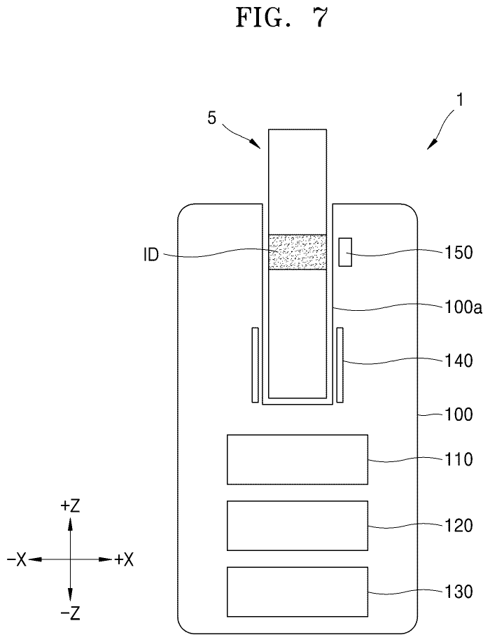

FIG. 7 is a schematic side view of an aerosol generating system according to an embodiment. In the present specification, the aerosol generating system may refer to a combination of the aerosol generating article and the aerosol generating device.

Referring to FIG. 7, an aerosol generating device 1 may include an aerosol generating device main body 100, a controller 110, a battery 120, a memory 130, a heater 140, and a sensor unit 150. However, components of the aerosol generating device 10 are not limited thereto, and according to embodiments, other components may be added thereto or at least one component may be omitted.

In addition, at least one of the components of the aerosol generating system of FIG. 7 is the same as or similar to at least one of the components of the aerosol generating system described above, and thus, repeated descriptions thereof are omitted. In addition, it is obvious that some components and configurations may be replaced, added, or omitted within a range that one of ordinary skill in the art may easily understand by referring to the drawings and descriptions below.

The aerosol generating device main body 100 may form a general exterior of the aerosol generating device 1. The aerosol generating device main body 100 may accommodate the components of the aerosol generating device 1.

In the aerosol generating device main body 100, a cavity 100a for accommodating the cigarette 5 may be formed. The cigarette 5 accommodated in the cavity 100a may be heated by the heater 140. The cavity 100a may be an elongated cavity, a coupling region, an insertion region, or a heating region that accommodates the cigarette 5. The cavity 100a may have a shape corresponding to at least some portions of the cigarette 5. For example, the cavity 100a may have a shape extending from an opening in a direction (e.g., a −Z direction). The cigarette 5 may pass through the opening and be inserted into the cavity 100a in a lengthwise direction thereof.

The cigarette 5 accommodated in the cavity 100a may include the identification portion ID described above. The identification portion ID may be on at least some portions of the outer circumferential surface of the cigarette 5. When the cigarette 5 is accommodated in the cavity 100a, the identification portion ID may be inside the aerosol generating device main body 100.

The controller 110 may control general operations of the aerosol generating device 1. The controller 110 may be implemented as an array of a plurality of logic gates or a combination of a general-purpose microprocessor and a memory in which a program executable in the microprocessor is stored, but is not limited thereto.

The controller 110 may control the power supplied to the heater 140 from the battery 120. For example, the controller 110 may control the amount and duration of the power supplied from the battery 120 to the heater 140 so that the heater 140 is heated to a specific temperature or maintained at a designated temperature.

In an embodiment, the controller 110 may receive a sensing result from the sensor unit 150. The memory 130 may be connected to the controller 110 and store executable instructions. The controller 110 may control the operation of the aerosol generating device 1 by executing the instructions stored in the memory 130.

In an embodiment, the controller 110 may receive the sensing result from the sensor unit 150 and execute an instruction related to the sensor unit 150 from among the instructions stored in the memory 130, thereby identifying identification information regarding the cigarette 5 based on the amount of light emitted from the identification portion ID. For example, the identification information may be information regarding the type of cigarette 5, the authenticity of the cigarette 5, and/or materials contained therein. The controller 110 may control the operation of the aerosol generating device 1 based on the identified identification information.

Specifically, the controller 10 may control the power supply to the heater 140 based on the determined information of the cigarette 5. The controller 110 may execute an instruction regarding the operation of the heater 140 from among the instructions stored in the memory 130 and thus differently control the operation of the heater 140 based on the identification information.

The battery 120 may supply power used to operate the aerosol generating device 1. For example, the battery 120 may be electrically connected to the heater 140 and supply power to heat the heater 140. In addition, the battery 120 may supply power necessary to operate other components (e.g., the controller 110, etc.) of the aerosol generating device 1. The battery 120 may be a rechargeable battery or a disposable battery. For example, the battery 120 may be a lithium polymer (LiPoly) battery, but the type of the battery 120 is not limited thereto.

The memory 130 is a hardware component that stores various types of data processed in the aerosol generating device 1, and may store data processed and data to be processed by the controller 110.

The memory 130 may store information regarding an appropriate temperature profile and operation, based on various details, such as the type of cigarette 5, the types of substances contained therein, the content ratio of the substances, and the humidity level. The controller 110 may execute an instruction regarding the operation of the heater 140 (e.g., driving cycle, intensity, etc.) from the memory 140 and may perform the corresponding operation for the cigarette 5 based on the identification portion ID.

The heater 140 may heat at least a portion of the cigarette 5 by receiving power from the battery 120. For example, the heater 140 may be arranged on the outer side of the tobacco rod of the cigarette 5 and heat the tobacco rod.

The heater 140 is not limited to the example shown in FIG. 7. That is, the heater 140 shown in FIG. 7 is arranged on the outer side of the cigarette 5, but the heater 140 may include a tube-type heating element, a plate-type heating element, a needle-type heating element, or a rod-type heating element. In this case, the heater 140 may be inserted into the cigarette 5 and heat the interior of the cigarette 5.

The sensor unit 150 may be arranged on the aerosol generating device main body 100 to identify the identification portion ID of the cigarette 5. The sensor unit 150 may be arranged near the cavity 100a to be at a position corresponding to the identification portion ID.

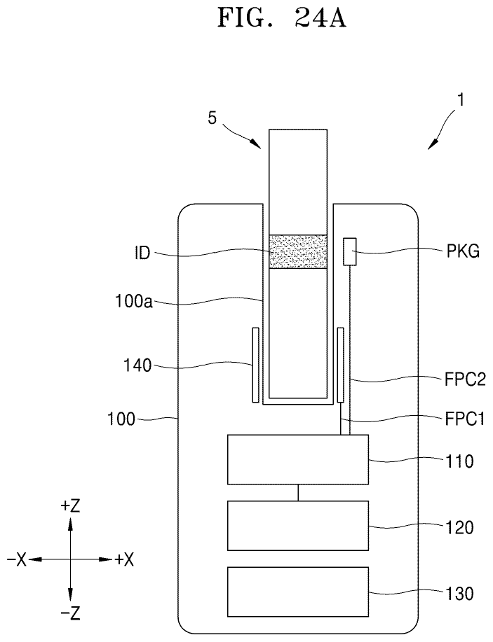

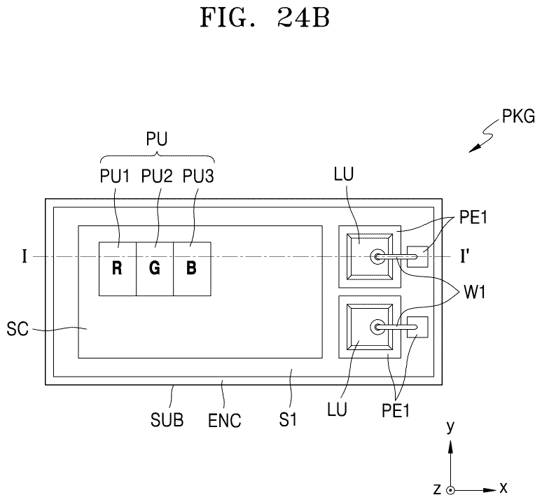

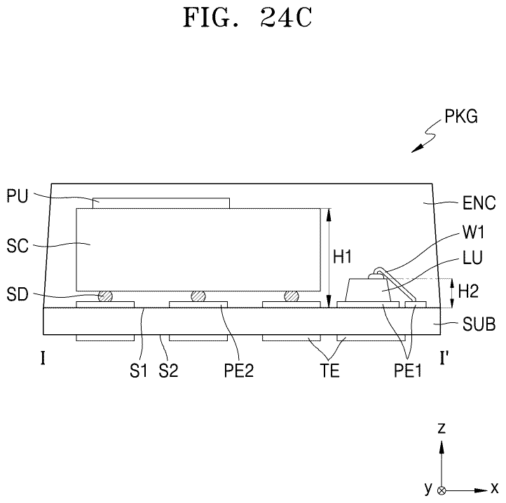

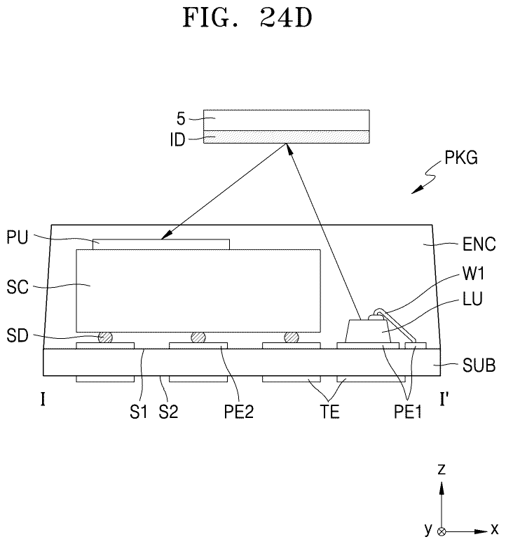

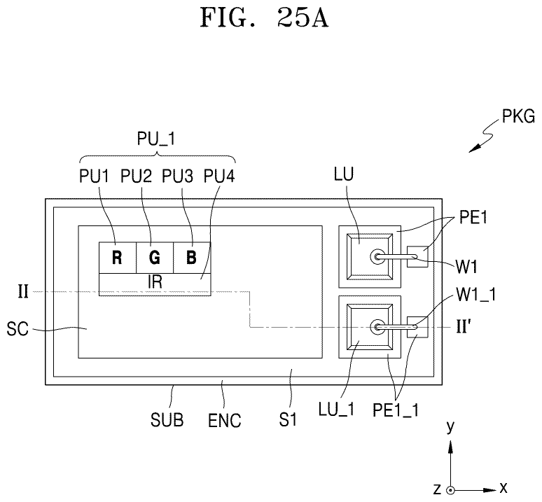

Although not shown in FIG. 7, the sensor unit 150 according to an embodiment may be of an optical sensor package type including an emission portion and a light-receiving portion. The optical sensor package is described below in detail with reference to FIGS. 24A to 32B.

The emission portion may emit light of a first wavelength towards the cavity 100a. For example, when a current flows, the emission portion may include at least one light-emitting diode emitting light of a first wavelength.

In an embodiment, at least part of the light of the first wavelength that is emitted from the emission portion may be delivered to the identification portion ID of the cigarette 5. The light of the first wavelength may be excited in the identification portion ID, and the identification portion ID may emit light of a second wavelength that is different from the first wavelength. The optical characteristics, such as wavelengths and quantity of light emitted from the identification portion ID, may be determined based on the amount, concentration, type, and/or composition ratio of the identification portion ID.

The light-receiving portion may receive the light emitted from the identification portion ID of the cigarette 5. For example, the light-receiving portion may include at least one light-receiving diode through which a current flows when light is irradiated.

The light-receiving portion may sense optical characteristics (e.g., the amount of light of a second wavelength) of the light emitted from the cigarette 5 and identify the identification information regarding the cigarette 5. The light-receiving portion may provide a sensing result to the controller 110.

Hereinafter, the light of the first wavelength emitted from the emission portion and the light of the second wavelength received by the light-receiving portion are described.

In an embodiment, the light of the first wavelength may be infrared light, and the light of the second wavelength may be infrared light having a wavelength different from the first wavelength. For example, the first wavelength may be in a range from about 930 nm to about 990 nm. The second wavelength may be in a range from about 1000 nm to about 1020 nm. For example, the first wavelength may be about 980 nm, and the second wavelength may be about 1012 nm.

Accordingly, the sensor unit 150 may use light of a first wavelength and light of a second wavelength, both of which are infrared light, and thus may detect the identification information of the cigarette 5 without being visually exposed to the user.

In an embodiment, the light of the first wavelength may be ultraviolet light, and the light of the second wavelength may be infrared light. For example, the first wavelength may be in a range from about 300 nm to about 340 nm. The second wavelength may be in a range from about 1000 nm to about 1020 nm. For example, the first wavelength may be about 320 nm, and the second wavelength may be about 1012 nm.

In an embodiment, the light in the first wavelength may be ultraviolet light, and the light in the second wavelength may be visible light. In this case, the light-receiving portion may be a color sensor. The color sensor may include a Red Green Blue (RGB) sensor or an XYZ optical sensor for measuring, determining, or distinguishing colors of identification indicators. The RGB sensor may include light sources having three colors and detect color information by reflecting light to an object. The XYZ optical sensor may include a light-to-digital converter and detect xy chromaticity coordinates according to the Commission Internationale de l'Eclairage (CIE) 1931 color space.

For example, the first wavelength may be in a range from about 340 nm to about 375 nm, and the second wavelength may be in a range from about 380 nm to about 780 nm. For example, the first wavelength may be about 365 nm, and the second wavelength may be in a range from about 613 nm to about 627 nm (red light). As another example, the first wavelength may be about 365 nm, and the second wavelength may be in a range from about 540 nm to about 551 nm (yellow light). In addition, the first wavelength may be about 365 nm, and the second wavelength may be in a range from about 513 nm to about 537 nm (green light). Moreover, the first wavelength may be about 365 nm, and the second wavelength may be in a range from about 437 nm to about 477 nm (blue light).

As another example, the first wavelength may be in a range from about 250 nm to about 260 nm, and the second wavelength may be in a range from about 400 nm to about 750 nm. For example, the first wavelength may be about 255 nm, and the second wavelength may be about 580 nm (yellow light).

In an embodiment, the first wavelength may be in a range from about 600 nm to about 900 nm, and the second wavelength may be in a range from about 1000 nm to about 1020 nm. For example, the first wavelength may be about 700 nm, and the second wavelength may be about 1012 nm. In this case, the sensor unit 150 may include a Near-Infrared (NIR) sensor.

As described above, by using different types of light (or light with relatively great wavelength variations) as the light of the first wavelength and the second wavelength, the sensor unit 150 may have improved identification accuracy of the cigarette 5.

For example, based on a sensing value of about 1012 nm that is received through the light-receiving portion, the controller 110 may determine that the cigarette 5 inserted into the aerosol generating device 1 is of the first type. As another example, based on the sensing value of about 1012 nm that is received through the light-receiving portion, the controller 110 may determine that the cigarette 5 inserted into the aerosol generating device 1 is a genuine article that has not been counterfeited.

When the cigarette 5 is determined to be an aerosol generating article of the first type, the controller 110 may control the power supply to the heater 140 based on a temperature profile corresponding to the aerosol generating article of the first type. As another example, when the cigarette 5 is determined to be a counterfeit article, the controller 110 may stop supplying power to the heater 140 or interrupt the power currently supplied.

When the type of cigarette 5 is detected based on the sensing value sensed through the light-receiving portion, the battery 120 may supply power to the heater 140 according to the temperature profile corresponding to the cigarette 5 of the detected type. As another example, when the cigarette 5 is determined to be counterfeit based on the sensing value sensed through the light-receiving portion, the battery 120 may not supply power to the heater 140.

The emission portion and the light-receiving portion may be arranged adjacent to the cavity 100a. For example, the emission portion and the light-receiving portion may be spaced apart by a certain distance in the z-axis direction along the extension direction of the cavity 100a. As another example, the emission portion and the light-receiving portion may be spaced apart by a certain distance in the x-axis direction crossing the extension direction of the cavity 100a and arranged to surround at least a portion of the cavity 100a. In this case, the expression ‘at least a portion of the cavity’ may refer to a region corresponding to a region of the cigarette 5 where the identification portion ID is arranged when the cigarette 5 is accommodated in the cavity 100a.

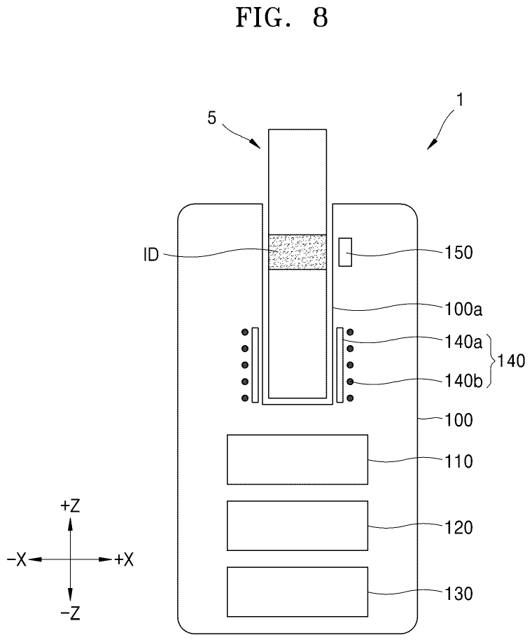

FIG. 8 is a schematic side view of an aerosol generating system using a heating method different from that of the aerosol generating system of FIG. 7.

Referring to FIG. 8, an aerosol generating device 1 may include the aerosol generating device main body 100, the controller 110, the battery 120, the memory 130, the heater 140, and the sensor unit 150. At least one of the components of the aerosol generating system of FIG. 8 (e.g., the sensor unit 150) is the same as or similar to at least one of the components of the aerosol generating system of FIG. 7, and thus, repeated descriptions thereof are omitted. In addition, it is obvious that some components and configurations may be replaced, added, or omitted within a range that one of ordinary skill in the art may easily understand by referring to the drawings and descriptions below.

The aerosol generating device 1 may generate an aerosol by heating the cigarette 5 accommodated in the cavity 100a according to an induction heating method. The induction heating method may indicate a method in which a magnetic substance is heated by applying an alternating magnetic field, of which a direction periodically changes, wherein the magnetic substance is heated by an external magnetic field.

When the alternating magnetic field is applied to the magnetic substance, energy may be lost in the magnetic substance because of eddy current loss and hysteresis loss, and the lost energy may be emitted from the magnetic substance as heat energy. The greater an amplitude or a frequency of an alternating magnetic field applied to a magnetic substance is, the more heat energy may be emitted from the magnetic substance. The heat energy may be emitted from the magnetic substance as the aerosol generating device 1 applies the alternating magnetic field to the magnetic substance, and the heat energy emitted from the magnetic substance may be transferred to the cigarette 5.

To this end, the heater 140 may include a susceptor 140a and a coil 140b.

The susceptor 140a may be a magnetic substance heated by the magnetic field. The susceptor 140a may be arranged inside the aerosol generating device main body 100 and surround the cigarette 5 accommodated in the cavity 100a. In this case, the susceptor 140a may be formed in the shape of a hollow cylinder, but the shape is not limited thereto.

In a modified embodiment, the susceptor 140a may be arranged inside the cigarette 5 accommodated in the cavity 100a. In this case, the susceptor 140a may be included in the cigarette 5 in the form of pieces, flakes, or strips.

At least a portion of the susceptor 140a may include a ferromagnetic substance. For example, the susceptor 140a may include metal or carbon. The susceptor 140a may include at least one of ferrite, ferromagnetic alloy, stainless steel, and aluminum (Al). Also, the susceptor 140a may include at least one of ceramic, such as graphite, molybdenum (Mo), silicon carbide, niobium (Nb), nickel (Ni) alloy, a metal film, or zirconia, transition metal, such as Ni or cobalt (Co), and metalloid, such as boron (B) or phosphorus (P).

The coil 140b may apply an alternating magnetic field to the susceptor 140a and heat the susceptor 140a. The coil 140b may be arranged to surround the outer side of the susceptor 140a. The battery 120 may include a battery unit for supplying a direct current to the coil 140b and a converter for converting the direct current supplied from the battery unit into an alternating current supplied to the coil 140b.

The sensor unit 150 may identify the identification portion ID of the cigarette 5 accommodated in the cavity 100a, and the controller 110 may control power supply to the coil 140b based on the information of the cigarette 5.

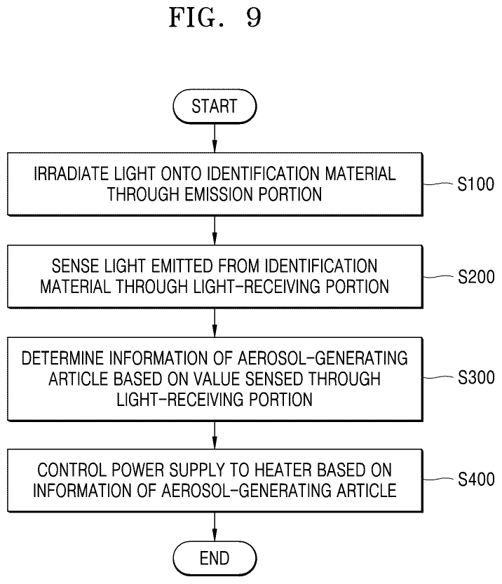

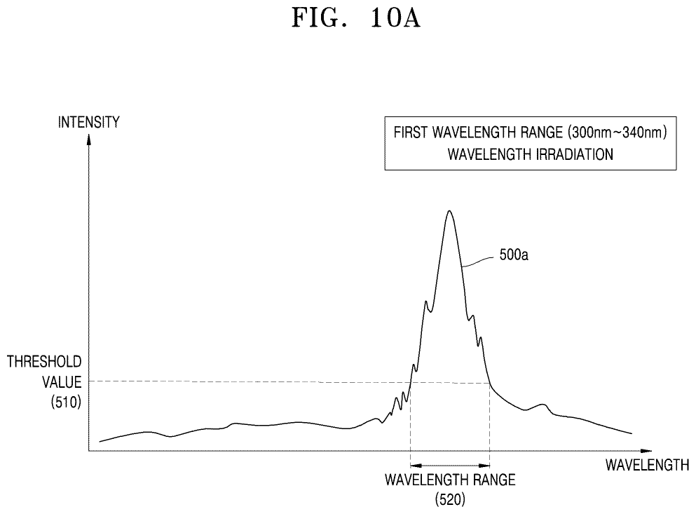

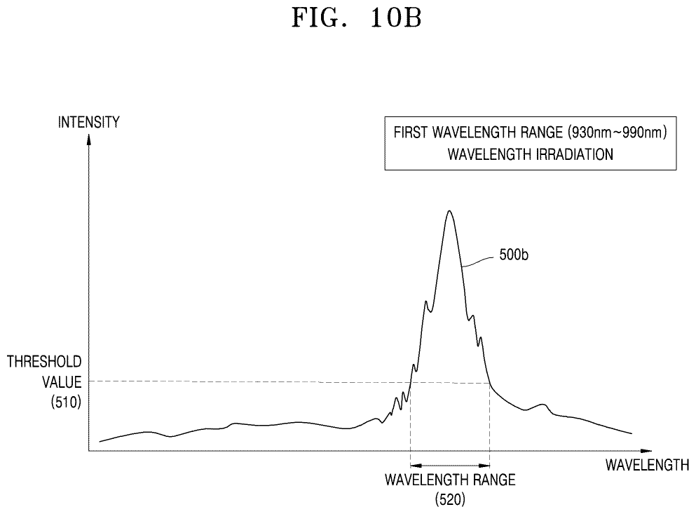

FIG. 9 is a flowchart of a process of an aerosol generating system for determining information about an aerosol generating article and controlling power supply to a heater, according to an embodiment. In the description of FIG. 9, because at least one of the components of the aerosol generating system is the same as or similar to that described above, repeated descriptions thereof may be omitted.

Referring to FIG. 9, an operating method of the aerosol generating system according to an embodiment may include four operations.

First of all, in operation S100, the controller of the aerosol generating device may irradiate light onto the identification material through the emission portion.

In an embodiment, when the insertion of the aerosol generating article is detected, the controller may irradiate light having a certain wavelength through the emission portion. For example, the aerosol generating device may include an insertion detection sensor, such as an inductive sensor, a capacitance sensor, or a pressure sensor, and when the insertion of the aerosol generating article is detected using the insertion detection sensor, the controller may irradiate light having a certain wavelength through the emission portion.

In another embodiment, when a user input regarding the aerosol generating device is received, the controller may irradiate light having a certain wavelength through the emission portion. For example, the aerosol generating device may include a physical button that allows the user to select the state of the aerosol generating device (e.g., turning on or off the device), and when a user input on the physical button is received, the controller may irradiate light having a certain wavelength through the emission portion.

In an embodiment, the wavelength of light irradiated through the emission portion may correspond to a first wavelength range. In this case, the first wavelength range may refer to the wavelength range of light allowing the excitation of the identification material and thus may be set in advance to correspond to the identification material. For example, to identify the aerosol generating article including the identification material that is excited at the wavelength of about 365 nm, the first wavelength range may be set in advance in a range from about 340 nm to about 375 nm.

In an embodiment, the first wavelength range allowing the excitation of the identification material may include at least one of the wavelength ranges from about 250 nm to about 260 nm, from about 300 nm to about 340 nm, from about 350 nm to about 390 nm, from about 600 nm to about 900 nm, and from about 930 nm to about 990 nm.

For example, when the first wavelength range is from about 300 nm to about 340 nm, the controller may irradiate ultraviolet light of about 320 nm onto the identification material of the aerosol generating article through the emission portion.

As another example, when the first wavelength range is from about 340 nm to about 375 nm, the controller may irradiate ultraviolet light of about 365 nm onto the identification material of the aerosol generating material through the emission portion.

As another example, when the first wavelength range is from about 930 nm to about 990 nm, the controller may irradiate ultraviolet light of about 980 nm onto the identification material of the aerosol generating material through the emission portion.

Next, in operation S200, the controller may sense the light emitted from the identification material through the light-receiving portion.

In an embodiment, the wavelength of light sensed through the light-receiving portion may correspond to the second wavelength range. In this case, the second wavelength range may refer to the wavelength range of light emitted from the identification material that is excited according to the irradiation of light in the first wavelength range. For example, the identification material may emit light in a range from about 1000 nm to about 1020 nm when excited at a wavelength of about 320 nm, and the controller may determine, as the second wavelength range emitted from the identification material, the wavelength range of about 1000 nm to about 1020 nm that is obtained through the light-receiving portion.

In an embodiment, the controller may receive an ADC value from the light-receiving portion and sense the light emitted from the identification material. In this case, as the light from the identification material is received, the light-receiving portion may obtain an analog signal, and the term “ADC value” may refer to a digital value converted from the analog signal, the digital value allowing the controller to identify the signal obtained by the light-receiving portion. For example, based on the ADC value received from the light-receiving portion, the controller may determine the wavelength range of light emitted from the identification material.

Next, in operation S300, the controller may determine information of the aerosol generating article, based on the sensing value sensed through the light-receiving portion. In this case, the information of the aerosol generating article may include the type of aerosol generating article and whether the aerosol generating article is counterfeit.

In an embodiment, the controller may determine the information of the aerosol generating article based on sensing values that are sensed differently depending on the type of the identification material.

For example, the identification material may include a first identification material emitting light of about 1012 nm and a second identification material emitting light of about 700 nm.

In this case, when the sensing value sensed through the light-receiving portion corresponds to a wavelength value (about 1012 nm) of light emitted from the first identification material, the controller may determine that the aerosol generating article is of the first type including the first identification material.

Alternatively, when the sensing value sensed through the light-receiving portion corresponds to a wavelength value (about 700 nm) of light emitted from the second identification material, the controller may determine that the aerosol generating article is of the second type including the second identification material.

The difference between the wavelength emitted from the first identification material and the wavelength emitted from the second identification material may be at least about 15 nm. When the wavelength emitted from the first identification material and the wavelength emitted from the second identification material are less than about 15 nm, the accuracy of the controller in distinguishing the types of identification materials may degrade. Here, the wavelength emitted from the first identification material and the wavelength emitted from the second identification material may each be the DWL. For example, the difference between the wavelength emitted from the first identification material and the wavelength emitted from the second identification material may be at least about 30 nm, about 50 nm, or about 100 nm.

In an embodiment, the controller may determine the information of the aerosol generating article, based on the sensing values sensed based on different concentrations of the identification materials.

For example, the identification material may include materials of the same type and may contain an identification material having a first concentration (e.g., about 20%) and an identification material having a second concentration (e.g., about 30%).

In this case, the sensing value sensed through the light-receiving portion is greater than a first threshold value, the controller may determine that the aerosol generating article is of the first type that includes the identification material at the first concentration.

Alternatively, when the sensing value sensed through the light-receiving portion is greater than a second threshold value that is greater than the first threshold value, the controller may determine that the aerosol generating article is of the second type that includes the identification material at the second concentration.

Next, in operation S400, the controller 110 may control power supply to the heater, based on the information of the aerosol generating article.

In an embodiment, the controller may control power supply to the heater based on the type of aerosol generating article. For example, when the aerosol generating article is determined to be of the first type, the controller may control power supply to the heater based on a first temperature profile that is set in advance for the aerosol generating article of the first type. As another example, when the aerosol generating article is determined to be of the second type, the controller may control power supply to the heater based on a second temperature profile that is set in advance for the aerosol generating article of the second type. In this case, the first temperature profile may differ from the second temperature profile.

In an embodiment, the controller may control power supply to the heater based on whether the aerosol generating article is counterfeit. For example, when the aerosol generating article is determined to be genuine, the controller may control power supply to the heater based on the temperature profile that is preset for the cigarette 5. As another example, when the aerosol generating article is determined to be counterfeit, the controller may not supply power to the heater or interrupt the power currently supplied.

FIG. 10A is an example of a graph showing a wavelength emitted from a first identification material as a wavelength in a first wavelength range is irradiated. FIG. 10B is an example of a graph showing a wavelength emitted from a second identification material as a wavelength in a second wavelength range is irradiated.

Referring to FIG. 10A, the first identification material included in the aerosol generating article may emit light in a specific wavelength range due to the light in the first wavelength range that is irradiated from the emission portion. In this case, the first wavelength range may be from about 300 nm to about 340 nm.

In an embodiment, in a first graph 500a showing the wavelength emitted from the first identification material, the controller of the aerosol generating device may determine, as the second wavelength range, a wavelength range 520 that is greater than a threshold value 510. For example, the controller may receive a sensing value corresponding to the wavelength range 520 through the light-receiving portion, and the wavelength range 520 that is the second wavelength range may be from about 1000 nm to about 1020 nm.

Referring to FIG. 101B, the second identification material included in the aerosol generating article may emit light in a specific wavelength range due to the light in the first wavelength range that is irradiated from the emission portion. In this case, the first wavelength range may be from about 930 nm to about 990 nm.

In an embodiment, in a second graph 500b showing the wavelength emitted from the second identification material, the controller 110 (See FIG. 7) of the aerosol generating device may determine, as the second wavelength range, the wavelength range 520 that is greater than the threshold value 510. For example, the controller may receive a sensing value corresponding to the wavelength range 520 through the light-receiving portion, and the wavelength range 520 that is the second wavelength range may be from about 1000 nm to about 1020 nm.

The first graph 500a of FIG. 10A and the second graph 500b of FIG. 10B are provided in the same form for convenience of explanation, but one or more embodiments are not limited thereto. For example, although the wavelength ranges that are greater than the threshold value 510 are partially similar in the first graph 500a of FIG. 10A and the second graph 500b of FIG. 10B, the overall shapes of the first graph 500a and the second graph 500b may differ.

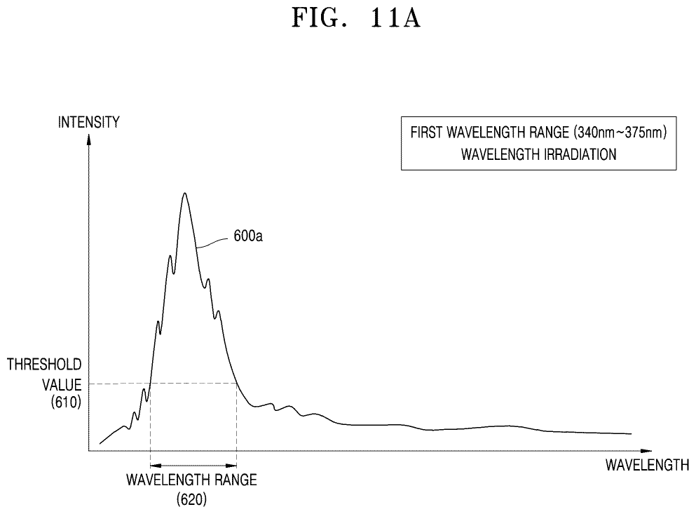

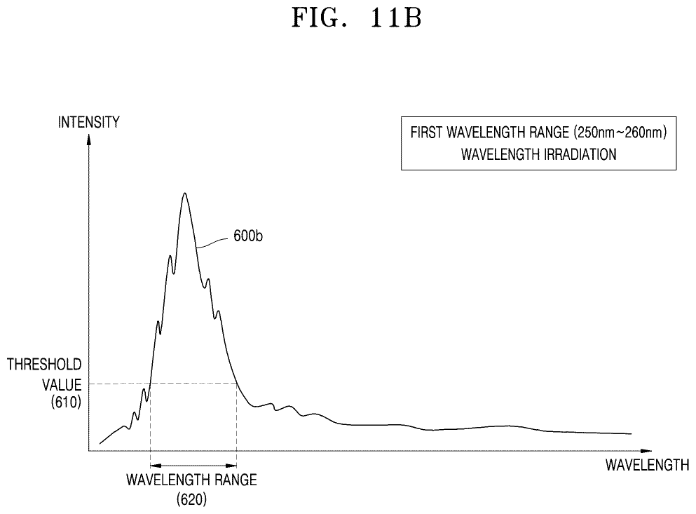

FIG. 11A is an example of a graph showing a wavelength emitted from a third identification material as a wavelength in a first wavelength range is irradiated. FIG. 11B is an example of a graph showing a wavelength emitted from the third identification material as a wavelength in a first wavelength range is irradiated.

Referring to FIG. 11A, the third identification material included in the aerosol generating article may emit light in a specific wavelength range due to the light in the first wavelength range that is irradiated from the emission portion. In this case, the first wavelength range may be from about 340 nm to about 375 nm.

In an embodiment, in a third graph 600a showing the wavelength emitted from the third identification material, the controller of the aerosol generating device may determine, as the second wavelength range, a wavelength range 620 that is greater than a threshold value 610. For example, the controller may receive a sensing value corresponding to the wavelength range 620 through the light-receiving portion, and the wavelength range 620 that is the second wavelength range may be part of the wavelength range of about 400 nm to about 750 nm.

For example, when the wavelength range 620 is from about 450 nm to about 490 nm, the controller may determine that the sensing value sensed through the light-receiving portion corresponds to ‘blue’ and determine that the aerosol generating article including the identification material expressed as ‘blue’ is of the first type.

As another example, when the wavelength range 620 is from about 490 nm to about 570 nm, the controller may determine that the sensing value sensed through the light-receiving portion corresponds to ‘green’ and determine that the aerosol generating article including the identification material expressed as ‘green’ is of the second type.

As another example, when the wavelength range 620 is from about 630 nm to about 750 nm, the controller may determine that the sensing value sensed through the light-receiving portion corresponds to ‘red’ and determine that the aerosol generating article including the identification material expressed as ‘red’ is of the third type.

Referring to FIG. 11B, the third identification material included in the aerosol generating article may emit light in a specific wavelength range due to the light in the first wavelength range that is irradiated from the emission portion. In this case, the first wavelength range may be from about 250 nm to about 260 nm. In other words, the third identification material may be excited not only in a wavelength range of about 350 nm to about 390 nm but also in a wavelength range of about 250 nm to about 260 nm.

In an embodiment, in a fourth graph 600b showing the wavelength emitted from the third identification material, the controller of the aerosol generating device may determine, as the second wavelength range, the wavelength range 620 that is greater than the threshold value 610. For example, the controller may receive a sensing value corresponding to the wavelength range 620 through the light-receiving portion, and the wavelength range 620 that is the second wavelength range may be part of the wavelength range of about 400 nm to about 750 nm.

The third graph 600a of FIG. 11A and the fourth graph 600b of FIG. 11B are provided in the same form for convenience of explanation, but one or more embodiments are not limited thereto. For example, although the wavelength ranges that are greater than the threshold value 610 are partially similar in the third graph 600a of FIG. 11A and the fourth graph 600b of FIG. 11B, the overall shapes of the third graph 600a and the fourth graph 600b may differ.

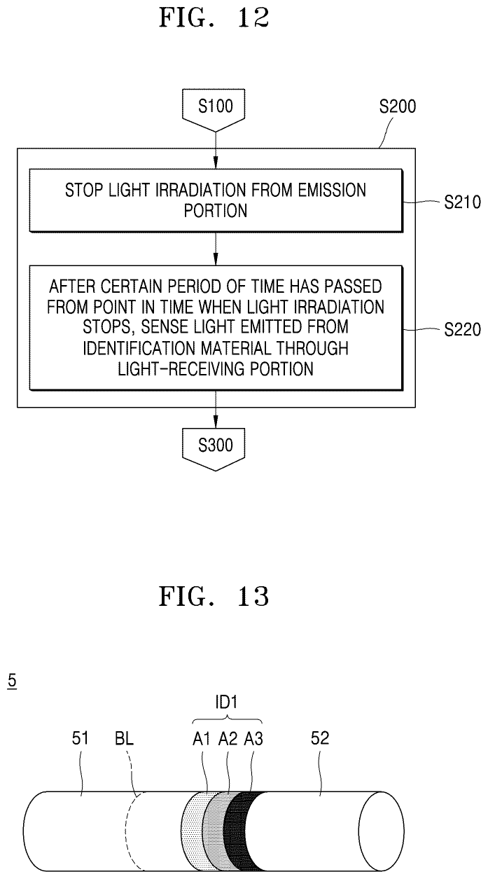

FIG. 12 is a flowchart of another example in which an aerosol generating system according to an embodiment determines information of an aerosol generating article. FIG. 12 is a flowchart that further details the operation of FIG. 9, and in the description of FIG. 12, at least one of the components of the aerosol generating system is the same as or similar to that described above, and thus, repeated descriptions may be omitted.

Referring to FIG. 12, operation S200 may include operation S210 and operation S220.

First of all, the controller of the aerosol generating device may stop irradiating light onto the identification material through the emission portion in operation S210 after the irradiation of light onto the identification material through the emission portion.

For example, when the first time has passed from the point in time when the light irradiation from the emission portion starts, the state of the identification material may change from the ground state to the excited state. In this case, the term ‘first time’ may refer to a period during which no state change occurs after the identification material is excited by absorbing light. The controller may irradiate light onto the identification material for the first time through the emission portion, and once the first time has passed, the light irradiation onto the identification material through the emission portion may stop.

Next, in operation S220, after the second time has passed from the point in time when the light irradiation onto the identification material through the emission portion stops, the controller may sense the light emitted from the identification material through the light-receiving portion. In this case, the term ‘second time’ may refer to the time taken for light irradiated from the emission portion to no longer be sensed by the light-receiving portion after the light irradiation from the emission portion stops.

In other words, the light-receiving portion needs to primarily sense the light emitted from the identification material, but as the light irradiated from the emission portion is also sensed by the light-receiving portion, the sensing values may include some noise.

However, the identification material of the disclosure may emit light for a certain period of time (that is, residual light emission) even if the light irradiated from the emission portion is blocked. Therefore, after the second time has passed from the point in time when the light irradiation from the emission portion stops, the controller may sense the light emitted from the identification material through the light-receiving portion to ensure that the light-receiving portion senses only the light emitted from the identification material.

In an embodiment, the controller may sense the light emitted from the identification material through the light-receiving portion after a period of about 200 μs to about 2000 μs has passed from the point in time when the light irradiation onto the identification material from the emission portion stops.

For example, when the identification material is a first-type material, which emits light for a relatively long period of time even after the light irradiated from the emission portion is blocked, or a material having a first concentration, the controller may sense the light emitted from the identification material through the light-receiving portion after a period of about 500 μs to about 2000 μs has passed.

As another example, when the identification material is a second-type material, which emits light for a relatively short period of time even after the light irradiated from the emission portion is blocked, or a material having a second concentration that is lower than the first concentration, the controller may sense the light emitted from the identification material through the light-receiving portion after a period of about 200 μs to about 500 μs has passed. In another embodiment, the light emission from the emission portion may occur simultaneously with the reception of the light emitted from the identification material through the light-receiving portion. Accordingly, the time required for the sensor unit to identify the identification material may be shortened.

The descriptions have been provided so far with reference to FIGS. 1 to 12 based on the embodiment in which the identification portions ID (or the identification materials 10) have a band pattern (or shape) surrounding the outer circumferential surface of the cigarette 5 and are spaced apart by a certain distance in a direction towards the filter rod 52 from the boundary BL between the tobacco rod 51 and the filter rod 52 of the cigarette 5.

However, because the identification material 10, such as a taggant, excites light at a specific first wavelength and emits light at a specific second wavelength, the sensor unit 150 may determine whether the cigarette 5 is counterfeit based on the changes in the wavelengths of the emitted light and the received light. However, because the identification of the type of cigarette 5 requires the accurate wavelength value of the received light, when external noise is introduced, there is a possibility that the type of cigarette 5 may be inaccurately identified. For example, the sensor unit 150 may fail to calculate an accurate sensing value because of the surrounding environment or the uneven surface condition of the wrapper of the cigarette 5. In particular, because the sensor unit 150 is sensitive to the distance from the sensing target (e.g., the identification portion ID), it may be difficult to process such errors using only software algorithms. Therefore, there is a need for a method of more accurately identifying the type of cigarette 5 by changing the amount, concentration, and/or composition ratio of the identification material 10 included in the identification portion ID or modifying the shape.

Hereinafter, embodiments in which the type of cigarette 5 may be accurately determined through the modification of the identification portion ID are described in more detail with reference to FIGS. 13 to 23B.

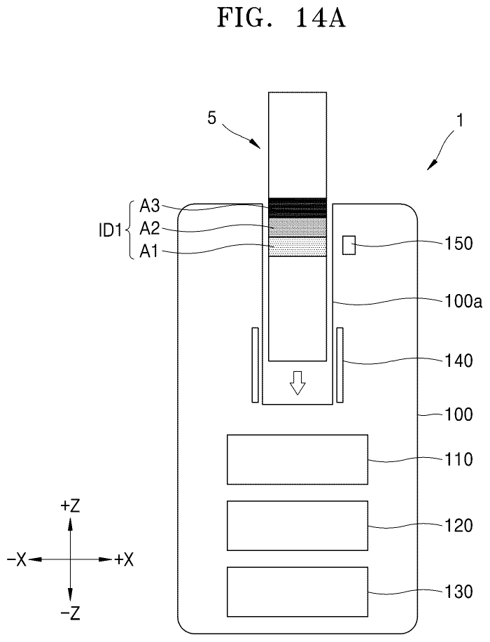

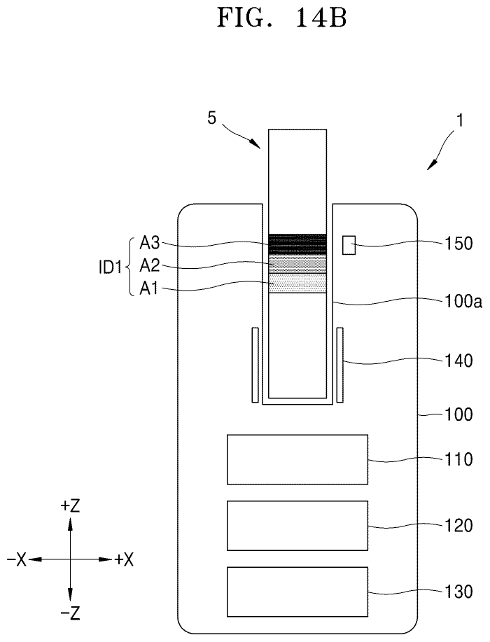

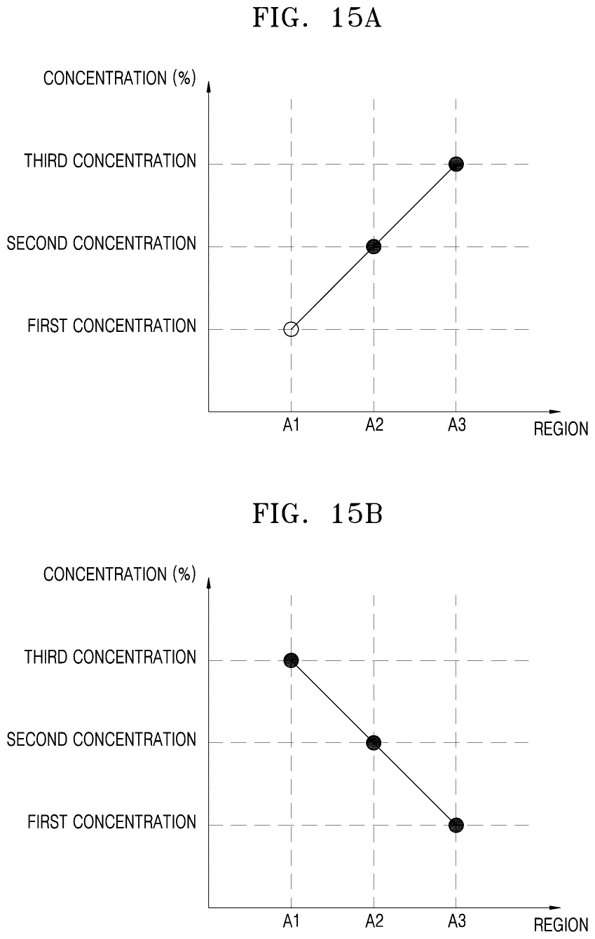

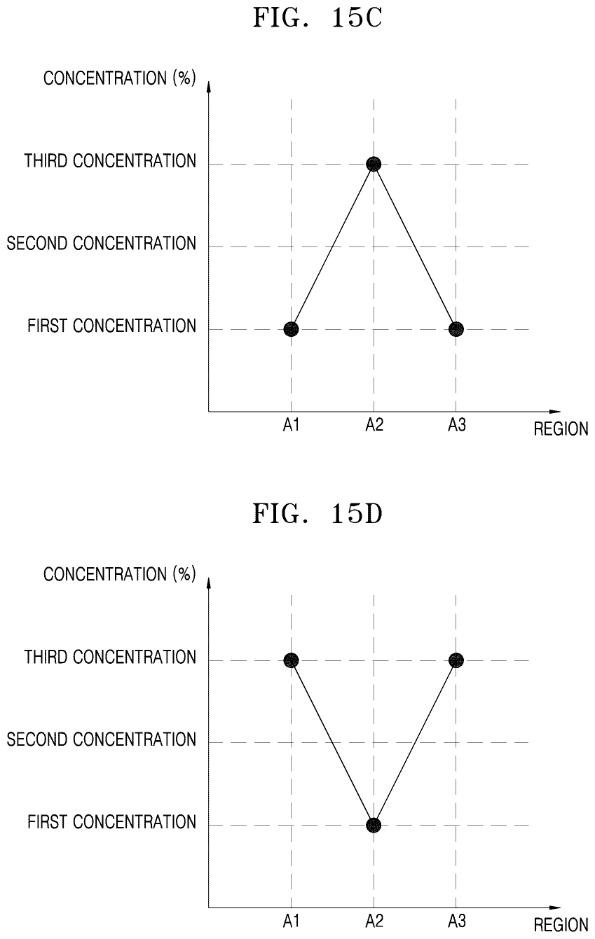

FIG. 13 illustrates a cigarette including an identification portion, according to an embodiment. FIGS. 14A and 14B illustrate a sensor unit for identifying a type of the cigarette of FIG. 13. FIGS. 15A to 15D are graphs showing sensing values for respective regions of an identification portion.

In this case, the aerosol generating device 1 shown in FIGS. 14A and 14B is substantially the same as the aerosol generating device 1 shown in FIG. 7, the differences therebetween are mainly described, and repeated descriptions are omitted.

Referring to FIG. 13, the cigarette 5 according to an embodiment may include the tobacco rod 51 and the filter rod 52 and an identification portion ID1 formed in a region extending towards the filter rod 52 from the boundary BL between the tobacco rod 51 and the filter rod 52.

The identification portion ID1 according to an embodiment may include a plurality of regions(ex: A1 to A3) including identification materials with different concentrations.

For example, the identification portion ID1 may include a first region A1, a second region A2, and a third region A3 each having a band shape surrounding the outer circumferential surface of the cigarette 5, and the first region A1, the second region A2, and the third region A3 may be arranged adjacent to each other in sequence in the direction towards the filter rod 52 from the boundary BL.

The identification material includes materials of the same type, but the materials may be an identification material with a first concentration (e.g., about 7%), an identification material with a second concentration (e.g., about 20%), and an identification material with a third concentration (e.g., about 30%). The identification material with the first concentration may be arranged in the first region A1, the identification material with the second concentration may be arranged in the second region A2, and the identification material with the third concentration may be arranged in the third region A3.

Referring to FIGS. 14A and 14B, the aerosol generating device 1 may include a main body 100 including a cavity 100a into which the cigarette 5 is inserted, a sensor unit 150 that is arranged around the cavity 100a and senses the identification portion ID1, and the controller 110 that identifies the type of cigarette 5 based on a sensing value detected by the sensor unit 150.

For example, when the cigarette 5 is completely inserted into the cavity 100a, the sensor unit 150 may be at the position corresponding to the third region A3 of the cigarette 5. Therefore, while the cigarette 5 is inserted into the cavity 100a, the sensor unit 150 may sequentially detect the first region A1, the second region A2, and the third region A3 of the cigarette 5.

In this case, when the sensing value sensed through the light-receiving portion falls within a first threshold range (e.g., a range of about 6% to about 8%), the sensor unit 150 may determine that the identification material has a first concentration (e.g., about 7%), and when the sensing value sensed through the light-receiving portion falls within a second threshold range (e.g., a range of about 19% to about 21%), the sensor unit 150 may determine that the identification material has a second concentration (e.g., about 20%). Likewise, when the sensing value sensed through the light-receiving portion falls within a third threshold range (e.g., a range of about 29% to about 31%), the sensor unit 150 may determine that the identification material has a third concentration (e.g., about 30%).

FIGS. 15A to 15D are example graphs for explaining concentration patterns of a plurality of regions. Therefore, the number of possible concentration patterns is not limited thereto. For example, when the concentration difference between adjacent regions is distinguished as a one-step difference (e.g., a change from the first concentration to the second concentration) or a two-step difference (e.g., a change from the first concentration to the third concentration), a greater number of possible patterns may be generated. In addition, even when the number of regions included in the identification portion ID1 increases, the number of possible concentration patterns may increase.

Referring to FIG. 15A, the first region A1 may have a first concentration, the second region A2 may have a second concentration, and the third region A3 may have a third concentration. In this case, the concentration intensity of the identification material is great in the order of the third concentration (e.g., about 30%), the second concentration (e.g., about 20%), and the first concentration (e.g., about 7%), and thus, in the embodiment shown in FIG. 15A, the sensor unit 150 may determine that the identification portion ID1 has a first concentration pattern in which the sensing value shows an upward trend from the first region A1 to the third region A3.

In addition, referring to FIG. 15B, the first region A1 may have a third concentration, the second region A2 may have a second concentration, and the third region A3 may have a first concentration. In this case, the concentration intensity of the identification material is great in the order of the third concentration (e.g., about 30%), the second concentration (e.g., about 20%), and the first concentration (e.g., about 7%), and thus, in the embodiment shown in FIG. 15B, the sensor unit 150 may determine that the identification portion ID1 has a second concentration pattern in which the sensing value shows a downward trend from the first region A1 to the third region A3.

In addition, referring to FIG. 15C, the first region A1 may have a first concentration, the second region A2 may have a third concentration, and the third region A3 may have a first concentration. In this case, because the third concentration (e.g., about 30%) is higher than the first concentration (e.g., about 7%) in terms of concentration intensity of the identification material, the sensor unit 150 may determine that the identification portion ID1 has a third concentration pattern in the shape of an upward chevron with the maximum value in the second region A2, in the embodiment shown in FIG. 15C.

In addition, referring to FIG. 15D, the first region A1 may have a third concentration, the second region A2 may have a first concentration, and the third region A3 may have a third concentration. In this case, because the third concentration (e.g., about 30%) is higher than the first concentration (e.g., about 7%) in terms of the concentration intensity of the identification material, the sensor unit 150 may determine that the identification portion ID1 has a fourth concentration pattern in a V shape with the minimum value in the second region A2, in the embodiment shown in FIG. 15D.

The aerosol generating device 1 may further include a memory 130 including a plurality of concentration intensity change patterns that vary according to the types of the cigarette 5. For example, the memory 130 may include a lookup table in which the concentration intensity change patterns are respectively mapped to the types of the cigarette 5.

The controller 110 may compare the concentration intensity change patterns stored in advance in the memory 130 with respective concentration intensity change patterns (e.g., a first concentration pattern to a fourth concentration pattern) of the first region A1 to the third region A3 that are determined by the sensor unit 150, thus determining the type of the cigarette 5 inserted into the cavity 100a.

For example, the controller 110 may determine that the cigarette 5 is a first-type aerosol generating article when the sensing value of the identification portion ID1 is determined by the sensor unit 150 as the first concentration pattern, determine that the cigarette 5 is a second-type aerosol generating article when the sensing value of the identification portion ID1 is determined by the sensor unit 150 as the second concentration pattern, determine that the cigarette 5 is a third-type aerosol generating article when the sensing value of the identification portion ID1 is determined by the sensor unit 150 as the third concentration pattern, and determine that the cigarette 5 is a fourth-type aerosol generating article when the sensing value of the identification portion ID1 is determined by the sensor unit 150 as the fourth concentration pattern.

As described, when the aerosol generating device 1 detects a concentration pattern based on concentration differences between the identification materials included in the identification portion ID1 and identifies the type of cigarette 5 based on the detected concentration pattern, a preventive effect against malfunctions caused by sensing errors due to the distance between the sensor unit 150 and the identification portion ID1 and the uneven surface of the wrapper of the cigarette 5 may be expected.

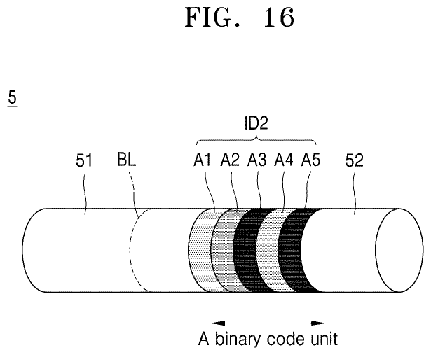

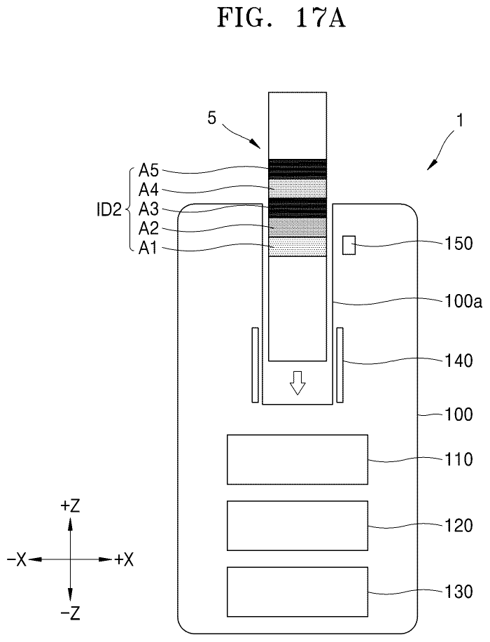

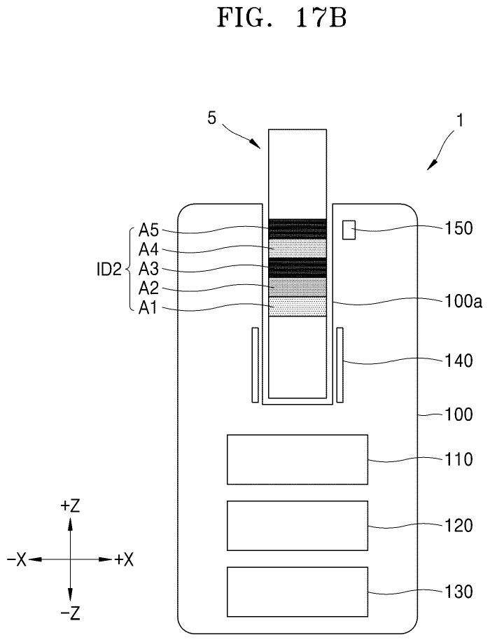

FIG. 16 illustrates a cigarette including an identification portion, according to an embodiment. FIGS. 17A and 17B illustrate a sensor unit for identifying a type of the cigarette of FIG. 16.

In this case, the aerosol generating device 1 shown in FIGS. 17A and 17B is substantially the same as the aerosol generating device 1 shown in FIG. 7, the differences therebetween are mainly described, and repeated descriptions are omitted.

Referring to FIG. 16, the cigarette 5 according to an embodiment may include the tobacco rod 51 and the filter rod 52 and an identification portion ID2 formed in a region extending in a direction towards the filter rod 52 from the boundary BL between the tobacco rod 51 and the filter rod 52.

The identification portion ID2 according to an embodiment may include a plurality of regions(ex: A1 to A5) including identification materials with different concentrations.

For example, the identification portion ID2 may include a first region A1, a second region A2, a third region A3, a fourth region A4, and a fifth region A5 each having a band shape surrounding the outer circumferential surface of the cigarette 5, and the first region A1, the second region A2, the third region A3, the fourth region A4, and the fifth region A5 may be arranged adjacent to each other in sequence in the direction towards the filter rod 52 from the boundary BL. FIG. 16 illustrates that the number of regions is five. However, this is merely an example, and the number is not limited thereto. Therefore, the number of regions may increase or decrease by considering the length of the cigarette 5 and the number of types of the cigarette 5 to be identified.

The identification material may include materials of the same type, and the concentration of the identification material formed in each of the regions A1 to A5 may be any one of a first concentration between a first threshold value and a second threshold value and a second concentration between a third threshold value and a fourth threshold value. In this case, to clearly distinguish the first concentration from the second concentration, the difference between the second threshold value and the third threshold value may be greater than the difference between the first threshold value and the second threshold value and the difference between the third threshold value and the fourth threshold value. For example, the first threshold value may be about 5%, and the second threshold value may be about 15%. In addition, the third threshold value may be about 30%, and the fourth threshold value may be about 40%.

When the identification portion ID2 is formed, although adjacent regions among the regions A1 to A5 are determined to have the same concentration (e.g., the first concentration), the actual concentration values of the adjacent regions may be different to distinguish the regions. For example, although the first region A1 to the third region A3 are determined to have the first concentration, the actual concentration value of the first region A1 may be about 7%, the actual concentration value of the second region A2 may be about 10%, and the actual concentration value of the third region A3 may be about 13%.

Referring to FIGS. 17A and 17B, the aerosol generating device 1 may include the main body 100 including the cavity 100a into which the cigarette 5 is inserted, the sensor unit 150 that is arranged around the cavity 100a and detects the identification portion ID2, and the controller 110 that identifies the type of cigarette 5 based on a sensing value detected by the sensor unit 150.

For example, when the cigarette 5 is completely inserted into the cavity 100a, the sensor unit 150 may be at the position corresponding to the fifth region A5 of the cigarette 5. Therefore, while the cigarette 5 is inserted into the cavity 100a, the sensor unit 150 may sequentially detect the first region A1 to the fifth region A5 of the cigarette 5.

When determining that a portion of the identification portion ID2 has a first concentration, the controller 110 according to an embodiment may map the first concentration to ‘0,’ and when determining that a portion of the identification portion ID2 has a second concentration, the controller 110 according to an embodiment may map the second concentration to ‘1’ so that an array of sensing values of the first region A1 to the fifth region A5 may be converted into binary code. That is, the identification portion ID2 may function as a binary code unit.

For example, when the actual concentration values are about 7% for the first region A1, about 10% for the second region A2, about 33% for the third region A3, about 7% for the fourth region A4, and about 33% for the fifth region A5, the controller 110 may convert the sensing results of the identification portion ID2 into binary code having a value of 00101.

The aerosol generating device 1 may further include a memory 130 including identification codes that vary according to the types of the cigarette 5. For example, the memory 130 may include a lookup table in which the identification codes are respectively mapped to the types of the cigarette 5.

The controller 110 may compare the binary code determined based on the sensing value of the sensor unit 150 with the identification codes stored in advance in the memory 130, thereby determining the type of cigarette 5 inserted into the cavity 100a.

As described, when the aerosol generating device 1 calculates binary code based on concertation differences between the identification materials included in the identification portion ID2 and identifies the type of cigarette 5 based on the calculated binary code, a preventive effect against malfunctions caused by sensing errors due to the distance between the sensor unit 150 and the identification portion ID2 and the uneven surface of the wrapper of the cigarette 5 may be expected.

In addition, with the recent acceleration of personalization trends, customized cigarettes are manufactured in various forms to meet the preferences of users. However, the types of taggants emitting visible light when excited by ultraviolet light are limited. As described above, the taggant may be excited by ultraviolet light and emit any one of red, green, blue, and yellow visible light. There are limitations in distinguishing a variety of cigarettes using the limited types of taggants.

When an identification portion is formed using a taggant that emits visible light when excited by ultraviolet light, there are advantages, such as enabling users to intuitively identify the type of cigarette with their eyes and robustness to external noise because of sufficiently separated wavelengths of respective colors. Therefore, research is required to identify various types of cigarettes using the limited types of taggants.

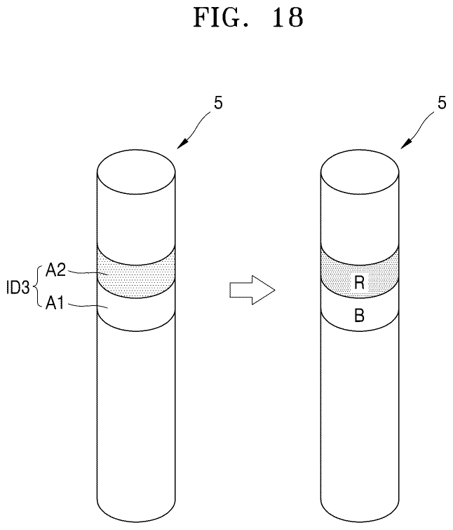

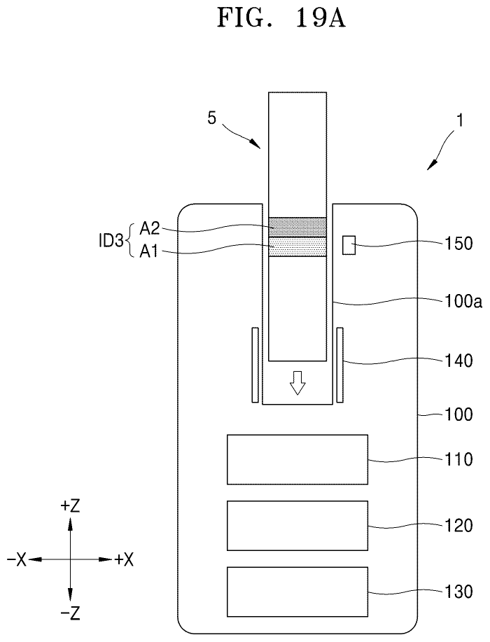

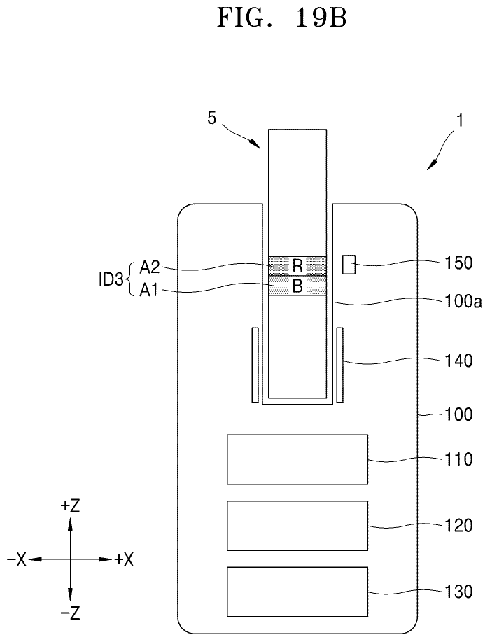

FIG. 18 illustrates a cigarette including an identification portion, according to an embodiment. FIGS. 19A and 19B illustrate a sensor unit for identifying a type of the cigarette of FIG. 18.

In this case, the aerosol generating device 1 shown in FIGS. 19A and 19B is substantially the same as the aerosol generating device 1 shown in FIG. 7, the differences therebetween are mainly described, and repeated descriptions are omitted.

Referring to FIG. 18, the cigarette 5 according to an embodiment may include the tobacco rod 51 and the filter rod 52 and an identification portion ID3 formed in a region extending towards the filter rod 52 from the boundary BL between the tobacco rod 51 and the filter rod 52.

The identification portion ID3 according to an embodiment may include a plurality of regions(ex: A1 and A2) including different types of identification materials. FIG. 18 illustrates an example in which the identification portion ID3 includes only two regions for convenience of explanation, but one or more embodiments are not limited thereto. The number of regions may increase or decrease depending on the length and types of cigarette 5 to be identified.

For example, the identification portion ID3 may include a first region A1 and a second region A2 each having a band shape surrounding the outer circumferential surface of the cigarette 5, and the first region A1 and the second region A2 may be arranged adjacent to each other in sequence in a direction towards the filter rod 52 from the boundary BL.

When the types of identification materials included in the regions A1 and A2 differ, light of a first wavelength may be excited to emit light at different second wavelengths. For example, the first region A1 and the second region A2 of the identification portion ID3 according to an embodiment may be excited by ultraviolet light emitted from the sensor unit 150 and emit any one of red, green, blue, and yellow visible light.

FIG. 18 illustrates an example in which the first region A1 emits blue visible light when excited by ultraviolet light, whereas the second region A2 emits red visible light when excited by ultraviolet light. However, one or more embodiments are not limited thereto. The first region A1 may emit any one of red, green, blue, and yellow visible light when excited by ultraviolet light, and similarly, the second region A2 may also emit any one of red, green, blue, and yellow visible light when excited by ultraviolet light. In other words, the identification portion ID3 may be divided into two regions, and when the number of colors of light emitted due to the excitation of each region by ultraviolet light is four, the identification portion ID3 may have 16 possible combinations of colors patterns.

The identification portion ID3 may include an organic material, and the organic material may include at least one organic material selected from the group consisting of quinazolinone-based compounds, thiophene-based compounds, sulfobenzoic acid-based compounds, and naphthyridine-based compounds.

Referring to FIGS. 19A and 19B, the aerosol generating device 1 may include the main body 100 including the cavity 100a into which the cigarette 5 is inserted, the sensor unit 150 that is arranged around the cavity 100a and detects the identification portion ID3, and the controller 110 that identifies the type of cigarette 5 based on a sensing value detected by the sensor unit 150.

For example, when the cigarette 5 is completely inserted into the cavity 100a, the sensor unit 150 may be at the position corresponding to the second region A2 of the cigarette 5. Therefore, the sensor unit 150 may sequentially sense the first region A1 and the second region A2 of the cigarette 5 while the cigarette 5 is inserted into the cavity 100a.

The aerosol generating device 1 may further include a memory 130 including pieces of color information that vary according to the types of cigarette 5. For example, the memory 130 may include a lookup table in which color information is mapped to each type of cigarette 5.

The controller 110 may compare the pieces of color information stored in advance in the memory 130 with the color patterns determined by the sensor unit 150, thereby determining the type of cigarette 5 inserted into the cavity 100a.

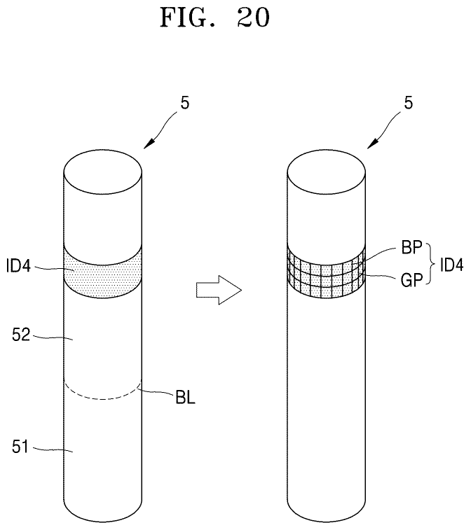

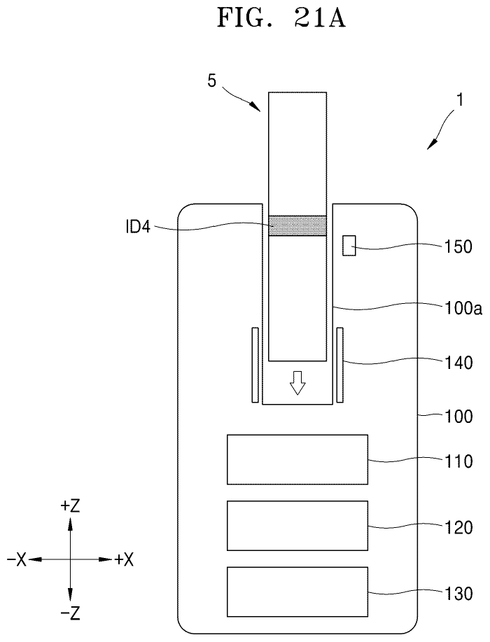

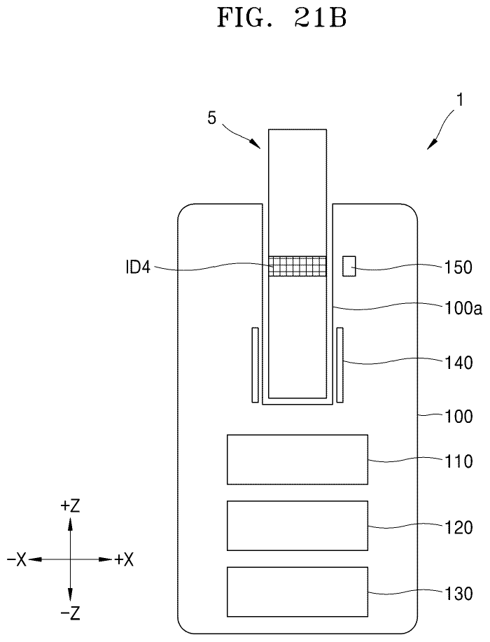

FIG. 20 illustrates a cigarette including an identification portion, according to an embodiment. FIGS. 21A and 21B illustrate a sensor unit for identifying a type of the cigarette of FIG. 20. In this case, the aerosol generating device 1 shown in FIGS. 21A and 21B is substantially the same as the aerosol generating device 1 shown in FIG. 7, the differences therebetween are mainly described, and repeated descriptions are omitted.

Referring to FIG. 20, the cigarette 5 according to an embodiment may include the tobacco rod 51 and the filter rod 52 and an identification portion ID4 formed in a region extending towards the filter rod 52 from the boundary BL between the tobacco rod 51 and the filter rod 52.

The identification portion ID4 according to an embodiment may be formed such that a band pattern BP including a first identification material overlaps a grid pattern GP including a second identification material in a thickness direction.

When the type of the first identification material included in the band pattern BP is different from the type of the second identification material included in the grid pattern GP, light at the same first wavelength may be excited to emit light at different second wavelengths. For example, the band pattern BP and the grid pattern GP of the identification portion ID4 according to an embodiment may be excited by the ultraviolet light emitted from the sensor unit 150 and may emit any one of red, green, blue, and yellow visible light.

For example, the band pattern BP may emit blue visible light when excited by ultraviolet light, whereas the grid pattern GP may emit red visible light when excited by ultraviolet light. However, one or more embodiments are not limited thereto. The band pattern BP may emit any one of red, green, blue, and yellow visible light when excited by ultraviolet light, and similarly, the grid pattern GP may also emit any one of red, green, blue, and yellow visible light when excited by ultraviolet light.

The identification portion ID4 may include an organic material, and the organic material may include at least one organic material selected from the group consisting of quinazolinone-based compounds, thiophene-based compounds, sulfobenzoic acid-based compounds, and naphthyridine-based compounds.

Referring to FIGS. 21A and 21B, the aerosol generating device 1 may include the main body 100 including the cavity 100a into which the cigarette 5 is inserted, the sensor unit 150 that is arranged around the cavity 100a and detects the identification portion ID4, and the controller 110 that identifies the type of cigarette 5 based on a sensing value detected by the sensor unit 150.

In this case, the emission portion of the sensor unit 150 may include ultraviolet light-emitting diodes, and the light-receiving portion of the sensor unit 150 may include RGB photodiodes.

For example, when the cigarette 5 is completely inserted into the cavity 100a, the sensor unit 150 may be at the position corresponding to the identification portion ID4 of the cigarette 5. Therefore, after the insertion of the cigarette 5 into the cavity 100a, the sensor unit 150 may simultaneously detect the band pattern BP and the grid pattern GP of the identification portion ID4.

The aerosol generating device 1 may further include a memory 130 including pieces of color information that vary according to the types of cigarette 5. For example, the memory 130 may include a lookup table in which color information is mapped to each type of cigarette 5.

The controller 110 may compare the color information of the identification portion ID4 determined by the sensor unit 150 with the color information stored in advance in the memory 130, thereby determining the type of cigarette 5 inserted into the cavity 100a. In this case, the color information of the identification portion ID4 may be a mixture of a color of visible light emitted from the first identification material and a color of visible light emitted from the second identification material. In the above example, the color information of the identification portion ID4 may be purple when the band pattern BP may emit blue visible light when excited by ultraviolet light, whereas the grid pattern GP may emit red visible light when excited by ultraviolet light.

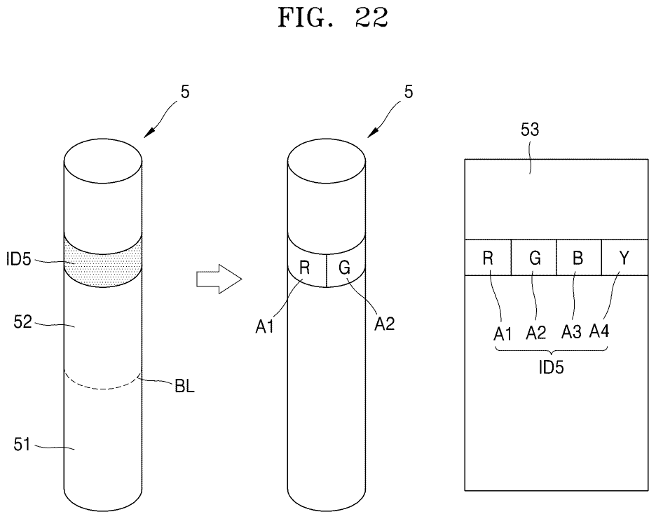

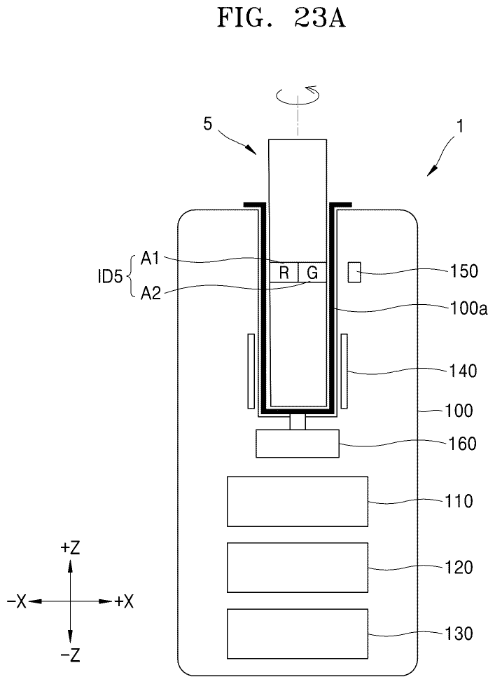

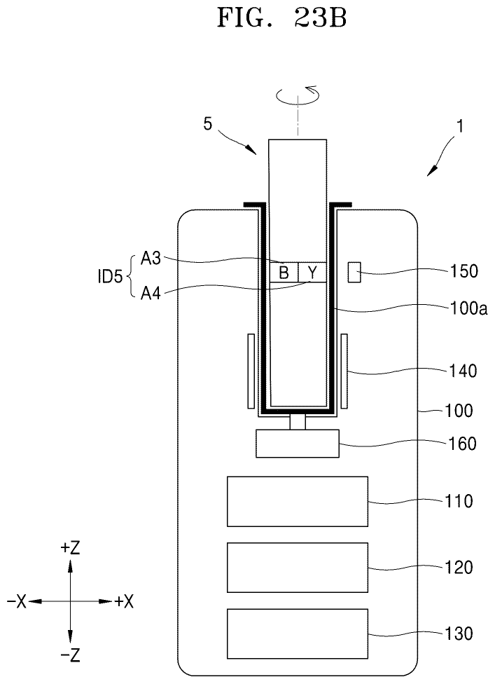

FIG. 22 illustrates a cigarette including an identification portion, according to an embodiment. FIGS. 23A and 23B illustrate a sensor unit for identifying a type of the cigarette of FIG. 22. In this case, the aerosol generating device 1 shown in FIGS. 23A and 23B differs from the aerosol generating device 1 of FIG. 7 with the fixed cavity 100a in that the cavity 100a of the aerosol generating device 1 shown in FIGS. 23A and 23B rotates around the rotation axis aligned with the central axis of the cigarette 5 (e.g., the +z direction and −z direction), and the remaining components are substantially the same. Hereinafter, the differences therebetween are mainly described, and repeated descriptions are omitted.

Referring to FIG. 22, the cigarette 5 according to an embodiment may include the tobacco rod 51 and the filter rod 52 and an identification portion ID5 formed in a region extending towards the filter rod 52 from the boundary BL between the tobacco rod 51 and the filter rod 52.

The identification portion ID5 may have a band shape generally surrounding the outer circumferential surface of the cigarette 5 and may include a plurality of regions(ex: A1 to A4) that are consecutively arranged along the circumferential direction of the cigarette 5 (e.g., the +x direction and −x direction).

When different types of identification materials are included in the regions A1 to A4, the light at the same first wavelength is excited to emit light at different second wavelengths. For example, each of the regions A1 to A4 of the identification portion ID5 according to an embodiment may be excited by ultraviolet light emitted from the sensor unit 150 and thus emit any one of red, green, blue, and yellow visible light.

For example, the first region A1 may emit red visible light when excited by ultraviolet light, the second region A2 may emit green visible light when excited by ultraviolet light, the third region A3 may emit blue visible light when excited by ultraviolet light, and the fourth region A4 may emit yellow visible light when excited by ultraviolet light.

Each of the regions A1 to A4 of the identification portion ID5 may include an organic material, and the organic material may include at least one organic material selected from the group consisting of quinazolinone-based compounds, thiophene-based compounds, sulfobenzoic acid-based compounds, and naphthyridine-based compounds.

Referring to FIGS. 23A and 23B, the aerosol generating device 1 may include the main body 100 including the cavity 100a into which the cigarette 5 is inserted, the sensor unit 150 that is arranged around the cavity 100a and detects the identification portion ID5, and the controller 110 that identifies the type of cigarette 5 based on a sensing value detected by the sensor unit 150.

The aerosol generating device 1 may further include a driving device 160 that generates driving force to rotate the cavity 100a. For example, the driving device 160 may be a motor disposed inside the main body 100 and operating in response to electrical signals. When an electrical signal is applied from the controller 110 to the motor of the driving device 160, the axis of the motor may perform rotational motion, and the driving force of the motor may cause the cavity 100a to rotate.

Embodiments in which the cavity 100a rotates are not limited to the configuration of the driving device 160 shown in FIGS. 23A and 23B, and for example, the driving device 160 may further include various power transmission elements, such as gears, belts, and sprockets.

The emission portion of the sensor unit 150 may include ultraviolet light-emitting diodes, and the light-receiving portion of the sensor unit 150 may include RGB photodiodes.

When the cigarette 5 is completely inserted into the cavity 100a, the sensor unit 150 may be located at the position corresponding to the identification portion ID5 of the cigarette 5. Therefore, after the insertion of the cigarette 5 into the cavity 100a, the sensor unit 150 may sequentially detect the regions A1 to A4 of the identification portion ID5 while the cavity 100a completes one rotation around the rotation axis in one direction. As a result, the sensor unit 150 may detect color pattern information of visible light that is emitted when the regions (e.g., the regions A1 to A4) are excited by ultraviolet light.

Although not explicitly shown in FIG. 22, the identification portion ID5 according to an embodiment may further include an additional region (not shown) between the regions (e.g., the regions A1 to A4). An identification material included in the additional region may be excited by ultraviolet light and emit light at a different wavelength (e.g., infrared light) that is outside the visible spectrum. When the cigarette 5 is inserted into the cavity 100a, because it is impossible to know which region of the identification portion ID5 (e.g., the regions A1 to A4) will first correspond to the sensor unit 150, an additional region emitting infrared light when excited by ultraviolet light may be provided, and thus, color patterns may be defined based on the region emitting infrared light as the reference point.

For example, because the cross-section of the cigarette 5 is circular, a red-green-blue-yellow pattern, a green-blue-yellow-red pattern, a blue-yellow-red-green pattern, and a yellow-red-green-blue pattern may be recognized as the same color pattern depending on which region of the identification portion ID5 is first detected by the sensor unit 150. Therefore, when color patterns are defined based on the region where infrared light is emitted, the color patterns are an infrared-red-green-blue-yellow pattern, an infrared-green-blue-yellow-red pattern, an infrared-blue-yellow-red-green pattern, and an infrared-yellow-red-green-blue pattern such that the color patterns may be distinguishable regardless of which region of the identification portion ID5 is first detected by the sensor unit 150. In other words, a greater number of color pattern types may be obtained.

The aerosol generating device 1 may further include a memory 130 including pieces of color pattern information that vary according to the types of cigarette 5. For example, the memory 130 may include a lookup table in which color pattern information is mapped to each type of cigarette 5.

The controller 110 may compare the color pattern information of the identification portion ID5 determined by the sensor unit 150 with the color pattern information stored in advance in the memory 130, thereby determining the type of cigarette 5 inserted into the cavity 100a.

Meanwhile, the aerosol generating device 1 may experience degradation in the sensing values from the sensor unit 150 due to various causes (e.g., interference from external light, crosstalk, introduction of contaminants, etc.), or the performance of the sensor unit 150 (e.g., a decrease in the emission mount of the emission portion) may be constrained due to heat generated by the heater 140 used to heat the cigarette 5. Additionally, because the aerosol generating device 1 is a small-sized electronic product, there are limitations in the space for mounting electronic components, which inevitably leads to power consumption issues due to the limited capacity of the battery 120.

To overcome the above problem, the sensor unit 150 may basically be of a sensor package type. Hereinafter, embodiments of an optical sensor package are described in more detail with reference to FIGS. 24A to 32B.

FIG. 24A illustrates an aerosol generating system according to an embodiment. FIG. 24B is a plan view of an optical sensor package according to an embodiment, and FIG. 24C is a cross-sectional view of the optical sensor package, taken along a line I-I′ of FIG. 24B. FIG. 24D illustrates a sensing operation of the optical sensor package, according to an embodiment.

Referring to FIGS. 24A to 24D, the aerosol generating system according to an embodiment may include a cigarette 5 including an identification portion ID, which emits light of a second wavelength that is different from a first wavelength as the identification portion ID is excited by light of the first wavelength, and the aerosol generating device 1.

The aerosol generating device 1 may include the main body 100 including the cavity 100a into which the cigarette 5 is inserted, an optical sensor package PKG arranged around the cavity 100a and detecting the identification portion ID, and the controller 110 that identifies whether the cigarette 5 is counterfeit and the type of cigarette 5 based on a sensing value detected by the optical sensor package PKG. The aerosol generating device 1 shown in FIG. 24A may correspond to the aerosol generating device 1 shown in FIGS. 7 and 8. Hereinafter, repeated descriptions are omitted.

The optical sensor package PKG according to an embodiment may include a package substrate SUB, an emission portion LU, a semiconductor chip SC, a light-receiving portion PU, and a molding member ENC.

In an embodiment, a first element PE1 and a second element PE2 may be formed on a first surface S1 (e.g., a surface in the +Z direction) of the package substrate SUB, and a substrate terminal TE may be formed on a second surface S2 (e.g., a surface in the −Z direction) that is opposite to the first surface S1.

In an embodiment, the first surface S1 may be a surface on which the optical sensor package PKG faces the identification portion ID of the cigarette 5. The substrate terminal TE may be electrically and/or physically connected to the aerosol generating device 1 on which the optical sensor package PKG of the disclosure is mounted.

The identification material 10 may be excited as light in a specific wavelength range is absorbed, and in this case, ‘the excitation of a material’ may refer to a transition of a material from a ground state to an excited state. Then, while the state of the identification material 10 transitions from the excited state to the ground state, light in a specific wavelength range may be emitted from an emission material.

In an embodiment, the identification material 10 may be excited by light emitted from the emission portion LU and may emit light in a wavelength range that is different from that of the irradiated light. For example, the identification material 10 may be excited by light in a first wavelength range that is irradiated from the emission portion LU and emit light in a second wavelength range that is different from the first wavelength range.

For example, the identification material 10 may be a first emission material that emits light in a second wavelength range of about 400 nm to about 750 nm when excited by light in a first wavelength range of about 350 nm to about 390 nm. Thus, the emission portion LU may irradiate ultraviolet light of about 365 nm onto the first emission material, and the light-receiving portion PU may sense visible light (that is, red light) of about 700 nm that is emitted from the first emission material.

In an embodiment, the emission portion LU may include at least one light-emitting diode that emits light L of a first wavelength when a current flows. For example, two emission portions LU shown in FIGS. 24A to 24C may both be ultraviolet light-emitting diodes. Thus, the optical sensor package PKG may provide a sufficient amount of light to detect the identification portion ID of the cigarette 5.

In an embodiment, the semiconductor chip SC may be an Application Specific Integrated Circuit (ASIC) that controls the overall operations of the optical sensor package PKG.

The semiconductor chip SC according to an embodiment may include a signal processor electrically connected to the light-receiving portion PU, and the signal processor may include an analog-to-digital converter (not shown) that converts an analog signal, which is the sensing value received from the light-receiving portion, into a digital signal.

The aerosol generating device 1 according to an embodiment may include a first flexible printed circuit board (FPCB1) that is electrically connected to a heater 140 and a second FPCB2 that is electrically connected to the optical sensor package PKG. In this case, the first FPCB1 and the second FPCB2 may be electrically insulated from and arranged adjacent to each other. Thus, when the sensing value, which is the analog signal detected by the optical sensor package PKG, is transmitted to the controller 110 through the second FPCB2 and processed therein, noise may be introduced by the second FPCB2 and the heater 140 (specifically, an induction-heating heater) arranged near the controller 110.

To reduce the above problem, the optical sensor package PKG may signal-process the detected sensing value by using the semiconductor chip SC, convert a result of signal processing into a digital signal, and then transmit the digital signal to the controller 110.

The controller 110 may determine whether the cigarette 5 is counterfeit and the type of cigarette 5, based on the digital signal generated by the signal processor.

In an embodiment, the light-receiving portion PU may include at least one light-receiving diode through which a current flows when light L′ of a second wavelength is received, wherein the light L′ is different from the light L of a first wavelength. For example, the light-receiving portion PU shown in FIGS. 24A to 24D may be an RGB detection sensor. The RGB detection sensor may include therein a first photodiode PU1 detecting red light, a second photodiode PU2 detecting green light, and a third photodiode PU3 detecting blue light. The RGB detection sensor may detect a color of light L′ of the second wavelength, based on a ratio of light amount received from each of the first photodiode PU1 to the third photodiode PU3.

In an embodiment, the optical sensor package PKG may include a first element PE1, a second element PE2, and a first conductive member W1.

In an embodiment, the first element PE1 and the second element PE2 may be formed on the first surface S1. The first element PE1 may be connected to the emission portion LU including a light-emitting diode, and the second element PE2 may be connected to the semiconductor chip SC.

In an embodiment, the first conductive member W1 may electrically connect the first element PE1 to the emission portion LU. For example, the first element PE1 may include two terminals including a negative terminal and a positive terminal. The emission portion LU may be directly coupled to any one of the two terminals. The first conductive member W1 may connect the emission portion LU to the other of the two terminals.

In addition, a solder ball SD may electrically connect the second element PE2 to the semiconductor chip SC. For example, the second element PE2 may include a plurality of terminals corresponding to pad electrodes formed on the rear surface of the semiconductor chip SC. The semiconductor chip SC may include solder balls SD arranged between the pad electrodes of the semiconductor chip SC and electrodes of the second element PE2 and may be coupled to the second element PE2 through a reflow process.

In an embodiment, the first element PE1 and the second element PE2 may be arranged adjacent to each other on the first surface S1. Accordingly, the emission portion LU and the semiconductor chip SC may be arranged adjacent to each other on the first surface S1 of the package substrate SUB.

In an embodiment, the light-receiving portion PU may be arranged on the semiconductor chip SC. For example, the light-receiving portion PU may be integrally formed during the manufacture of the semiconductor chip SC. FIG. 24A illustrates an example in which the light-receiving portion PU is arranged on the top left portion of the semiconductor chip SC and the area of the light-receiving portion PU occupies about ¼ of the semiconductor chip SC. However, this is only an example, and one or more embodiments are not limited thereto. In other words, the size and placement of the light-receiving portion PU may vary according to customer requirements.

According to an embodiment, the height H1 from the first surface S1 (or the upper surface) of the package substrate SUB to the upper surface of the semiconductor chip SC may be greater than the height H2 from the first surface S1 (or the upper surface) of the package substrate SUB to the upper surface of the emission portion LU. For example, the height H1 from the first surface S1 (or the upper surface) of the package substrate SUB to the upper surface of the semiconductor chip SC may be about 610 μm, and the height H2 from the first surface S1 (or the upper surface) of the package substrate SUB to the upper surface of the emission portion LU may be about 150 μm.

As described, when the height H1 from the first surface S1 (or the upper surface) of the package substrate SUB to the upper surface of the semiconductor chip SC is greater than the height H2 from the first surface S1 (or the upper surface) of the package substrate SUB to the upper surface of the emission portion LU, the light-receiving portion PU is arranged on the semiconductor chip SC, and thus, the light L emitted from the emission portion LU may be prevented from directly reaching the light-receiving portion PU without passing through the identification portion ID of the cigarette 5. That is, the semiconductor chip SC may function as a partition in that the semiconductor chip SC blocks the light emitted from the emission portion LU.

Accordingly, the optical sensor package PKG of the disclosure may prevent crosstalk in which the light L from the emission portion LU is directly incident to the light-receiving portion PU; thus, the sensing sensitivity of the optical sensor package PKG may be expected to improve.

In an embodiment, the molding member ENC may be arranged on the first surface S1 of the package substrate SUB. The molding member ENC may protect the first surface S1 of the package substrate SUB and other components (e.g., the emission portion LU, the semiconductor chip SC, and the light-receiving portion PU) mounted on the first surface S1. The molding member ENC may include a non-conductive material. The molding member ENC may reduce or prevent electrical disconnection or unintended short circuits of the first surface S1 of the package substrate SUB and other components mounted on the first surface S1.

In an embodiment, the molding member ENC may be formed on the first surface S1 of the package substrate SUB to surround the emission portion LU, the semiconductor chip SC, and the light-receiving portion PU.

In an embodiment, the molding member ENC may include a light-transmissive material. For example, the molding member ENC may be a clear molding compound (CMC). The molding member ENC may guide the light emitted from the emission portion LU so that the light may be transmitted to the identification portion ID of the cigarette 5 that is a sensing target of the optical sensor package PKG.

In an embodiment, the molding member ENC may be formed as a single body as the regions respectively surrounding the emission portion LU, the semiconductor chip SC, and the light-receiving portion PU are connected. The molding member ENC may be substantially uniformly applied to the first surface S1 of the package substrate SUB and thus cured. The molding member ENC formed as a single body may improve the manufacturing efficiency of the optical sensor package PKG.

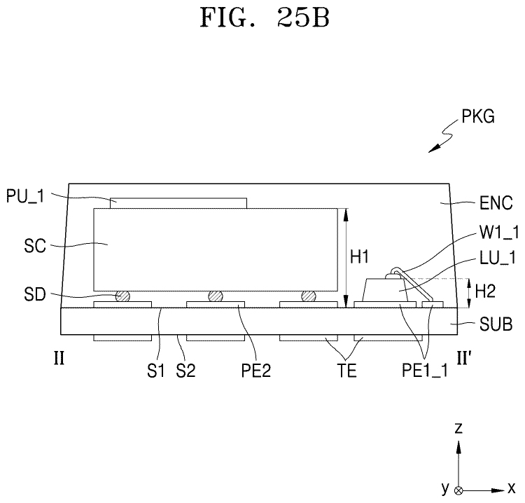

FIG. 25A is a plan view of an optical sensor package according to an embodiment, and FIG. 25B is a cross-sectional view of the optical sensor package, taken along a line II-II′ of FIG. 25A.

The optical sensor package PKG shown in FIGS. 25A and 25B differs from the optical sensor package PKG of FIGS. 24A to 24D, which only includes the ultraviolet light-emitting diodes and the RGB detection sensor, in that the optical sensor package PKG shown in FIGS. 25A and 25B further includes infrared light-emitting diodes and infrared light-receiving diodes, and the remaining components are substantially the same. Hereinafter, the differences between the components are mainly described, and repeated descriptions regarding the same components are omitted.

Referring to FIGS. 25A and 25B, the optical sensor package PKG according to an embodiment may include the package substrate SUB, emission portions LU and LU_1, the semiconductor chip SC, a light-receiving portion PU_1, and the molding member ENC.

The identification material 10 may be placed on a surface of the cigarette 5.

The identification material 10 may be excited as light in a specific wavelength range is absorbed, and in this case, ‘the excitation of a material’ may refer to a transition of a material from a ground state to an excited state. Then, while the state of the identification material 10 transitions from the excited state to the ground state, light in a specific wavelength range may be emitted from an emission material.

In an embodiment, the identification material 10 may be excited by light irradiated from the emission portion LU and may emit light in a wavelength range that is different from that of the irradiated light. For example, the identification material 10 may be excited by light in a first wavelength range that is irradiated from the emission portion LU and emit light in a second wavelength range that is different from the first wavelength range.

For example, the identification material 10 may be a first emission material that emits light in a second wavelength range of about 400 nm to about 750 nm when excited by light in a first wavelength range of about 350 nm to about 390 nm. Thus, the emission portion LU may irradiate ultraviolet light of about 365 nm onto the first emission material, and the light-receiving portion PU_1 may sense visible light (that is, red light) of about 700 nm that is emitted from the first emission material.

As another example, the identification material 10 may be a second emission material that emits light in a second wavelength range of about 1000 nm to about 1020 nm when excited by light in a first wavelength range of about 300 nm to about 340 nm. Thus, the emission portion LU may irradiate ultraviolet light of about 325 nm onto the second emission material, and the light-receiving portion PU_1 may sense infrared light of about 1012 nm that is emitted from the second emission material.

As another example, the identification material 10 may be a third emission material that emits light in a second wavelength range of about 1000 nm to about 1020 nm when excited by light in a first wavelength range of about 930 nm to about 990 nm. Thus, the emission portion LU may irradiate infrared light of about 980 nm onto the third emission material, and the light-receiving portion PU_1 may sense infrared light of about 1012 nm that is emitted from the third emission material.

The embodiment shown in FIGS. 25A and 25B may include the emission portion LU including ultraviolet light-emitting diodes and the emission portion LU_1 including infrared light-emitting diodes.

In an embodiment, the semiconductor chip SC may be an ASIC that controls the general operation of the optical sensor package PKG.

In an embodiment, the light-receiving portion PU_1 may include at least one light-receiving diode through which a current flows when light L′ of a second wavelength is received, wherein the light L′ is different from the light L of a first wavelength. For example, the light-receiving portion PU_1 shown in FIGS. 25A and 25B may be an RGB detection sensor. The RGB detection sensor may include therein a first photodiode PU1 detecting red light, a second photodiode PU2 detecting green light, and a third photodiode PU3 detecting blue light. In addition, the light-receiving portion PU_1 may further include an infrared light-receiving diode PU4 that may receive light at an infrared wavelength (that is, in a range of about 1000 nm to about 1020 nm).

Therefore, when the identification material included in the cigarette 5 is the first emission material, the light emitted from the emission portion LU including the ultraviolet light-emitting diodes may be detected by the RGB detection sensors(ex: PU1 to PU3) of the light-receiving portion PU_1, and when the identification material is the second emission material, the light may be detected by the infrared light-receiving diode PU4 of the light-receiving portion PU_1.

In addition, when the identification material included in the cigarette 5 is the third emission material, the infrared light of a first wavelength that is emitted from the emission portion LU_1 including the infrared light-emitting diodes may be excited by infrared light of a second wavelength and detected by the infrared light-receiving diode PU4 of the light-receiving portion PU_1.

Meanwhile, the infrared light of the first wavelength that is emitted from the emission portion LU_1 including the infrared light-emitting diodes may be detected intactly by the infrared light-receiving diode PU4 of the light-receiving portion PU_1.

In an embodiment, the optical sensor package PKG may include a first conductive member W1_1. In an embodiment, the first conductive member W1_1 may electrically connect a first element PE1_1 to the emission portion LU_1.

In an embodiment, the light-receiving portion PU_1 may be arranged on the semiconductor chip SC. Also, the height H1 from the first surface S1 (or the upper surface) of the package substrate SUB to the upper surface of the semiconductor chip SC may be greater than the height H2 from the first surface S1 (or the upper surface) of the package substrate SUB to the upper surface of the emission portion LU.

As described above with reference to FIGS. 24A to 24D, because the semiconductor chip SC functions as a partition also in the optical sensor package PKG of FIGS. 25A and 25B, the crosstalk may be prevented so that the sensing sensitivity of the optical sensor package PKG may be expected to improve.

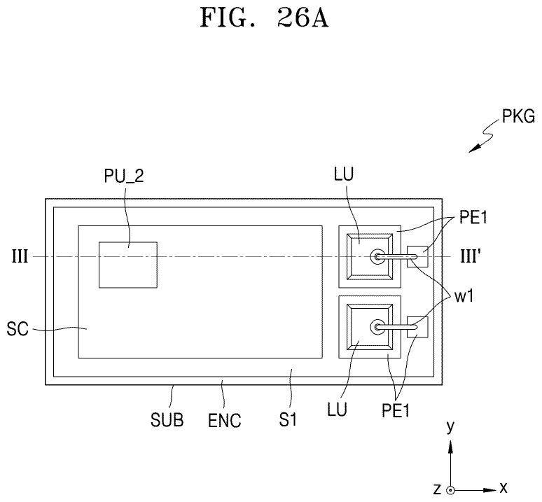

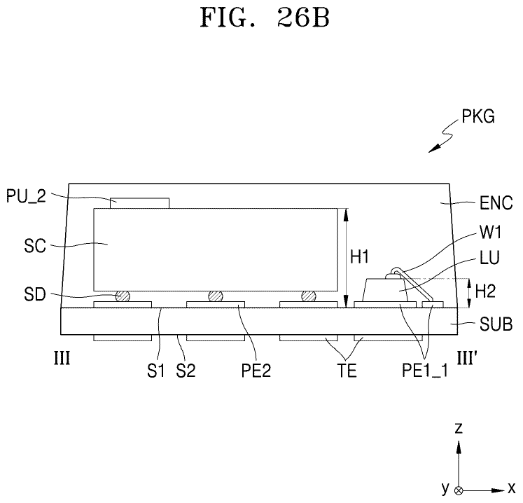

FIG. 26A is a plan view of an optical sensor package according to an embodiment, and FIG. 26B is a cross-sectional view of the optical sensor package, taken along a line III-III′ of FIG. 26A.

The optical sensor package PKG shown in FIGS. 26A and 26B differs from the optical sensor package PKG shown in FIGS. 24A to 24D in that the optical sensor package PKG shown in FIGS. 26A and 26B includes infrared photodiodes instead of the RGB detection sensor included in the optical sensor package PKG shown in FIGS. 24A to 24D, and the remaining components are substantially the same. Hereinafter, the differences between the components are mainly described, and descriptions regarding the same components are omitted.

Referring to FIGS. 26A and 26B, the optical sensor package PKG according to an embodiment may include the package substrate SUB, the emission portion LU, the semiconductor chip SC, a light-receiving portion PU_2, and the molding member ENC.

The identification material 10 may be placed on a surface of the cigarette 5.

The identification material 10 may be excited as light in a specific wavelength range is absorbed, and in this case, ‘the excitation of a material’ may refer to a transition of a material from a ground state to an excited state. Then, while the state of the identification material 10 transitions from the excited state to the ground state, light in a specific wavelength range may be emitted from an emission material.

In an embodiment, the identification material 10 may be excited by light irradiated from the emission portion LU and may emit light in a wavelength range that is different from that of the irradiated light. For example, the identification material 10 may be excited by light in a first wavelength range that is irradiated from the emission portion LU and may emit light in a second wavelength range that is different from the first wavelength range.

For example, the identification material 10 may be a second emission material that emits light in a second wavelength range of about 1000 nm to about 1020 nm when excited by light in a first wavelength range of about 300 nm to about 340 nm. Thus, the emission portion LU may irradiate ultraviolet light of about 325 nm onto the second emission material, and the light-receiving portion PU_2 may sense infrared light of about 1012 nm that is emitted from the second emission material.

Two emission portions LU shown in FIGS. 26A and 26B may both be ultraviolet light-emitting diodes.

In an embodiment, the semiconductor chip SC may be an ASIC that controls the general operation of the optical sensor package PKG.

In an embodiment, the light-receiving portion PU_2 may include at least one light-receiving diode through which a current flows when light L′ of a second wavelength is received, wherein the light L′ is different from the light L of a first wavelength. For example, the light-receiving portion PU_2 shown in FIGS. 26A and 26B may include infrared light-receiving diodes capable of receiving light at the infrared wavelength (that is, from about 1000 nm to about 1020 nm).

Therefore, when the identification material included in the cigarette 5 is the second emission material, the light emitted from the emission portion LU including ultraviolet light-emitting diodes may be detected by the infrared light-receiving diodes of the light-receiving portion PU_2.

In an embodiment, the light-receiving portion PU_2 may be arranged on the semiconductor chip SC. Also, the height H1 from the first surface S1 (or the upper surface) of the package substrate SUB to the upper surface of the semiconductor chip SC may be greater than the height H2 from the first surface S1 (or the upper surface) of the package substrate SUB to the upper surface of the emission portion LU.

As described above with reference to FIGS. 24A to 24D, because the semiconductor chip SC functions as a partition also in the optical sensor package PKG of FIGS. 26A and 26B, the crosstalk may be prevented so that the sensing sensitivity of the optical sensor package PKG may be expected to improve.

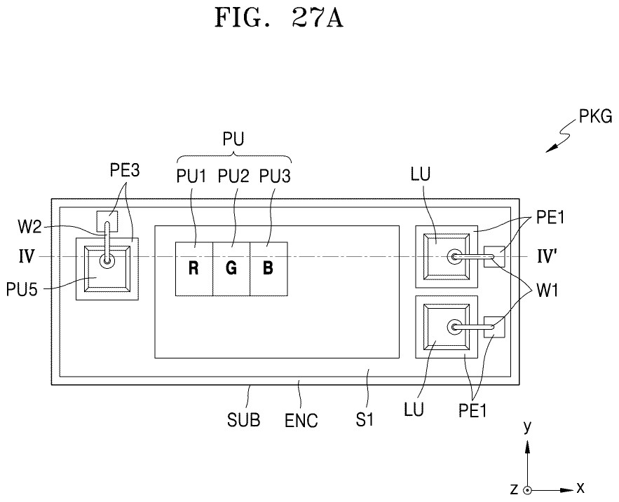

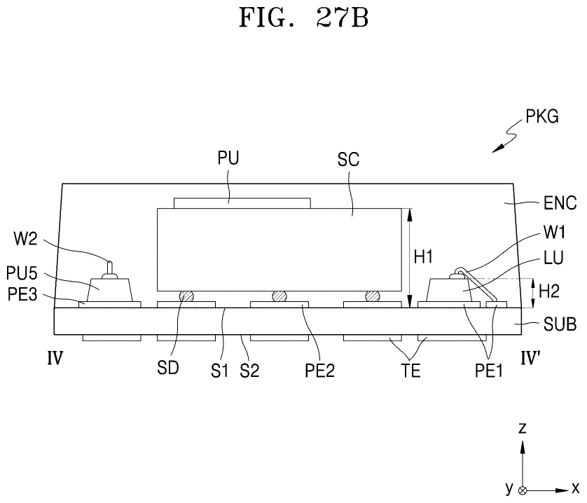

FIG. 27A is a plan view of an optical sensor package according to an embodiment, and FIG. 27B is a cross-sectional view of the optical sensor package, taken along a line IV-IV′ of FIG. 27A.

The optical sensor package PKG shown in FIGS. 27A and 27B differs from the optical sensor package PKG shown in FIGS. 24A to 24D in that the optical sensor package PKG shown in FIGS. 27A and 27B further includes an additional light-receiving portion PU5, and the remaining components are substantially the same. Hereinafter, the differences between the components are mainly described, and repeated descriptions regarding the same components are omitted.

Referring to FIGS. 27A and 27B, the optical sensor package PKG may further include the additional light-receiving portion PU5, a third element PE3, and a second conductive member W2.

In an embodiment, the third element PE3 may be formed on the first surface S1 of the package substrate SUB. The third element PE3 may be connected to the additional light-receiving portion PU5 including infrared light-receiving diodes.

For example, the third element PE3 may include two terminals including a negative terminal and a positive terminal. The additional light-receiving portion PU5 may be directly coupled to any one of the two terminals. The second conductive member W2 may connect the additional light-receiving portion PU5 to the other of the two terminals.

In an embodiment, the third element PE3 may be arranged on the first surface S1 opposite to the first element PE1 with respect to the second element PE2 and may be adjacent to the second element PE2 on the first surface S1. In addition, the additional light-receiving portion PU5 may be arranged on the first surface S1 opposite to the emission portion LU with respect to the semiconductor chip SC and may be adjacent to the semiconductor chip SC on the first surface S1.

Because the semiconductor chip SC is arranged between the additional light-receiving portion PU5 and the emission portion LU, the semiconductor chip SC may function as a partition.

The identification material 10 may be placed on a surface of the cigarette 5.

The identification material 10 may be excited by light irradiated from the emission portion LU and may emit light in a wavelength range that is different from that of the irradiated light. For example, the identification material 10 may be excited by light in a first wavelength range that is irradiated from the emission portion LU and emit light in a second wavelength range that is different from the first wavelength range.

For example, the identification material 10 may be a first emission material that emits light in a second wavelength range of about 400 nm to about 750 nm when excited by light in a first wavelength range of about 350 nm to about 390 nm. Thus, the emission portion LU may irradiate ultraviolet light of about 365 nm onto the first emission material, and the light-receiving portion PU may sense visible light (that is, red light) of about 700 nm that is emitted from the first emission material.

As another example, the identification material 10 may be a second emission material that emits light in a second wavelength range of about 1000 nm to about 1020 nm when excited by light in a first wavelength range of about 300 nm to about 340 nm. Thus, the emission portion LU may irradiate ultraviolet light of about 325 nm onto the second emission material, and the light-receiving portion PU may sense infrared light of about 1012 nm that is emitted from the second emission material.

Therefore, when the identification material included in the cigarette 5 is the first emission material, the light emitted from the emission portion LU including the ultraviolet light-emitting diodes may be detected by RGB detection sensors PU1 to PU3 of the light-receiving portion PU, and when the identification material is the second emission material, the light may be detected by the infrared light-receiving diode of the additional light-receiving portion PU5.

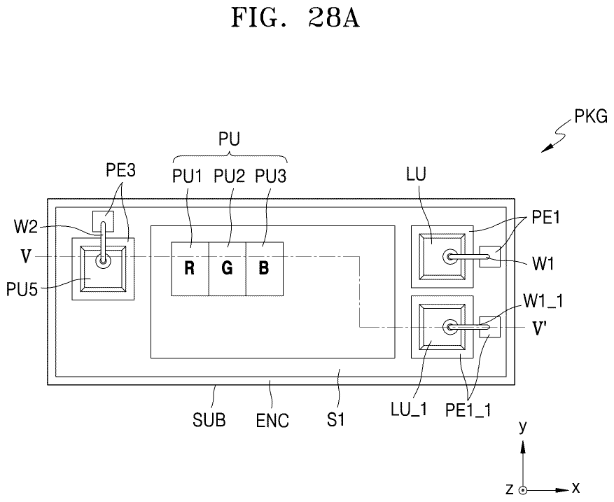

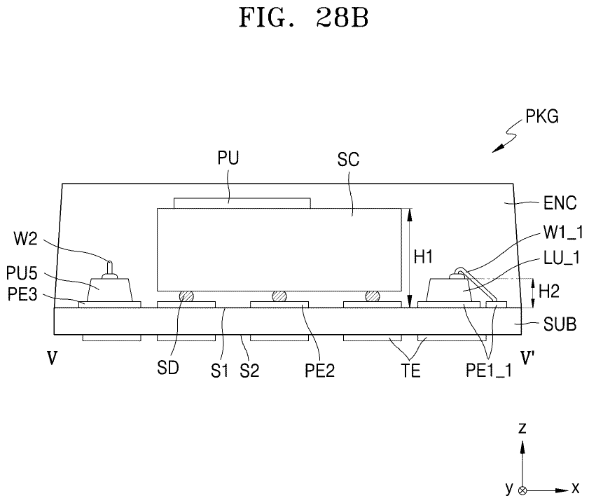

FIG. 28A is a plan view of an optical sensor package according to an embodiment, and FIG. 28B is a cross-sectional view of the optical sensor package, taken along a line V-V′ of FIG. 28A.

The optical sensor package PKG shown in FIGS. 28A and 28B differs from the optical sensor package PKG shown in FIGS. 27A and 27B, which only includes the emission portion LU including the ultraviolet light-emitting diodes, in that the optical sensor package PKG shown in FIGS. 28A and 28B includes both an emission portion LU including ultraviolet light-emitting diodes and an emission portion LU_1 including infrared light-emitting diodes, and the remaining components are substantially the same. Hereinafter, the differences between the components are mainly described, and repeated descriptions regarding the same components are omitted.

In the optical sensor package PKG, when the identification material included in the cigarette 5 is the first emission material, the light emitted from the emission portion LU including the ultraviolet light-emitting diodes may be detected by RGB detection sensors PU1 to PU3 of the light-receiving portion PU, and when the identification material is the second emission material, the light may be detected by the infrared light-receiving diode of the additional light-receiving portion PU5.

In addition, when the identification material included in the cigarette 5 is the third emission material, the infrared light of a first wavelength that is emitted from the emission portion LU_1 including the infrared light-emitting diodes may be excited by infrared light of a second wavelength and detected by the infrared light-receiving diode of the additional light-receiving portion PU5. Meanwhile, the infrared light of the first wavelength that is emitted from the emission portion LU_1 including the infrared light-emitting diodes may be detected intactly by the infrared light-receiving diode of the additional light-receiving portion PU5.

Because the semiconductor chip SC is arranged between the additional light-receiving portion PU5 and the emission portions LU and LU_1, the semiconductor chip SC may function as a partition.

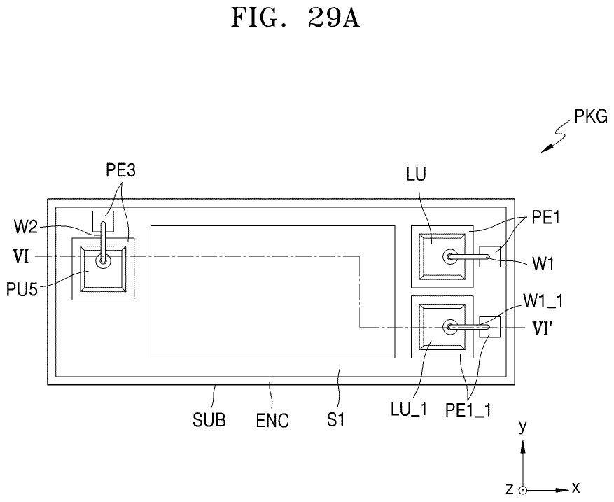

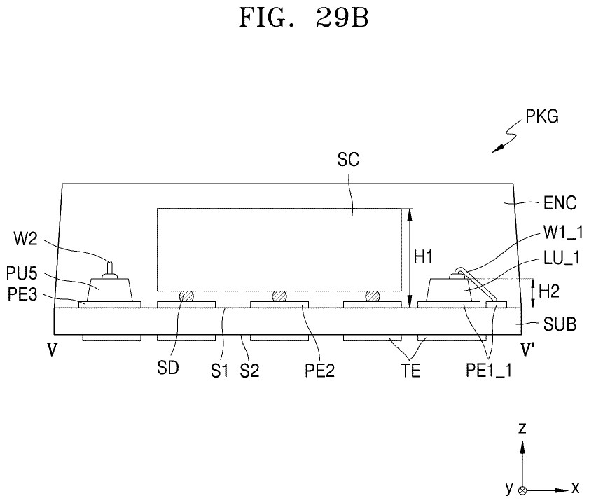

FIG. 29A is a plan view of an optical sensor package according to an embodiment, and FIG. 29B is a cross-sectional view of the optical sensor package, taken along a line VI-VI′ of FIG. 29A.

The optical sensor package PKG shown in FIGS. 29A and 29B differs from the optical sensor package PKG shown in FIGS. 28A and 28B, which includes the emission portion LU that includes both the RGB detection sensor and the additional light-receiving portion PU5 with the infrared light-receiving diodes, in that the optical sensor package PKG shown in FIGS. 29A and 29B does not include an RGB detection sensor and includes an additional light-receiving portion PU5 including infrared light-receiving diodes. The remaining components are substantially the same. Hereinafter, the differences between the components are mainly described, and repeated descriptions regarding the same components are omitted.

In the optical sensor package PKG shown in FIGS. 29A and 29B, when the identification material included in the cigarette 5 is the second emission material, the light emitted from the emission portion LU including the ultraviolet light-emitting diodes may be detected by the infrared light-receiving diode of the additional light-receiving portion PU5.

In addition, when the identification material included in the cigarette 5 is the third emission material, the infrared light of a first wavelength that is emitted from the emission portion LU_1 including the infrared light-emitting diodes may be excited by infrared light of a second wavelength and detected by the infrared light-receiving diode of the additional light-receiving portion PU5. Meanwhile, the infrared light of the first wavelength that is emitted from the emission portion LU_1 including the infrared light-emitting diodes may be detected intactly by the infrared light-receiving diode of the additional light-receiving portion PU5.

Because the semiconductor chip SC is arranged between the additional light-receiving portion PU5 and the emission portions LU and LU_1, the semiconductor chip SC may function as a partition.

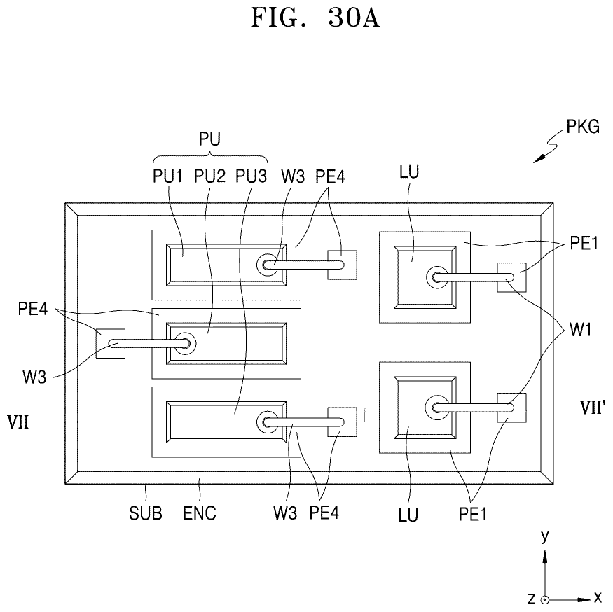

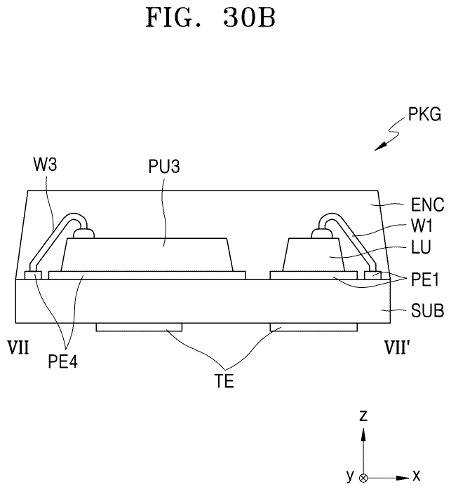

FIG. 30A is a plan view of an optical sensor package according to an embodiment, and FIG. 30B is a cross-sectional view of the optical sensor package, taken along a line VII-VII′ of FIG. 30A.

The optical sensor package PKG shown in FIGS. 30A and 30B differs from the optical sensor package PKG shown in FIGS. 24A to 24D, which includes the light-receiving portion PU with the RGB detection sensor arranged on the semiconductor chip SC, in that the optical sensor package PKG shown in FIGS. 30A and 30B does not include a semiconductor chip SC and includes a light-receiving portion PU with an RGB detection sensor, and the remaining components are substantially the same. Hereinafter, the differences between the components are mainly described, and repeated descriptions regarding the same components are omitted.

Referring to FIGS. 30A and 30B, the optical sensor package PKG may include the light-receiving portion PU including the RGB detection sensors, a fourth element PE4, and a third conductive member W3.

In an embodiment, the fourth element PE4 may be formed on the first surface S1 of the package substrate SUB. The fourth element PE4 may be connected to the light-receiving portion PU including the RGB detection sensors. The RGB detection sensor may include therein a first photodiode PU1 detecting red light, a second photodiode PU2 detecting green light, and a third photodiode PU3 detecting blue light.

For example, the fourth element PE4 may include two terminals including a negative terminal and a positive terminal. The first photodiode PU1 may be directly coupled to any one of the two terminals. The third conductive member W3 may connect the first photodiode PU1 to the other of the two terminals. The second photodiode PU2 may be directly coupled to any one of the two terminals. The third conductive member W3 may connect the second photodiode PU2 to the other of the two terminals. Similarly, the third photodiode PU3 may be directly coupled to any one of the two terminals. The third conductive member W3 may connect the third photodiode PU3 to the other of the two terminals.

Because the light-receiving portion PU may sense only visible light, the likelihood of crosstalk caused by the light emitted from the emission portion LU including ultraviolet light-emitting diodes may not be theoretically high. Unlike the embodiments shown in FIGS. 24A to 29B, the embodiment shown in FIGS. 30A and 30B does not illustrate the semiconductor chip SC serving as a partition. In other words, the optical sensor package PKG shown in FIGS. 30A and 30B has an advantage in terms of miniaturization and manufacturing cost reduction, but as long as there is no physical shielding structure, the sensing sensitivity may be likely to degrade due to various noise.

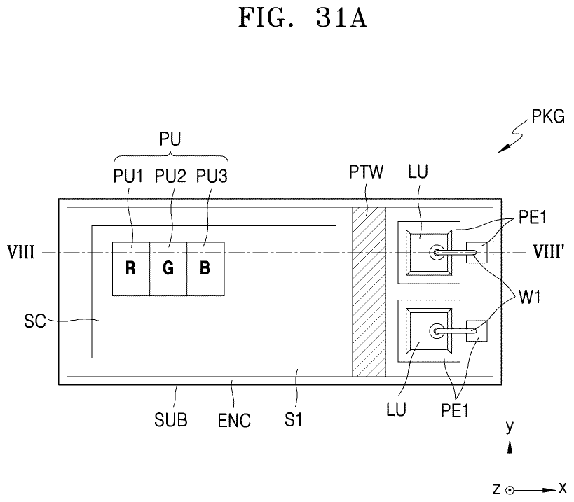

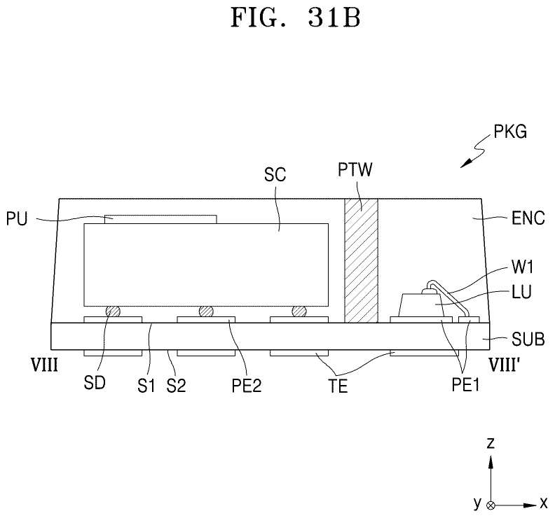

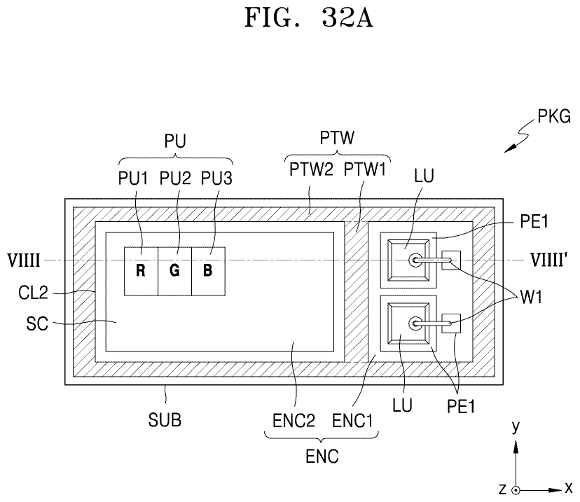

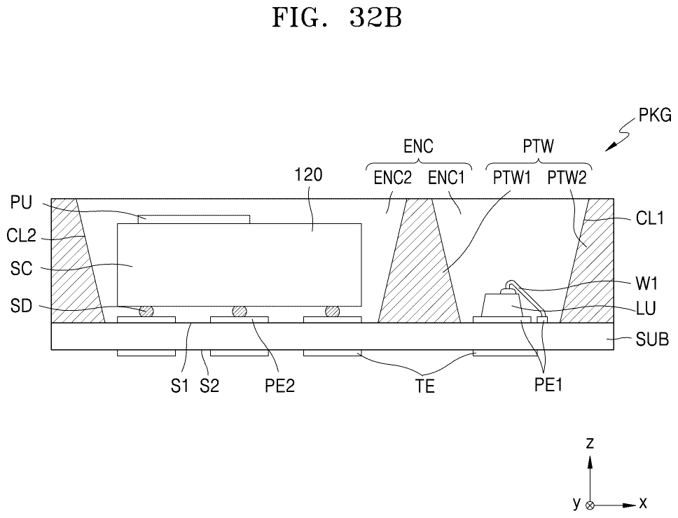

On the contrary, a partition structure is further formed in the embodiments shown in FIGS. 24A to 29B, as in the optical sensor packages PKG in FIGS. 31A to 32B described below so that the likelihood of crosstalk may be further reduced and the sensing sensitivity may be notably enhanced.

Hereinafter, for convenience of explanation, FIGS. 31A to 32B illustrate the embodiment in which the partition structure is added to the optical sensor package PKG shown in FIGS. 24A to 24D. However, one or more embodiments are not limited thereto, and a partition structure may also be added to the optical sensor packages PKG shown in FIGS. 25A to 30B.

FIG. 31A is a plan view of an optical sensor package according to an embodiment. FIG. 31B is a cross-sectional view of the optical sensor package, taken along a line VIII-VIII′ of FIG. 31A.

The optical sensor package PKG shown in FIGS. 31A and 31B differs from the optical sensor package PKG shown in FIGS. 24A to 24D, which does not include a partition PTW, in that the optical sensor package PKG shown in FIGS. 31A and 31B includes a partition PTW between the emission portion LU and the light-receiving portion PU (or the semiconductor chip SC), and the remaining components are substantially the same. Hereinafter, the differences between the components are mainly described, and repeated descriptions regarding the same components are omitted.

Referring to FIGS. 24A to 24D, 31A, and 31B, the partition PTW may be arranged between the emission portion LU and the light-receiving portion PU, thus preventing the light from the emission portion LU from being incident to the light-receiving portion PU.

It is advantageous to form the partition PTW using a material with low transmittance to the light emitted from the emission portion LU to reduce the incidence rate of the light from the emission portion LU to the light-receiving portion PU. For example, the partition PTW may include a black EMC.

In existing cases, when a separately manufactured partition member is attached to a package substrate SUB using adhesive resin or the like, light from an emission portion LU leaks through the portion where the adhesive resin is placed and then reaches a light-receiving portion PU. In contrast, according to the method of manufacturing the optical sensor package PKG of the disclosure, the partition PTW may be directly formed on the package substrate SUB using a transfer molding method. Thus, in the optical sensor package PKG of the disclosure, because the partition PTW is formed on the package substrate SUB without adhesive resin, light leakage due to the adhesive resin may be effectively prevented.

In addition, because the partition PTW is coupled to the package substrate SUB, the partition PTW may include a material with a coefficient of thermal expansion similar to that of the package substrate SUB. For example, the partition PTW may have a coefficient of thermal expansion that is about 0.8 times to about 1.2 times that of the package substrate SUB. In this case, the adhesion between the package substrate SUB and the partition PTW increases, and the distortion of the partition PTW decreases; thus, the partition PTW may remain stably attached to the package substrate SUB.

As shown in FIGS. 31A and 31B, the partition PTW is disposed only between the light-receiving portion PU and the emission portion LU, but in the optical sensor package PKG according to another embodiment, the partition PTW may not only be between the light-receiving portion PU and the emission portion LU, but may also be additionally formed along the periphery of the package substrate SUB, as shown in FIGS. 32A and 32B.

The optical sensor package PKG the molding member ENC arranged on the upper surface of an exposed portion of the package substrate SUB, the emission portion PU, the semiconductor chip SC, and the light-receiving portion PU.

In an embodiment, the molding member ENC may include a light-transmissive material. For example, the molding member ENC may be a clear molding compound (CMC). The molding member ENC may guide the light emitted from the emission portion LU so that the light may be transmitted to the identification portion ID of the cigarette 5 that is a sensing target of the optical sensor package PKG.

The upper surface of the partition PTW and the upper surface of the molding member ENC may be arranged on the same plane, and the other side surfaces of the partition PTW, except the side surfaces facing the emission portion LU, the light-receiving portion PU, and the semiconductor chip SC, may be arranged on the same plane as the side surfaces of the molding member ENC.

FIG. 32A is a plan view of an optical sensor package according to an embodiment. FIG. 32B is a cross-sectional view of the optical sensor package, taken along a line VIIII-VIIII′ of FIG. 32A.

The optical sensor package PKG shown in FIGS. 32A and 32B differs from the optical sensor package PKG shown in FIGS. 31A and 31B, in which the partition PTW is positioned only between the emission portion LU and the light-receiving portion PU (or the semiconductor chip SC), in that the optical sensor package PKG shown in FIGS. 32A and 32B includes a second partition portion extending along the periphery of the package substrate in the direction of the first surface (e.g., the surface in the +Z direction), and the remaining components are substantially the same. Hereinafter, the differences between the components are mainly described, and repeated descriptions regarding the same components are omitted.

Referring to FIGS. 32A and 32B, the optical sensor package PKG may include a partition PTW that includes a first partition portion PTW1 arranged between the emission portion LU and the light-receiving portion PU (or the semiconductor chip SC) and a second partition portion PTW2 extending along the periphery of the package substrate SUB in the direction of the first surface S1 (e.g., the surface in the +Z direction).

It is advantageous to form the partition PTW using a material with low transmittance to the light emitted from the emission portion LU to reduce the incidence rate of the light from the emission portion LU to the light-receiving portion PU. For example, the partition PTW may include a black EMC.

The optical sensor package PKG may include a molding member ENC that includes a first molding portion ENC1 arranged on the upper surface of an exposed portion of the package substrate SUB and the emission portion LU and a second molding portion ENC2 arranged on the upper surface of another exposed portion of the package substrate SUB, the light-receiving portion PU, and the semiconductor chip SC.

In an embodiment, the molding member ENC may include a light-transmissive material. For example, the molding member ENC may be a CMC. The molding member ENC may guide the light emitted from the emission portion LU so that the light may be transmitted to the identification portion ID of the cigarette 5 that is a sensing target of the optical sensor package PKG.

The inner side surface of the partition PTW that contacts the first molding portion ENC1 may have a first inclined surface CL1 that forms an obtuse angle with the first surface S1 (or the upper surface) of the package substrate SUB.

A reflective material may be placed on the inclined surface. The reflective material may reflect light from the emission portion LU, allowing the light to evenly spread. For example, the reflective material may include at least one of glass, quartz, ceramic, polymethlymethalcrylate (PMMA), polycabonate, silicon resin, and plastics such as White Epoxy Molding Compound (WEMC), plyphthalamide (PPA), or Polycyclo hexylene dimethylen-eterephthalate (PCT).

In addition, the inner side surface of the partition PTW that contacts the second molding portion ENC2 may have a second inclined surface CL2 that forms an obtuse angle with the first surface S1 (or the upper surface) of the package substrate SUB.

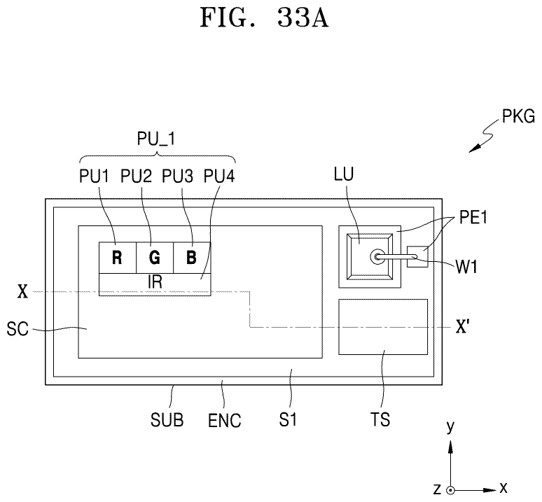

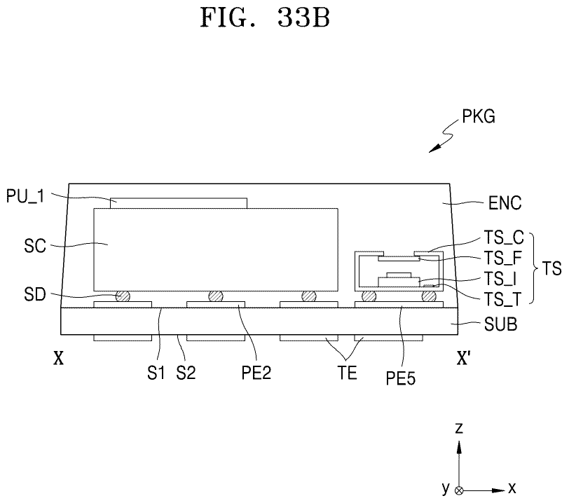

FIG. 33A is a plan view of an optical sensor package that includes a temperature sensor unit, according to an embodiment, and FIG. 33B is a cross-sectional view of the optical sensor package, taken along a line X-X′ of FIG. 33A.

Referring to FIGS. 24A, 33A, and 33B, the aerosol generating system according to an embodiment may include the cigarette 5 including the identification portion ID, which emits light of the second wavelength that is different from the first wavelength as the identification portion ID is excited by light of the first wavelength, and the aerosol generating device 1.

The aerosol generating device 1 may include the main body 100 including the cavity 100a into which the cigarette 5 is inserted, the optical sensor package PKG arranged around the cavity 100a and detecting the identification portion ID, and the controller 110 that identifies whether the cigarette 5 is counterfeit and the type of cigarette 5 based on a sensing value detected by the optical sensor package PKG. In this case, the aerosol generating device 1 shown in FIG. 24A may correspond to the aerosol generating device 1 shown in FIGS. 7 and 8. Hereinafter, repeated descriptions are omitted.

The optical sensor package PKG according to an embodiment may include the package substrate SUB, the emission portion LU, the semiconductor chip SC, the light-receiving portion PU, a temperature sensor unit TS, and the molding member ENC.

In an embodiment, the first surface S1 may be a surface on which the optical sensor package PKG faces the identification portion ID of the cigarette 5. The substrate terminals TE may be electrically and/or physically connected to the aerosol generating device 1 on which the optical sensor package PKG of the disclosure is mounted.

The identification portion ID may include an identification material. The identification material may be excited as light in a specific wavelength range is absorbed, and in this case, ‘the excitation of a material’ may refer to a transition of the material from a ground state to an excited state. Then, while the state of the identification material transitions from the excited state to the ground state, light in a specific wavelength range may be emitted from the emission material.

In an embodiment, the identification material may be excited by light irradiated from the emission portion LU and may emit light in a wavelength range that is different from that of the irradiated light. For example, the identification material may be excited by light in a first wavelength range that is irradiated from the emission portion LU and emit light in a second wavelength range that is different from the first wavelength range.

For example, the identification material may be a first emission material that emits light in a second wavelength range of about 400 nm to about 750 nm when excited by light in a first wavelength range of about 350 nm to about 390 nm. Thus, the emission portion LU may irradiate ultraviolet light of about 365 nm onto the first emission material, and the light-receiving portion PU may sense visible light (that is, red light) of about 700 nm that is emitted from the first emission material.

As another example, the identification material may be a second emission material that emits light in a second wavelength range of about 1000 nm to about 1020 nm when excited by light in a first wavelength range of about 300 nm to about 340 nm. Thus, the emission portion LU may irradiate ultraviolet light of about 325 nm onto the second emission material, and the light-receiving portion PU_1 may sense infrared light of about 1012 nm that is emitted from the second emission material.

In an embodiment, the semiconductor chip SC may be an ASIC that controls the general operation of the optical sensor package PKG.

In an embodiment, the light-receiving portion PU_1 may include at least one light-receiving diode through which a current flows when light L′ of a second wavelength is received, wherein the light L′ is different from the light L of a first wavelength. For example, the light-receiving portion PU_1 shown in FIGS. 33A and 33B may be an RGB detection sensor. The RGB detection sensor may include therein a first photodiode PU1 detecting red light, a second photodiode PU2 detecting green light, and a third photodiode PU3 detecting blue light. In addition, the light-receiving portion PU_1 may further include an infrared light-receiving diode PU4 that may receive light at an infrared wavelength (that is, in a range of about 1000 nm to about 1020 nm).

Therefore, when the identification material included in the cigarette 5 is the first emission material, the light emitted from the emission portion LU including the ultraviolet light-emitting diodes may be detected by the RGB detection sensors(ex: PU1 to PU3) of the light-receiving portion PU_1, and when the identification material is the second emission material, the light may be detected by the infrared light-receiving diode PU4 of the light-receiving portion PU_1.

In addition, when the identification material included in the cigarette 5 is the third emission material, the infrared light of a first wavelength that is emitted from the emission portion LU_1 including the infrared light-emitting diodes may be excited by infrared light of a second wavelength and detected by the infrared light-receiving diode PU4 of the light-receiving portion PU_1.

In an embodiment, the temperature sensor unit TS may be arranged on the package substrate SUB. Solder balls SD may electrically connect a fifth element PE5 to the temperature sensor unit TS. For example, the fifth element PE5 may include a plurality of terminals corresponding to pad electrodes formed on the rear surface of the temperature sensor unit TS. The solder balls SD may be arranged between the pad electrodes of the temperature sensor unit TS and electrodes of the fifth element PE5, and the temperature sensor unit TS may be coupled to the fifth element PE5 through a reflow process.

For example, the temperature sensor unit TS may include an infrared temperature sensor TS_I. The temperature sensor unit TS may include a case TS_C with an open upper portion, the infrared temperature sensor TS_I mounted inside the case TS_C, a thermistor TS_T, and an infrared transmission window TS_F installed on the open upper portion of the case TS_C.

The infrared transmission window TS_F may include, for example, an infrared filter and a lens and may be provided on the upper portion of the infrared temperature sensor TS_I. The infrared transmission window TS_F may transmit infrared light and provide the same to the infrared temperature sensor TS_I.

Therefore, the temperature sensor unit TS may provide the infrared light, which is incident through the infrared transmission window TS_F, to the infrared temperature sensor TS_I by selecting infrared light in a specific wavelength range, and the thermistor TS_T may convert the infrared light into an electrical signal; thus, the temperature near the cavity 100a may be measured.

As the heater 140 operates in the aerosol generating device 1, the temperature near the cavity 100a may increase. Because characteristics of light-emitting devices (e.g., light-emitting diodes) of the emission portion LU change due to heat, the temperature increase of the heater 140 may result in a decrease in the light emission amount of the emission portion LU and a degradation in the detection capability of the optical sensor package PKG. Therefore, to prevent the decrease in the emission amount of the emission portion LU due to the increase in the temperature of the heater 140, the aerosol generating device 1 may adjust the emission amount of the emission portion LU.

For example, when the temperature near the cavity 100a increases, the emission amount of the emission portion LU may be reduced. In this case, when the measured temperature of the temperature sensor unit TS changes beyond a preset reference temperature range, the semiconductor chip SC may adjust the emission amount of the emission portion LU based on the difference between the measured temperature and the upper limit of the reference temperature range. As the emission amount of the emission portion LU is adjusted, the degradation in the detection capability of the optical sensor package PKG may be prevented. In other words, the aerosol generating device 1 may compensate for a detection value of the optical sensor package PKG by increasing the emission amount of the light-emitting devices of the emission portion LU that was reduced due to the increase in the temperature of the heater 140.

Based on an offset value, the semiconductor chip SC may control a duty ratio through pulse width modulation of the emission portion LU. The memory 130 may include a lookup table in which the offset value for adjusting the emission amount of the emission portion LU is mapped to each difference between the measured temperature and the upper limit of the reference temperature range. For example, as the temperature near the cavity 100a increases, the difference between the measured temperature and the upper limit of the reference temperature range increases, and thus, the offset value may also increase.

The controller 110 may determine whether the cigarette 5 is counterfeit and the type of cigarette 5, based on the sensing value detected by the optical sensor package PKG.

In an embodiment, the molding member ENC may be arranged on the first surface S1 of the package substrate SUB. The molding member ENC may protect the first surface S1 of the package substrate SUB and other components (e.g., the emission portion LU, the semiconductor chip SC, the temperature sensor unit TS, and the light-receiving portion PU) mounted on the first surface S1. The molding member ENC may include a non-conductive material. The molding member ENC may reduce or prevent electrical disconnection or unintended short circuits of the first surface S1 of the package substrate SUB and other components mounted on the first surface S1.

In an embodiment, the molding member ENC may be formed on the first surface S1 of the package substrate SUB to surround the emission portion LU, the semiconductor chip SC, the temperature sensor unit TS, and the light-receiving portion PU.

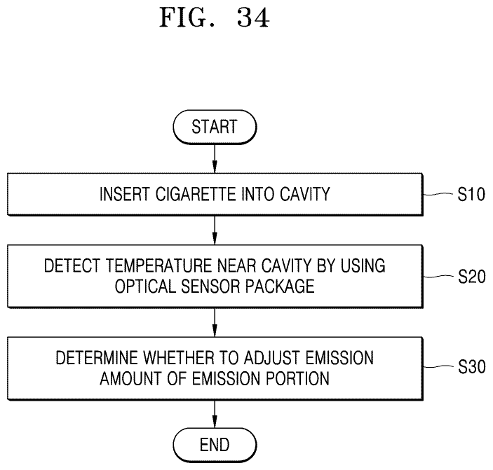

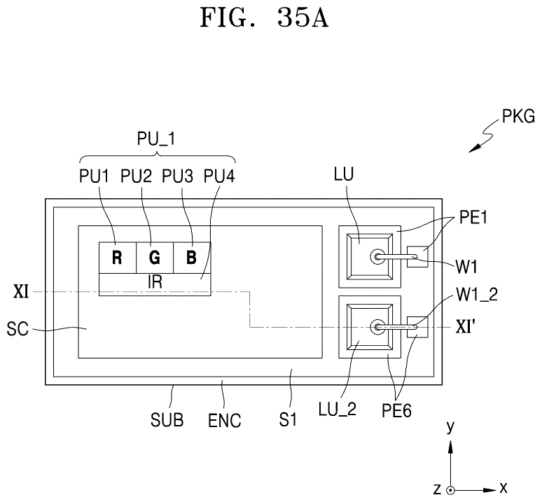

FIG. 34 is a flowchart for explaining an emission amount adjustment method of an aerosol generating system, according to an embodiment.

Referring to FIGS. 24A and 33A to 34, an operating method of the aerosol generating system according to an embodiment may include operation S10 of inserting the cigarette 5 into the cavity 100a of the aerosol generating device 1, operation S20 of measuring a temperature near the cavity 100a by using the temperature sensor unit TS included in the optical sensor package PKG, and operation S30 of determining whether to adjust the emission amount of the emission portion LU included in the optical sensor package PKG, based on the measured temperature near the cavity 100a.

Specifically, in operation S10, the cigarette 5 may include the identification portion ID that emits light of a second wavelength that is different from the first wavelength as being excited by the light of the first wavelength. The identification portion ID may include an identification material, and the identification material may be excited by ultraviolet light and emit any one of red visible light, green visible light, blue visible light, and yellow visible light. For example, the identification material may include an organic material, and the organic material may include at least one organic material selected from the group consisting of quinazolinone-based compounds, thiophene-based compounds, sulfobenzoic acid-based compounds, and naphthyridine-based compounds.

In operation S20, the temperature sensor unit TS may include the infrared temperature sensor TS_I. The temperature sensor unit TS may include the case TS_C with an open upper portion, the infrared temperature sensor TS_I mounted inside the case TS_C, the thermistor TS_T, and the infrared transmission window TS_F installed on the open upper portion of the case TS_C.

The infrared transmission window TS_F may include, for example, an infrared filter and a lens and may be provided on the upper portion of the infrared temperature sensor TS_I. The infrared transmission window TS_F may transmit infrared light and provide the same to the infrared temperature sensor TS_I.

Therefore, the temperature sensor unit TS may provide the infrared light, which is incident through the infrared transmission window TS_F, to the infrared temperature sensor TS_I by selecting infrared light in a specific wavelength range, and the thermistor TS_T may convert the infrared light into an electrical signal; thus, the temperature near the cavity 100a may be measured.

As the heater 140 operates in the aerosol generating device 1, the temperature near the cavity 100a may increase. Because characteristics of light-emitting devices (e.g., light-emitting diodes) of the emission portion LU change due to heat, the temperature increase of the heater 140 may result in a decrease in the light emission amount of the emission portion LU and a degradation in the detection capability of the optical sensor package PKG.

In operation S30, when the temperature near the cavity 100a that is measured by the temperature sensor unit TS is higher than the upper limit of the preset reference temperature range, the semiconductor chip SC may determine to adjust the emission amount of the emission portion. In this case, the reference temperature range may be set in advance based on experimental statistics.

When the measured temperature of the temperature sensor unit TS changes beyond a preset reference temperature range, the semiconductor chip SC may adjust the emission amount of the emission portion LU based on the difference between the measured temperature and the upper limit of the reference temperature range. As the emission amount of the emission portion LU is adjusted, the degradation in the detection capability of the optical sensor package PKG may be prevented. In other words, the aerosol generating device 1 may compensate for a detection value of the optical sensor package PKG by increasing the emission amount of the light-emitting devices of the emission portion LU that was reduced due to the increase in the temperature of the heater 140.

Based on an offset value, the semiconductor chip SC may control a duty ratio through pulse width modulation of the emission portion LU. The memory 130 may include a lookup table in which the offset value for adjusting the emission amount of the emission portion LU is mapped to each difference between the measured temperature and the upper limit of the reference temperature range. For example, as the temperature near the cavity 100a increases, the difference between the measured temperature and the upper limit of the reference temperature range increases, and thus, the offset value may also increase.

Because the aerosol generating device 1 is a small-sized electronic product, there are limitations on the space for mounting various electronic components, and the space for mounting the battery 120 may also be limited. Accordingly, there is a need to effectively utilize the limited capacity of the battery 120.

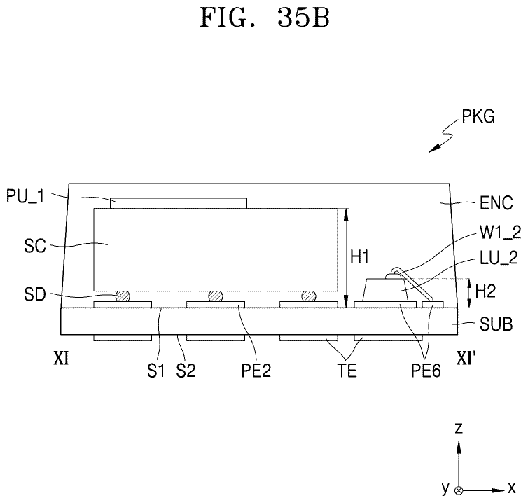

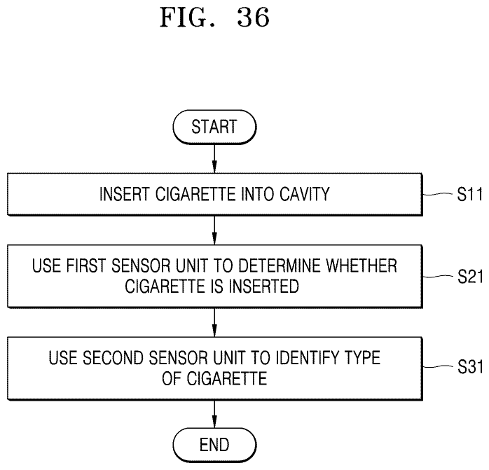

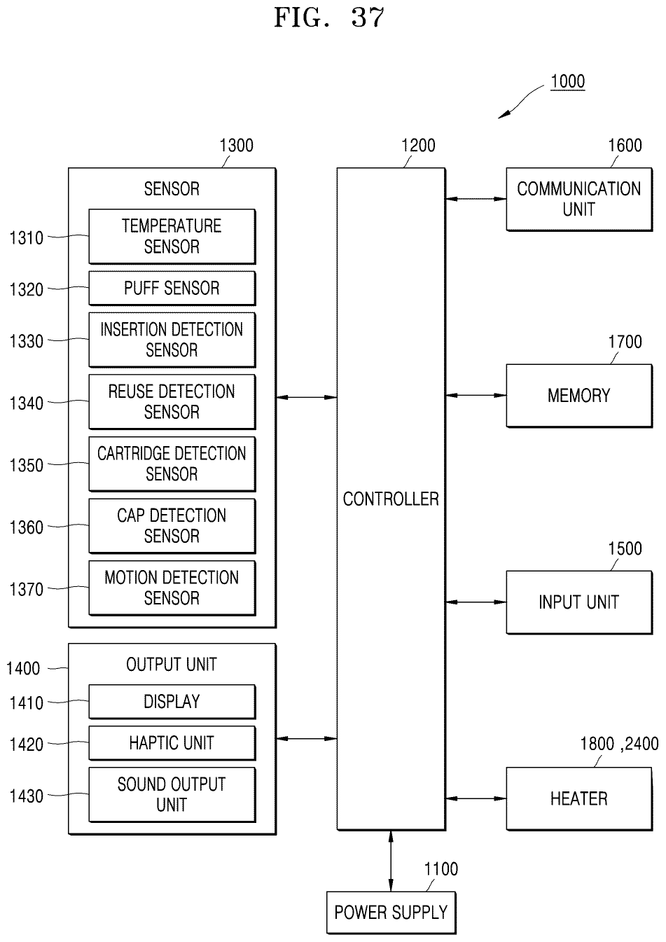

The sensor unit 150 (or the optical sensor package PKG) described above with reference to FIGS. 24A to 33B includes the emission portion LU, and to identify the identification portion ID that emits light of a second wavelength that is different from the first wavelength when excited by light of the first wavelength, the sensor unit 150 includes light-emitting diodes that commonly emit ultraviolet light. However, the ultraviolet light has a significantly short wavelength, and the emission portion LU requires higher power consumption to generate the ultraviolet light compared to when visible light or infrared light is generated. Therefore, in terms of reducing power consumption, a method of minimizing the operation of the emission portion LU that emits ultraviolet light is described in more detail with reference to FIGS. 35A to 36.

FIG. 35A is a plan view of an optical sensor package that includes an emission portion emitting visible light, according to an embodiment, and FIG. 35B is a cross-sectional view of the optical sensor package, taken along a line XI-XI′ of FIG. 35A.

Referring to FIGS. 24A, 35A, and 35B, the aerosol generating system according to an embodiment may include the cigarette 5 including the identification portion ID, which emits light of the second wavelength that is different from the first wavelength when excited by light of the first wavelength, and the aerosol generating device 1.

The aerosol generating device 1 may include the main body 100 including the cavity 100a into which the cigarette 5 is inserted, the optical sensor package PKG arranged around the cavity 100a and detecting the identification portion ID, and the controller 110 that identifies whether the cigarette 5 is counterfeit and the type of cigarette 5 based on a sensing value detected by the optical sensor package PKG. In this case, the aerosol generating device 1 shown in FIG. 24A may correspond to the aerosol generating device 1 shown in FIGS. 7 and 8. Hereinafter, repeated descriptions are omitted.

The optical sensor package PKG may include the package substrate SUB, emission portions LU and LU_2, the semiconductor chip SC, the light-receiving portion PU, and the molding member ENC. In this case, the optical sensor package PKG may further include the emission portion LU_2 emitting visible light or ultraviolet light, in addition to the emission portion LU emitting ultraviolet light.

In an embodiment, the first surface S1 may be a surface on which the optical sensor package PKG faces the identification portion ID of the cigarette 5. The substrate terminal TE may be electrically and/or physically connected to the aerosol generating device 1 on which the optical sensor package PKG of the disclosure is mounted.

Referring to FIG. 20, the identification portion ID4 according to an embodiment may be formed such that the band pattern BP including the first identification material overlaps the grid pattern GP including the second identification material in the thickness direction.

The first identification material may include a visible light reflection material when the emission portion LU_2 includes a white light-emitting diode. However, one or more embodiments are not limited thereto, and when the emission portion LU_2 includes an infrared light-emitting diode, the first identification material may also include an infrared reflection material.

The second identification portion may include the second identification material that emits light of the second wavelength that is different from the first wavelength when excited by light of the first wavelength.

The second identification material may be excited as light in a specific wavelength range is absorbed, and in this case, ‘the excitation of a material’ may refer to a transition of the material from a ground state to an excited state. Then, while the state of the second identification material transitions from the excited state to the ground state, light in a specific wavelength range may be emitted from the emission material.

In an embodiment, the second identification material may be excited by light irradiated from the emission portion LU and may emit light in a wavelength range that is different from that of the irradiated light. For example, the second identification material may be excited by light in a first wavelength range that is irradiated from the emission portion LU and emit light in a second wavelength range that is different from the first wavelength range.

For example, the second identification material may be a first emission material that emits light in a second wavelength range of about 400 nm to about 750 nm when excited by light in a first wavelength range of about 350 nm to about 390 nm. Thus, the emission portion LU may irradiate ultraviolet light of about 365 nm onto the first emission material, and the light-receiving portion PU may sense visible light (that is, red light) of about 700 nm that is emitted from the first emission material.

As another example, the second identification material may be a second emission material that emits light in a second wavelength range of about 1000 nm to about 1020 nm when excited by light in a first wavelength range of about 300 nm to about 340 nm. Thus, the emission portion LU may irradiate ultraviolet light of about 325 nm onto the second emission material, and the light-receiving portion PU_1 may sense infrared light of about 1012 nm that is emitted from the second emission material.

In an embodiment, the semiconductor chip SC may be an ASIC that controls the general operation of the optical sensor package PKG.

In an embodiment, the light-receiving portion PU_1 may include at least one light-receiving diode through which a current flows when light L′ of a second wavelength is received, wherein the light L′ is different from the light L of a first wavelength. For example, the light-receiving portion PU_1 shown in FIGS. 35A and 35B may be an RGB detection sensor. The RGB detection sensor may include therein the first photodiode PU1 detecting red light, the second photodiode PU2 detecting green light, and the third photodiode PU3 detecting blue light. In addition, the light-receiving portion PU_1 may further include the infrared light-receiving diode PU4 that may receive infrared wavelengths (that is, in a range of about 1000 nm to about 1020 nm).

Therefore, when the second identification material included in the cigarette 5 is the first emission material, the light emitted from the emission portion LU including the ultraviolet light-emitting diodes may be detected by the RGB detection sensors(ex: PU1 to PU3) of the light-receiving portion PU_1, and when the second identification material is the second emission material, the light may be detected by the infrared light-receiving diode PU4 of the light-receiving portion PU_1.

In addition, when the first identification material included in the cigarette 5 is a visible light reflection material, white light emitted from the emission portion LU_2 including white light-emitting diodes may be detected by the RGB detection sensors PU1 to PU3 of the light-receiving portion PU_1.

The emission portion LU_2 may include infrared light-emitting diodes. When the second identification material included in the cigarette 5 is an infrared reflection material, the infrared light may be reflected and detected by the infrared light-receiving diode PU4 of the light-receiving portion PU_1.

In an embodiment, the molding member ENC may be arranged on the first surface S1 of the package substrate SUB. The molding member ENC may protect the first surface S1 of the package substrate SUB and other components (e.g., the emission portions LU and LU_2, the semiconductor chip SC, and the light-receiving portion PU) mounted on the first surface S1. The molding member ENC may include a non-conductive material. The molding member ENC may reduce or prevent electrical disconnection or unintended short circuits of the first surface S1 of the package substrate SUB and other components mounted on the first surface S1.

In an embodiment, the molding member ENC may be formed on the first surface S1 of the package substrate SUB to surround the emission portions LU and LU_2, the semiconductor chip SC, and the light-receiving portion PU.

Hereinafter, for convenience of explanation, a combination of the emission portion LU_2 including white light-emitting diodes (or infrared light-emitting diodes) and the light-receiving portion PU_1 is defined as a first sensor unit, and a combination of the emission portion LU including the ultraviolet light-emitting diodes and the light-receiving portion PU_1 is defined as a second sensor unit. The first sensor unit according to an embodiment may repeatedly switch between the ON state and the OFF state in a preset cycle and detect whether the cigarette 5 is inserted into the cavity 100a. For example, when the visible light (or infrared light) emitted from the emission portion LU_1 is reflected by the band pattern BP including the first identification material and is received by the light-receiving portion PU_1, the controller 110 may determine that the cigarette 5 is inserted into the cavity 100a and then switch the first sensor unit to the OFF state and the second sensor unit to the ON state.

Then, the second sensor unit may identify whether the cigarette 5 is counterfeit and the type of cigarette 5. For example, when the ultraviolet light emitted from the emission portion LU is excited by the grid pattern GP including the second identification material, converted into visible light, and then received by the light-receiving portion PU_1 the controller 110 may compare color information of the second identification material, which is detected by the second sensor unit, with the pieces of color information stored in the memory 130, thereby determining the type of cigarette 5 inserted into the cavity 100a.

When a second identification material detection event ends, the controller 110 may switch the second sensor unit to the OFF state.

Then, the controller 110 may operate the first sensor unit to repeatedly switch between the ON state and the OFF state in a preset cycle. The movement state of the cigarette 5 may be detected through the detection operation of the first sensor unit. For example, the controller 110 may use the first sensor unit to determine that the cigarette 5 has moved within the cavity 100a when the amount of visible light (or infrared light) reflected from the band pattern BP is detected to be a preset threshold value or lower. In this case, the movement state of the cigarette 5 may refer to the state in which because the cigarette 5 is not sufficiently heated by the heater 140, it is difficult to provide the user of the aerosol generating device 1 with a satisfactory smoking sensation.

When determining that the cigarette 5 is moved within the cavity 100a, the controller 110 may perform a smart off operation that stops the operation of the heater 140.

FIG. 36 is a flowchart for explaining a power consumption reduction operation of an aerosol generating system, according to an embodiment.

Referring to FIGS. 24A, 35A, and 36, an operating method of the aerosol generating system according to an embodiment may include operation S11 of inserting the cigarette 5 into the cavity 100a of the aerosol generating device 1, operation S21 of determining whether the cigarette 5 is inserted into the cavity 100a, based on the sensing value of the first identification portion (e.g., the band pattern BP of FIG. 20) that is detected by the first sensor unit included in the optical sensor package PKG arranged near the cavity 100a, and operation S31 of determining, when it is determined that the cigarette 5 is inserted into the cavity 100a, the type of cigarette 5 based on the sensing value of the second identification portion (e.g., the grid pattern GP of FIG. 20) that is detected by the second sensor unit included in the optical sensor package PKG.

Specifically, in operation S11, referring to FIG. 20, the identification portion ID4 may be formed such that the band pattern BP including the first identification material overlaps the grid pattern GP including the second identification material in the thickness direction. The first identification material may include a visible light reflection material when the emission portion LU_2 includes a white light-emitting diode. However, one or more embodiments are not limited thereto, and when the emission portion LU_2 includes an infrared light-emitting diode, the first identification material may include an infrared reflection material.

The second identification portion may include the second identification material emitting light of the second wavelength that is different from the first wavelength when excited by light of the first wavelength. The second light may be excited by ultraviolet light and emit any one of red, green, blue, and yellow visible light. For example, the second identification material may include an organic material, and the organic material may include at least one organic material selected from the group consisting of quinazolinone-based compounds, thiophene-based compounds, sulfobenzoic acid-based compounds, and naphthyridine-based compounds.

In operation S21, the first sensor unit may repeatedly switch between the ON state and OFF state in a preset cycle and detect whether the cigarette 5 is inserted into the cavity 100a. For example, when the visible light (or infrared light) emitted from the emission portion LU_1 is reflected by the band pattern BP including the first identification material and is received by the light-receiving portion PU_1, the controller 110 may determine that the cigarette 5 is inserted into the cavity 100a and then switch the first sensor unit to the OFF state and the second sensor unit to the ON state.

In operation S31, the second sensor unit may identify whether the cigarette 5 is counterfeit and the type of cigarette 5. For example, when the ultraviolet light emitted from the emission portion LU is excited by the grid pattern GP including the second identification material, converted into visible light, and then received by the light-receiving portion PU_1, the controller 110 may compare color information of the second identification material, which is detected by the second sensor unit, with the pieces of color information stored in the memory 130, thereby determining the type of cigarette 5 inserted into the cavity 100a.

When a second identification material detection event ends, the controller 110 may switch the second sensor unit to the OFF state.

The operating method of the aerosol generating system according to an embodiment may further include stopping the operation of the heater 140 when the first sensor unit is unable to detect the first identification portion after power supply to the heater 140 starts.

The controller 110 may operate the first sensor unit to repeatedly switch between the ON state and the OFF state in a preset cycle. The movement state of the cigarette 5 may be detected through the detection operation of the first sensor unit. For example, when the first sensor unit detects that the amount of visible light (or infrared light) reflected by the band pattern BP is equal to or less than a preset threshold value, the controller 110 may determine that the cigarette 5 is moved within the cavity 100a. In this case, the movement state of the cigarette 5 may refer to the state in which because the cigarette 5 is not sufficiently heated by the heater 140, it is difficult to provide the user of the aerosol generating device 1 with a satisfactory smoking sensation.

When determining that the cigarette 5 is moved within the cavity 100a, the controller 110 may perform a smart off operation that stops the operation of the heater 140.

FIG. 37 is a block diagram of an aerosol generating device according to another embodiment.

The aerosol generating device 1000 may include a power supply 1100, a controller 1200, a sensor 1300, an output unit 1400, an input unit 1500, a communication unit 1600, a memory 1700, and one or more heaters(ex: 1800 and 2400). However, the internal structure of the aerosol generating device 1000 is not limited to those illustrated in FIG. 37. That is, according to the design of the aerosol generating device 1000, it will be understood by one of ordinary skill in the art that some of the components shown in FIG. 37 may be omitted or new components may be added.

The sensor 1300 may sense a state of the aerosol generating device 1000 and a state around the aerosol generating device 1000, and transmit sensed information to the controller 1200. Based on the sensed information, the controller 1200 may control the aerosol generating device 1000 to perform various functions, such as controlling the operation of the cartridge heater 2400 and/or the heater 1800, limiting smoking, determining whether an aerosol generating article and/or a cartridge 19 is inserted, and displaying a notification.

The sensor 1300 may include at least one of a temperature sensor 1310, a puff sensor 1320, an insertion detection sensor 1330, a reuse detection sensor 1340, a cartridge detection sensor 1350, a cap detection sensor 1360, and a motion detection sensor 1370.

The temperature sensor 1310 may sense a temperature at which the cartridge heater 2400 and/or the heater 1800 is heated. The aerosol generating device 1000 may include a separate temperature sensor for detecting the temperature of the cartridge heater 2400 and/or the heater 1800, or the cartridge heater 2400 and/or the heater 1800 may serve as a temperature sensor.

The temperature sensor 1310 may output a signal corresponding to the temperature of the cartridge heater 2400 and/or the heater 1800. For example, the temperature sensor 1310 may include a resistive element whose resistance value varies according to a temperature change in the cartridge heater 2400 and/or the heater 1800. The temperature sensor 1310 may be implemented as a thermistor that is a device whose resistance changes depending on temperature. In this case, the temperature sensor 1310 may output a signal corresponding to the resistance value of the resistive element as a signal corresponding to the temperature of the cartridge heater 2400 and/or the heater 1800. For example, the temperature sensor 1310 may include a sensor that detects a resistance value of the cartridge heater 2400 and/or the heater 1800. In this case, the temperature sensor 1310 may output the signal corresponding to a resistance value of the cartridge heater 2400 and/or the heater 1800 as a signal corresponding to the temperature of the cartridge heater 2400 and/or the heater 1800.

The temperature sensor 1310 may be arranged near the power supply 1100 to monitor the temperature of the power supply 1100. The temperature sensor 1310 may be arranged adjacent to the power supply 1100. For example, the temperature sensor 1310 may be attached to a surface of a battery that is the power supply 1100. For example, the temperature sensor 1310 may be mounted on a surface of a printed circuit board.

The temperature sensor 1310 may be arranged inside the aerosol generating device main body and detect the internal temperature thereof.

The puff sensor 1320 may sense a user's puff based on various physical changes in an airflow path. The puff sensor 1320 may output a signal corresponding to a puff. For example, the puff sensor 1320 may be a pressure sensor. The puff sensor 1320 may output a signal corresponding to the internal pressure of the aerosol generating device. Here, the internal pressure of the aerosol generating device 1000 may correspond to the pressure of the airflow path through which gas flows. The puff sensor 1320 may be arranged to correspond to the airflow path through which gas flows in the aerosol generating device 1000.

The insertion detection sensor 1330 may sense insertion and/or removal of an aerosol generating article. The insertion detection sensor 1330 may sense a signal change according to the insertion and/or removal of the aerosol generating article. The insertion detection sensor 1330 may be installed near the insertion space. The insertion detection sensor 1330 may detect the insertion and/or removal of the aerosol generating article based on a permittivity change within the insertion space. For example, the insertion detection sensor 1330 may be an inductive sensor and/or a capacitance sensor.

The inductive sensor may include at least one coil. The coil of the inductive sensor may be arranged adjacent to the insertion space. For example, when the magnetic field changes near the coil where a current flows, the characteristics of the current flowing through the coil may change according to Faraday's law of electromagnetic induction. Here, the characteristics of the current flowing through the coil may include the frequency of an alternating current, a current value, a voltage value, an inductance value, an impedance value, and the like.

The inductive sensor may output a signal corresponding to the characteristics of the current flowing through the coil. For example, the inductive sensor may output a signal corresponding to the inductance value of the coil.

The capacitance sensor may include a conductor. The conductor of the capacitance sensor may be arranged adjacent to the insertion space. The capacitance sensor may output a signal corresponding to a peripheral electromagnetic characteristic, for example, capacitance near the conductor. For example, when an aerosol generating article including a metallic wrapper is inserted into the insertion space, the electromagnetic characteristics around the conductor may be changed by the wrapper of the aerosol generating article.

The reuse detection sensor 1340 may detect whether the aerosol generating article is reused. The reuse detection sensor 1340 may be a color sensor. The color sensor may detect the color of the aerosol generating article. The color sensor may detect the color of a portion of the wrapper surrounding the exterior of the aerosol generating article. The color sensor may detect a value representing the optical characteristics corresponding to the color of an object, based on light reflected from the object. For example, the optical characteristic may be the wavelength of light. The color sensor may be integrated with a proximity sensor as a single unit or implemented as a component separate from the proximity sensor.

At least a portion of the wrapper forming the aerosol generating article may change color due to the aerosols. When the aerosol generating article is inserted into the insertion space, the reuse detection sensor 1340 may be arranged to correspond to the location where at least a portion of the wrapper changing color due to the aerosols is arranged. For example, before the user uses the aerosol generating article, at least a portion of the wrapper may have a first color. In this case, as at least a portion of the wrapper is moistened by the aerosols while the aerosols generated by the aerosol generating device 1000 pass through the aerosol generating article, the color of the at least a portion of the wrapper changes to a second color. The color of at least a portion of the wrapper may be maintained as the second color after the color changes from the first color to the second color.

The cartridge detection sensor 1350 may detect the mounting and/or removal of the cartridge. The cartridge detection sensor 1350 may be implemented using an inductance-based sensor, a capacitive sensor, a Hall effect sensor (a hall integrated circuit (IC)), or the like.

The cap detection sensor 1360 may detect the mounting and/or removal of a cap. When the cap is separated from the aerosol generating device main body, the cartridge 19 and a portion of the aerosol generating device main body covered by the cap may be externally exposed. The cap detection sensor 1360 may be implemented using a contact sensor, a Hall sensor (Hall IC), an optical sensor, or the like.

The motion detection sensor 1370 may detect a motion of the aerosol generating device. The motion detection sensor 1370 may be implemented as at least one of an acceleration sensor and a gyroscope sensor.

The sensor 1300 may further include at least one of a humidity sensor, a barometric pressure sensor, a magnetic sensor, a location sensor (e.g., a global positioning system (GPS)), and a proximity sensor, in addition the sensors 1310 to 1370 stated above. Because a function of each of sensors may be intuitively inferred by one of ordinary skill in the art from the name of the sensor, a detailed description thereof may be omitted.

The output unit 1400 may output information on a state of the aerosol generating device 1000 and provide the information to a user. The output unit 1400 may include at least one of a display 1410, a haptic unit 1420, and a sound output unit 1430, but is not limited thereto. When the display 1410 and a touch pad form a layered structure to form a touch screen, the display 1410 may also be used as an input device in addition to an output device.

The display 1410 may visually provide information about the aerosol generating device 1000 to the user. For example, information about the aerosol generating device 1000 may indicate various pieces of information, such as a charging/discharging state of the power supply 1100 of the aerosol generating device 1000, a preheating state of the heater 1800, an insertion/removal state of an aerosol generating article and/or the cartridge 19, the mounting/removal of the cap, or a state in which the use of the aerosol generating device 1000 is restricted (e.g., sensing of an abnormal object), and the display unit 1140 may output the information to the outside. For example, the display 1410 may be in the form of a light-emitting diode (LED) device. The display 1410 may be, for example, a liquid crystal display panel (LCD), an organic light-emitting diode (OLED) display panel, or the like.

The haptic unit 1420 may tactilely provide information about the aerosol generating device 1000 to the user by converting an electrical signal into a mechanical stimulus or an electrical stimulus. For example, the haptic unit 1420 may generate vibration corresponding to the completion of initial heating when an initial power input is provided to the cartridge heater 2400 and/or the heater 1800 for a determined period of time. The haptic unit 1420 may include a vibration motor, a piezoelectric element, or an electrical stimulation device.

The sound output unit 1430 may audibly provide information about the aerosol generating device 1000 to the user. For example, the sound output unit 1430 may convert an electrical signal into a sound signal and output the same to the outside.

The power supply 1100 may supply power used to operate the aerosol generating device 1000. The power supply 1100 may supply power to heat the cartridge heater 2400 and/or the heater 1800. In addition, the power supply 1100 may supply power required for operations of other components of the aerosol generating device 1000, for example, the sensor 1300, the output unit 1400, the input unit 1500, the communication unit 1600, and the memory 1700. The power supply 1100 may be a rechargeable battery or a disposable battery. For example, the power supply 1100 may be a lithium polymer (LiPoly) battery, but is not limited thereto.

Although not illustrated in FIG. 37, the aerosol generating article 1000 may further include a power protection circuit. The power protection circuit may be electrically connected to the power supply 1100 and include a switching device.

The power protection circuit may cut off the power path to the power supply 1100 under specific conditions. For example, when the voltage level of the power supply 1100 is at least a first voltage corresponding to overcharging, the power protection circuit may cut off the power path to the power supply 1100. For example, when the voltage level of the power supply 1100 is less than a second voltage corresponding to over-discharge, the power protection circuit may cut off the power path to the power supply 1100.

The heater 1800 may receive power from the power supply 1100 and heat the medium or aerosol generating material within the aerosol generating article. Although not illustrated in FIG. 37, the aerosol generating device 1000 may further include a power conversion circuit (e.g., a direct current (DC)/DC converter) that converts power of the power supply 1100 and supplies the same to the cartridge heater 2400 and/or the heater 1800. In addition, when the aerosol generating device 1000 generates aerosols in an induction heating method, the aerosol generating device 1100 may further include a DC/alternating current (AC) that converts DC power of the battery 1140 into AC power.

The controller 1200, the sensor 1300, the output unit 1400, the input unit 1500, the communication unit 1600, and the memory 1700 may each receive power from the power supply 1100 to perform a function. Although not illustrated in FIG. 37, the aerosol generating device 1000 may further include a power conversion circuit that converts power from the power supply 1100 to supply the power to respective components, for example, a low dropout (LDO) circuit, or a voltage regulator circuit. In addition, although not shown in FIG. 37, a noise filter may be arranged between the power supply 1100 and the heater 1800. The noise filter may be a low pass filter. The low-pass filter may include at least one inductor and a capacitor. The cutoff frequency of the low-pass filter may correspond to the frequency of the high-frequency switching current applied from the power supply 1100 to the heater 1800. The low-pass filter may prevent high-frequency noise components from affecting the sensor 1300, such as the insertion detection sensor 1330.

In an embodiment, the cartridge heater 2400 and/or the heater 1800 may be formed of any suitable electrically resistive material. For example, the suitable electrically resistive material may be a metal or a metal alloy including titanium, zirconium, tantalum, platinum, nickel, cobalt, chromium, hafnium, niobium, molybdenum, tungsten, tin, gallium, manganese, iron, copper, stainless steel, nichrome, or the like, but is not limited thereto. In addition, the heater 1800 may be implemented by a metal wire, a metal plate on which an electrically conductive track is arranged, a ceramic heating element, or the like, but is not limited thereto.

In another embodiment, the heater 1800 may be a heater of an induction heating type. For example, the heater 1800 may include a susceptor that heats an aerosol generating material by generating heat through a magnetic field applied by a coil.

The input unit 1500 may receive information that is input from the user or may output information to the user. For example, the input unit 1500 may be a touch panel. The touch panel may include at least one touch sensor that detects touches. For example, the touch sensor may include a capacitive touch sensor, a resistive touch sensor, a surface acoustic wave touch sensor, an infrared touch sensor, or the like, but is not limited thereto.

The display 1410 and the touch panel may be implemented as a single panel. For example, the touch panel may be inserted into the display 1410 in an on-cell or in-cell manner. For example, the touch panel may be added to the display 1410 in an add-on manner.

The input unit 1500 may include a button, a key pad, a dome switch, a jog wheel, a jog switch, or the like, but is not limited thereto.

The memory 1700 is a hardware component that stores various types of data processed in the aerosol generating device 1000 and may store data processed and data to be processed by the controller 1200. The memory 1700 may include at least one type of storage medium from among a flash memory type, a hard disk type, a multimedia card micro type memory, a card-type memory (for example, secure digital (SD) or extreme digital (XD) memory, etc.), random access memory (RAM), static random access memory (SRAM), read-only memory (ROM), electrically erasable programmable read-only memory (EEPROM), programmable read-only memory (PROM), a magnetic memory, a magnetic disk, and an optical disk. The memory 1700 may store an operation time of the aerosol generating device 1000, the maximum number of puffs, the current number of puffs, at least one temperature profile, data on a user's smoking pattern, and the like.

The communication unit 1600 may include at least one component for communication with another electronic device. For example, the communication unit 1600 may include at least one of a short-range wireless communication unit and a wireless communication unit.

The short-range wireless communication unit may include a Bluetooth communication unit, a Bluetooth Low Energy (BLE) communication unit, a near field communication unit, a wireless LAN (WLAN) (Wi-Fi) communication unit, a Zigbee communication unit, an infrared data association (IrDA) communication unit, a Wi-Fi Direct (WFD) communication unit, an ultra-wideband (UWB) communication unit, an Ant+ communication unit, or the like, but is not limited thereto.

The wireless communication unit may include a cellular network communication unit, an Internet communication unit, a computer network (e.g., local area network (LAN) or wide area network (WAN)) communication unit, or the like, but is not limited thereto.

Although not illustrated in FIG. 37, the aerosol generating device 1000 may further include a connection interface, such as a universal serial bus (USB) interface, and may connect to other external devices through the connection interface, such as the USB interface, to transmit and receive information or to charge the power supply 1100.

The controller 1200 may control general operations of the aerosol generating device 1000. In an embodiment, the controller 1200 may include at least one processor. A processor can be implemented as an array of a plurality of logic gates or can be implemented as a combination of a general-purpose microprocessor and a memory in which a program executable in the microprocessor is stored. It will be understood by one of ordinary skill in the art that the processor may be implemented in other forms of hardware.

The controller 1200 may control the temperature of the heater 1800 by controlling the supply of power of the power supply 1100 to the heater 1800. The controller 1200 may control the temperature of the cartridge heater 2400 and/or the heater 1800 based on the temperature of the cartridge heater 2400 and/or the heater 1800 that is sensed by the temperature sensor 1310. The controller 1200 may adjust the power supplied to the cartridge heater 2400 and/or the heater 1800 based on the temperature of the cartridge heater 2400 and/or the heater 1800. For example, based on the temperature profile stored in the memory 1700, the controller 1200 may determine the target temperature of the cartridge heater 2400 and/or the heater 1800.

The aerosol generating device 1000 may include a power supply circuit (not shown) that is electrically connected to the power supply 1100 between the power supply 1100 and the cartridge heater 2400 and/or the heater 1800. The power supply circuit may be electrically connected to the cartridge heater 2400, the heater 1800, or an induction coil. The power supply circuit may include at least one switching device. The switching device may be implemented by a Bipolar Junction Transistor (BJT), a Field Effect Transistor (FET), or the like. The controller 1200 may control the power supply circuit.

The controller 1200 may control the power supply by controlling the switching of the switching device in the power supply circuit. The power supply circuit may be an inverter that converts the DC power from the power supply 1100 into AC power. For example, the inverter may include a full-bridge circuit or a half-bridge circuit that includes a plurality of switching devices.

The controller 1200 may turn on the switching device to allow the power to be supplied from the power supply 1100 to the cartridge heater 2400 and/or the heater 1800. The controller 1200 may turn off the switching device to cut the power supplied to the cartridge heater 2400 and/or the heater 1800. The controller 1200 may adjust a frequency and/or a duty ratio of a current pulse that is input to the switching device, thus adjusting a current supplied from the power supply 1100.

The controller 1200 may control the voltage output from the power supply 1100 by controlling the switching of the switching device in the power supply circuit. The power conversion circuit may convert a voltage output from the power supply 1100. For example, the power conversion circuit may include a buck converter that reduces a voltage that is output from the power supply 1100. For example, the power conversion circuit may be implemented using a buck-boost converter, a Zener diode, and the like.

The controller 1200 may adjust a level of the voltage output from the power conversion circuit by controlling on/off operations of the switching device included in the power conversion circuit. When the switching device remains in the on state, the level of the voltage output from the power conversion circuit may correspond to the level of the voltage output from the power supply 1100. The duty ratio of the on/off operations of the switching device may correspond to the ratio of the voltage output from the power supply 1100 to the voltage output from the power conversion circuit. As the duty ratio regarding the on/off operations of the switching device decreases, the level of the voltage output from the power conversion circuit may decrease. The heater 1800 may be heated based on the voltage output from the power conversion circuit.

The controller 1200 may control power to be supplied to the heater 1800 by employing at least one of Pulse Width Modulation (PWM) and Proportional-Integral-Differential (PID).

For example, the controller 1200 may control a pulse of current with a specific frequency and duty ratio to be supplied to the heater 1800 using PWM. The controller 1200 may control the power supplied to the heater 1800 by adjusting the frequency and duty ratio of the current pulse.

For example, the controller 1200 may set a target temperature, which is a control target, based on a temperature profile. The controller 1200 may control the power supplied to the heater 1800 by using PID that is a feedback control method utilizing a difference between the temperature and the target temperature of the heater 1800, a value obtained by integrating the difference over time, and a value obtained by differentiating the difference over time.

The controller 1200 may prevent the cartridge heater 2400 and/or the heater 1800 from being overheated. For example, the controller 1200 may control the operation of the power conversion circuit to interrupt the power supply to the cartridge heater 2400 and/or the heater 1800 when the temperature of the cartridge heater 2400 and/or the heater 1800 is higher than a preset threshold temperature. For example, the controller 1200 may reduce the amount of power supplied to the cartridge heater 2400 and/or the heater 1800 by a specific ratio when the temperature of the cartridge heater 2400 and/or the heater 1800 is higher than the preset threshold temperature. For example, the controller 1200 may determine that an aerosol generating material in the cartridge is exhausted when the temperature of the cartridge heater 2400 is higher than the preset threshold temperature and may interrupt the power supply to the cartridge heater 2400.

The controller 1200 may control charging/discharging of the power supply 1100. The controller 1200 may check the temperature of the power supply 1100, based on an output signal of the temperature sensor 1310.

When a power line is connected to a battery terminal of the aerosol generating device 1000, the controller 1200 may check whether the temperature of the power supply 1100 reaches or exceeds a first threshold temperature that is a reference for blocking the charging of the power supply 1100. When the temperature of the power supply 1100 is below the first threshold temperature, the controller 1200 may control the power supply 1100 to be charged, based on a preset charging current. When the temperature of the power supply 1100 reaches or exceeds the first threshold temperature, the controller 1200 may stop charging the power supply 1100.

When the aerosol generating device 1000 is in the on state, the controller 1200 may check whether the temperature of the power supply 1100 reaches or exceeds a second threshold temperature that is a reference for blocking the discharge of the power supply 1100. When the temperature of the power supply 1100 is below the second threshold temperature, the controller 1200 may allow the power stored in the power supply 1100 to be used. When the temperature of the power supply 1100 reaches or exceeds the second threshold temperature, the controller 1200 may stop using the power stored in the power supply 1100.

The controller 1200 may calculate the remaining capacity of the power stored in the power supply 1100. For example, the controller 120 may calculate the remaining capacity of the power supply 1100, based on a voltage and/or a current sensing value of the power supply 1100.

The controller 1200 may determine whether the aerosol generating article is inserted into the insertion space by using the insertion detection sensor 1330. The controller 1200 may determine that the aerosol generating article is inserted, based on an output signal of the insertion detection sensor 1330. When it is determined that the aerosol generating article is inserted into the insertion space, the controller 1200 may control power to be supplied to the cartridge heater 2400 and/or the heater 1800. For example, based on the temperature profile stored in the memory 1700, the controller 1200 may supply power to the cartridge heater 2400 and/or the heater 1800.

The controller 1200 may determine whether the aerosol generating article is removed from the insertion space. For example, the controller 1200 may determine whether the aerosol generating article is removed from the insertion space by using the insertion detection sensor 1330. For example, when the temperature of the heater 1800 reaches or exceeds a threshold temperature, or when a temperature change gradient of the heater 1800 is equal to or greater than a preset gradient, the controller 1200 may determine that the aerosol generating article is removed from the insertion space When it is determined that the aerosol generating article is removed from the insertion space, the controller 1200 may interrupt power supply to the cartridge heater 2400 and/or the heater 1800.

The controller 1200 may control the duration and/or amount of power supply to the heater 1800, based on the state of the aerosol generating article that is detected by the sensor 1300. Based on the lookup table, the controller 1200 may identify a level range including a level of a signal from a capacitance sensor. The controller 1200 may determine the moisture content of the aerosol generating article, according to the identified level range.

When the aerosol generating article is excessively humid, the controller 1200 may control the duration of power supply to the heater 1800 to increase the preheating time of the aerosol generating article, compared to when the aerosol generating article is in a normal state.

By using the reuse detection sensor 1340, the controller 1200 may determine whether the aerosol generating article inserted into the insertion space is reused. For example, the controller 1200 may compare a sensing value of a signal from the reuse detection sensor 1340 with a first reference range including the first color, and when the sensing value falls within the first reference range, the controller 1200 may determine that the aerosol generating article has not been used. For example, the controller 1200 may compare a sensing value of a signal from the reuse detection sensor 1340 with a second reference range including the second color, and when the sensing value falls within the second reference range, the controller 1200 may determine that the aerosol generating article has been used. When it is determined that the aerosol generating article has been used, the controller 1200 may interrupt the power supply to the cartridge heater 2400 and/or the heater 1800.

The controller 1200 may determine the coupling and/or removal of the cartridge 19 by using the cartridge detection sensor 1350. For example, the controller 1200 may determine the coupling and/or removal of the cartridge 19, based on a sensing value of a signal from the cartridge detection sensor 1350.

The controller 1200 may determine whether the aerosol generating material in the cartridge is exhausted. For example, the controller 1200 may preheat the cartridge heater 2400 and/or the heater 1800 by supplying power, determine in a preheating section whether the temperature of the cartridge heater 2400 is higher than a threshold temperature, and determine that the aerosol generating material in the cartridge is exhausted when the temperature of the cartridge heater 2400 exceeds the threshold temperature. When it is determined that the aerosol generating material in the cartridge is exhausted, the controller 1200 may interrupt the power supply to the cartridge heater 2400 and/or the heater 1800.

The controller 1200 may determine whether the cartridge may be used. For example, based on the data stored in the memory 1700, the controller 1200 may determine that it is impossible to use the cartridge when the current number of puffs is equal to or greater than the maximum number of puffs that is set for the cartridge. For example, when the total heating time of the cartridge heater 2400 is equal to or greater than the preset maximum time, or when the total amount of power supplied to the cartridge heater 2400 is equal to or greater than the maximum amount of power, the controller 1200 may determine that it is impossible to use the cartridge.

The controller 1200 may determine the inhalation of the user using the puff sensor 1320. For example, the controller 1200 may determine whether puffs are generated, based on a sensing value of a signal from the puff sensor 1320. For example, the controller 1200 may determine the intensity of puffs based on the sensing value of the signal from the puff sensor 1320. When the number of puffs reaches the preset maximum number of puffs, or when no puffs are detected for a preset period of time, the controller 1200 may interrupt the power supply to the cartridge heater 2400 and/or the heater 1800.

The controller 1200 may determine the coupling and/or removal of the cap by using the cap detection sensor 1360. For example, the controller 1200 may determine the coupling or removal of the cap based on a sensing value of a signal from the cap detection sensor 1360.

The controller 1200 may control the output unit 1400 based on the result detected by the sensor 1300. For example, when the number of puffs counted by the puff sensor 1320 reaches a preset number, the controller 1200 may notify the user that the aerosol generating device 1000 will soon be terminated through at least one of the display 1410, the haptic unit 1420, and the sound output unit 1430. For example, the controller 1200 may notify the user through the output unit 1400 that the aerosol generating article is not present in the insertion space. For example, the controller 1200 may notify the user through the output unit 1400 that the cartridge 19 and/or the cap is not attached. For example, the controller 1200 may transmit the information regarding the temperature of the cartridge heater 2400 and/or the heater 1800 to the user through the output unit 1400.

Based on the occurrence of certain events, the controller 1200 may store and update the history of the events in the memory 1700. The events may include, for example, detection of the insertion of the aerosol generating article, initiation of heating of the aerosol generating article, puff detection, puff termination, detection of overheating of the cartridge heater 2400 and/or the heater 1800, detection of overvoltage applied to the cartridge heater 2400 and/or the heater 1800, termination of heating of the aerosol generating article, operations such as turning on/off of the aerosol generating device 1000, initiation of charging of the power supply 1100, detection of overcharging of the power supply 1100, and termination of charging of the power supply 1100, all of which are performed by the aerosol generating device 1000. The history of events may include the date and time of the events, log data corresponding to the events, and the like. For example, when a specific event is the detection of the insertion of the aerosol generating article, the log data corresponding to the event may include data regarding the sensing value, etc. of the insertion detection sensor 1330. For example, when a specific event is the detection of overheating of the cartridge heater 2400 and/or the heater 1800, the log data corresponding to the event may include data regarding the temperature of the cartridge heater 2400 and/or the heater 1800, the voltage applied to the cartridge heater 2400 and/or the heater 1800, the current flowing through the cartridge heater 2400 and/or the heater 1800, and the like.

The controller 1200 may control the establishment of a communication link with an external device, such as a mobile terminal of the user. When authentication-related data is received from the external device through the communication link, the controller 1200 may remove the restriction on the use of at least one of the functions of the aerosol generating device 1000. Here, the authentication-related data may include data indicating the completion of user authentication for the user corresponding to the external device. The user may perform user authentication using the external device. The external device may determine the validity of the user data based on factors such as the user's birthday or a unique number indicating the user, and may receive data regarding the authorization to use the aerosol generating device 1000. Based on the data regarding the authorization to use the aerosol generating device 1000, the external device may transmit data indicating the completion of user authentication to the aerosol generating device 1000. When the user authentication is completed, the controller 1200 may remove the restriction on the use of at least one of the functions of the aerosol generating device 1000. For example, when user authentication is completed, the controller 1200 may remove the restriction on using the heating function to supply power to the heater 1800.

The controller 1200 may transmit data regarding the state of the aerosol generating device 1000 to the external device via the communication link established between the controller 1200 and the external device. Based on the received state data, the external device may output the remaining capacity of the power supply 1100 of the aerosol generating device 1000, the operation mode, and the like via the display of the external device.

Based on an input for initiating search for the location of the aerosol generating device 1000, the external device may transmit a location search request to the aerosol generating device 1000. Upon receiving the location search request from the external device, the controller 1200 may control at least one of the output devices to perform an operation corresponding to the location search, in response to the received location search request. For example, the haptic unit 1420 may generate vibration in response to the location search request. For example, the display 1410 may output objects corresponding to the location search and search end, in response to the location search request.

When receiving firmware data from the external device, the controller 1200 may control the firmware update to be performed. The external device may check the current version of firmware of the aerosol generating device 1000 and determine whether a new version of the firmware is available. When an input requesting the firmware download is received, the external device may receive the new version of the firmware data and transmit the same to the aerosol generating device 1000. Upon receiving the new version of the firmware data, the controller 1200 may control the firmware update of the aerosol generating device 1000 to be performed.

The controller 1200 may transmit data regarding the sensing value of at least one sensor 1300 to an external server (not shown) through the communication unit 1600 and may receive and store a learning model that is generated by training the sensing value from the server using machine learning techniques such as deep learning. The controller 1200 may perform an operation of determining a user's inhalation pattern, an operation of generating temperature profiles, and the like by using the learning model received from the server. The controller 1200 may store, in the memory 1700, data regarding the sensing value of at least one sensor 1300 and data used for training an Artificial Neural Network (ANN). For example, the memory 1700 may store a database regarding each component of the aerosol generating device 1000 as well as the weights and biases forming the structure of the ANN, the database being used to train the ANN. The controller 1200 may train the data regarding the sensing value of at least one sensor 1300, the user's inhalation pattern, and temperature profiles, which are stored in the memory 1700, and generate at least one learning model used to determine the user's inhalation pattern, generate temperature profiles, and the like.

The descriptions of the above-described embodiments are merely examples, and it will be understood by one of ordinary skill in the art that various changes and equivalents thereof may be made. Therefore, the scope of the disclosure should be defined by the appended claims, and all differences within the scope equivalent to those described in the claims will be construed as being included in the scope of protection defined by the claims.

Any embodiments of the present disclosure or other embodiments described above are not mutually exclusive or distinct from each other. Any embodiment or other embodiments described in this disclosure may be combined with one another, both in terms of configurations and functions.

For example, configuration A from a specific embodiment and/or drawing can be combined with configuration B from another embodiment and/or drawing. This means that even if a combination of components is not explicitly described, such combinations are still possible unless specifically stated otherwise.

The detailed description above should not be interpreted as limiting in any respect, but rather as illustrative. The scope of the present disclosure should be defined by a reasonable interpretation of the appended claims, and all modifications that fall within the equivalent scope of the present disclosure are included in its scope.

According to an aerosol generating system according to the one or more embodiments of the disclosure, the sensitivity of sensors may be improved.

The aerosol generating system according to the one or more embodiments of the disclosure may identify various types of cigarettes using limited identification means.

The aerosol generating system according to the one or more embodiments of the disclosure may efficiently utilize the limited mounting space and reduce power consumption.

Effects of the embodiments are not limited to those stated above, and effects that are not described herein may be clearly understood by one of ordinary skill in the art from the present specification and the attached drawings.

What is claimed is:

1. An aerosol generating system comprising:
a cigarette comprising an identification portion that emits light of a second wavelength when excited by light of a first wavelength, wherein the second wavelength is different from the first wavelength;
a main body comprising a cavity into which the cigarette is inserted;
an optical sensor package arranged near the cavity and configured to detect the identification portion; and
a controller configured to identify whether the cigarette is counterfeit and a type of the cigarette based on a sensing value detected by the optical sensor package,
wherein the optical sensor package comprises:
a package substrate;
an emission portion arranged on the package substrate and emitting light of the first wavelength;
a semiconductor chip arranged on the package substrate; and
a light-receiving portion arranged on at least one of the semiconductor chip and the package substrate, which is located on the opposite side of the emission portion with respect to the semiconductor chip, and configured to receive light of the second wavelength.

2. The aerosol generating system of claim 1, wherein the semiconductor chip comprises a signal processor that is electrically connected to the light-receiving portion, and
the signal processor comprises an analog-to-digital converter configured to convert an analog signal, which is the sensing value, into a digital signal.

3. The aerosol generating system of claim 2, wherein the controller is further configured to determine whether the cigarette is counterfeit and a type of the cigarette, based on the digital signal generated by the signal processor.

4. The aerosol generating system of claim 1, wherein a height from an upper surface of the package substrate to an upper surface of the semiconductor chip is greater than a height from the upper surface of the package substrate to an upper surface of the emission portion.

5. The aerosol generating system of claim 1, wherein the emission portion comprises at least one of an infrared light-emitting diode and an ultraviolet light-emitting diode, and
the light-receiving portion comprises at least one of an RGB photodiode and an infrared photodiode.

6. The aerosol generating system of claim 1, wherein the identification portion comprises at least one of a lanthanide material and a taggant material.

7. The aerosol generating system of claim 1, wherein the optical sensor package further comprises a partition arranged on the package substrate located between the emission portion and the semiconductor chip.

8. The aerosol generating system of claim 7, wherein the partition comprises a black epoxy mold compound, and a molding member comprises a clear molding compound.

9. The aerosol generating system of claim 8, wherein the optical sensor package further comprises the molding member arranged on an upper surface of an exposed portion of the package substrate, the emission portion, the light-receiving portion, and the semiconductor chip.

10. The aerosol generating system of claim 1, further comprising a partition arranged on the package substrate and comprising a first partition portion and a second partition portion, wherein the first partition is arranged between the emission portion and the semiconductor chip, and the second partition portion is arranged along the periphery of the package substrate.

11. The aerosol generating system of claim 9, wherein the molding member comprises a first molding portion arranged on an upper surface of an exposed portion of the package substrate and a second molding portion arranged on an upper surface of another exposed portion of the package substrate, the light-receiving portion, and the semiconductor chip.

12. The aerosol generating system of claim 11, wherein an inner side surface of the partition that contacts the first molding portion has an inclined surface that forms an obtuse angle with the upper surface of the package substrate.

13. The aerosol generating system of claim 11, wherein a reflective material is placed on the inclined surface.

14. The aerosol generating system of claim 11, wherein the partition comprises a black epoxy mold compound, and the molding member comprises a clear molding compound.

15. The aerosol generating system of claim 1, wherein the cigarette comprises an aerosol generating rod and a filter rod, and
the identification portion is formed in a region extending in a direction towards the filter rod from a boundary between the aerosol generating rod and the filter rod, the identification portion having a band shape surrounding an outer circumferential surface of the cigarette.
